(19) United States
(12) Patent Application Publication
(10) Pub. No.: US 2022/0417517 A1
(43) Pub. Date: Dec. 29, 2022

(54) IMAGE DECODING METHOD USING CCLM PREDICTION IN IMAGE CODING SYSTEM, AND APPARATUS THEREFOR

(71) Applicant: LG ELECTRONICS INC., Seoul (KR)

(72) Inventors: Jangwon CHOI, Seoul (KR); Jin HEO, Seoul (KR); Sunmi YOO, Seoul (KR); Ling LI, Seoul (KR); Jungah CHOI, Seoul (KR); Seunghwan KIM, Seoul (KR)

(21) Appl. No.: 17/373,522

(22) Filed: Jul. 12, 2021

Related U.S. Application Data
(63) Continuation of application No. PCT/KR2020/000618, filed on Jan. 13, 2020.
(60) Provisional application No. 62/791,749, filed on Jan. 12, 2019.

(51) Int. Cl. H04N 19/132; H04N 19/105; H04N 19/117; H04N 19/82; H04N 19/159; H04N 19/186; H04N 19/176

(52) U.S. Cl. CPC H04N 19/132; H04N 19/105; H04N 19/117; H04N 19/176; H04N 19/159; H04N 19/186; H04N 19/82

(57) ABSTRACT

An image decoding method according to the present disclosure comprises the steps of: deriving downsampled luma samples and downsampled peripheral luma samples on the basis of a current luma block and peripheral samples of the current luma block; and deriving a cross-component linear model (CCLM) parameter on the basis of the downsampled peripheral luma samples and peripheral chroma samples of a current chroma block, wherein the peripheral chroma samples include left peripheral chroma samples of the current chroma block and upper peripheral chroma samples of the current chroma block, and the downsampled peripheral luma samples include two downsampled left peripheral luma samples related to the left peripheral chroma samples and two downsampled upper peripheral luma samples related to the upper peripheral chroma samples.

### BACKGROUND OF DISCLOSURE

### Field of the Disclosure

This document relates generally to an image coding technology and, more particularly, to an image decoding method using CCLM prediction in an image coding system, and an apparatus therefor.

### Related Art

Demand for high-resolution, high-quality images such as HD (High Definition) images and UHD (Ultra High Definition) images has been increasing in various fields. As the image data has high resolution and high quality, the amount of information or bits to be transmitted increases relative to the legacy image data. Therefore, when image data is transmitted using a medium such as a conventional wired/wireless broadband line or image data is stored using an existing storage medium, the transmission cost and the storage cost thereof are increased.

Accordingly, there is a need for a highly efficient image compression technique for effectively transmitting, storing, and reproducing information of high resolution and high quality images.

### SUMMARY

This document is to provide a method and apparatus for improving image coding efficiency.

This document is also to provide a method and apparatus for improving efficiency of intra prediction.

This document is also to provide a method and apparatus for improving the efficiency of intra prediction based on the cross component linear model (CCLM).

This document is also to provide efficient encoding and decoding methods of CCLM prediction, and apparatuses for performing the encoding and decoding methods.

This document is also to provide a method and apparatus for selecting a neighboring sample for deriving a linear model parameter for the CCLM.

This document is also to provide a method and apparatus for satisfying encoding and decoding performance based on efficient or optimized CCLM and reducing the complexity of hardware implementation.

This document is also to provide a method and apparatus for reducing the downsampling operation amount in CCLM prediction.

According to an embodiment of this document, an image decoding method performed by a decoding apparatus is provided. The method includes obtaining image information including prediction mode information for a current chroma block from a bitstream, deriving an intra prediction mode of the current chroma block as a cross-component linear model (CCLM) mode based on the prediction mode information, deriving downsampled luma samples based on a current luma block, deriving downsampled neighboring luma samples selected based on neighboring luma samples of the current luma block, deriving a CCLM parameter based on the selected downsampled neighboring luma samples and neighboring chroma samples of the current chroma block, and generating prediction samples for the current chroma block based on the CCLM parameter and the downsampled luma samples, wherein the selected downsampled neighboring luma samples include four selected downsampled neighboring luma samples related to the neighboring chroma samples.

According to another embodiment of this document, a decoding apparatus for performing image decoding is provided. The decoding apparatus includes an entropy decoder which obtains image information including prediction mode information for a current chroma block from a bitstream, and a predictor which derives an intra prediction mode of the current chroma block as a cross-component linear model (CCLM) mode based on the prediction mode information, derives downsampled luma samples based on a current luma block, derives downsampled neighboring luma samples selected based on neighboring luma samples of the current luma block, derives a CCLM parameter based on the selected downsampled neighboring luma samples and neighboring chroma samples of the current chroma block, and generates prediction samples for the current chroma block based on the CCLM parameter and the downsampled luma samples, wherein the selected downsampled neighboring luma samples include four selected downsampled neighboring luma samples related to the neighboring chroma samples.

According to still another embodiment of this document, a video encoding method which is performed by an encoding apparatus is provided. The method includes determining an intra prediction mode of a current chroma block as a cross-component linear model (CCLM) mode, deriving downsampled luma samples based on a current luma block, deriving downsampled neighboring luma samples selected based on neighboring luma samples of the current luma block, deriving a CCLM parameter based on the selected downsampled neighboring luma samples and neighboring chroma samples of the current chroma block, generating prediction samples for the current chroma block based on the CCLM parameter and the downsampled luma samples, and encoding image information including prediction mode information for the current chroma block, wherein the selected downsampled neighboring luma samples include four selected downsampled neighboring luma samples related to the neighboring chroma samples.

According to still another embodiment of this document, a video encoding apparatus is provided. The encoding apparatus includes a predictor which determines an intra prediction mode of a current chroma block as a cross-component linear model (CCLM) mode, derives downsampled luma samples based on a current luma block, derives downsampled neighboring luma samples selected based on neighboring luma samples of the current luma block, derives a CCLM parameter based on the selected downsampled neighboring luma samples and neighboring chroma samples of the current chroma block, and generates prediction samples for the current chroma block based on the CCLM parameter and the downsampled luma samples, and an entropy encoder which encodes image information including prediction mode information of the current chroma block, wherein the selected downsampled neighboring luma samples include four selected downsampled neighboring luma samples related to the neighboring chroma samples.

According to still yet another embodiment of this document, a computer-readable digital storage medium is provided. The computer-readable digital storage medium includes a bitstream stored therein, which causes said decoding method to be performed.

According to still yet another embodiment of this document, a computer-readable digital storage medium is provided. The computer-readable digital storage medium includes a bitstream stored therein, which is generated by said encoding method.

According to this document, it is possible to improve overall image/video compression efficiency.

According to this document, it is possible to improve the intra prediction efficiency.

According to this document, it is possible to improve image coding efficiency by performing the intra prediction based on the CCLM.

According to this document, it is possible to improve the efficiency of intra prediction based on the CCLM.

According to this document, it is possible to reduce the complexity of intra prediction by limiting the number of neighboring samples selected to derive a linear model parameter for the CCLM of a chroma block of big size to a specific number.

According to this document, it is possible to satisfy encoding and decoding performance and reduce the complexity of hardware implementation through efficient CCLM using a downsampling ratio or a downsampling filter.

According to this document, it is also possible to provide a method and apparatus for reducing the downsampling operation amount in CCLM prediction.

### BRIEF DESCRIPTION OF THE DRAWINGS

FIG. 1 schematically illustrates an example of a video/image coding system to which embodiments of this document are applicable.

FIG. 2 is a schematic diagram illustrating a configuration of a video/image encoding apparatus to which embodiments of this document are applicable.

FIG. 3 is a schematic diagram illustrating a configuration of a video/image decoding apparatus to which embodiments of this document are applicable.

FIG. 4 illustratively represents intra directional modes of 65 prediction directions.

FIG. 5 is a diagram for describing a process of deriving an intra prediction mode of a current chroma block according to an embodiment.

FIG. 6 shows 2N reference samples for parameter calculation for the aforementioned CCLM prediction.

FIG. 7 is a diagram for explaining a simplified CCLM parameter calculation method.

FIGS. 8A and 8B are diagrams for explaining an LM_A mode and an LM_L mode.

FIGS. 9A and 9B are diagrams for describing a process of performing CCLM prediction for a current chroma block according to an embodiment.

FIGS. 10A and 10B are diagrams for describing a process of performing CCLM prediction for a current chroma block according to an embodiment.

FIGS. 11A and 11B are diagrams for describing a process of performing CCLM prediction based on the CCLM parameters of the current chroma block derived according to method 1 of the embodiment described above.

FIGS. 12A and 12B are diagrams for describing a process of performing CCLM prediction based on the CCLM parameters of the current chroma block derived according to method 2 of the embodiment described above.

FIGS. 13A and 13B are diagrams for describing a process of performing CCLM prediction based on the CCLM parameters of the current chroma block derived according to method 3 of the embodiment described above.

FIGS. 14A and 14B are diagrams for describing a process of performing CCLM prediction based on the CCLM parameters of the current chroma block derived according to method 4 of the embodiment described above.

FIGS. 15A and 15B are diagrams for describing a process of performing CCLM prediction based on the CCLM parameters of the current chroma block derived according to method 1 of the embodiment described above.

FIGS. 16A and 16B are diagrams for describing a process of performing CCLM prediction based on the CCLM parameters of the current chroma block derived according to method 2 of the embodiment described above.

FIGS. 17A and 17B are diagrams for describing a process of performing CCLM prediction based on the CCLM parameters of the current chroma block derived according to method 3 of the embodiment described above.

FIG. 18 is a diagram for describing a method of selecting a subsampled sample.

FIGS. 19A and 19B show examples of neighboring reference sample positions for a 2×2 block selected through the subsampling.

FIGS. 20A and 20B show examples of neighboring reference sample positions for a 4×4 block selected through the subsampling.

FIGS. 21A and 21B show examples of neighboring reference sample positions for an 8×2 block selected through the subsampling.

FIGS. 22A and 22B are diagrams for describing a process of performing CCLM prediction based on the CCLM parameters of the current chroma block derived according to the method of the embodiment described above.

FIGS. 23A and 23B are diagrams for describing a process of performing CCLM/MDLM prediction based on the CCLM/MDLM parameters of the current chroma block derived according to method 1 of the embodiment described above.

FIGS. 24A and 24B are diagrams for describing a process of performing CCLM/MDLM prediction based on the CCLM/MDLM parameters of the current chroma block derived according to method 2 of the embodiment described above.

FIGS. 25A and 25B are diagrams for describing a process of performing CCLM/MDLM prediction based on the CCLM/MDLM parameters of the current chroma block derived according to method 3 of the embodiment described above.

FIGS. 26A and 26B are diagrams for describing a process of performing CCLM/MDLM prediction based on the CCLM/MDLM parameters of the current chroma block derived according to method 4 of the embodiment described above.

FIGS. 27A and 27B are diagrams for describing a process of performing CCLM/MDLM/MMLM/MM-MDLM prediction based on the CCLM/MDLM/MMLM/MM-MDLM parameters of the current chroma block derived according to method 1 of the embodiment described above.

FIGS. 28A and 28B are diagrams for describing a process of performing CCLM/MDLM/MMLM/MM-MDLM prediction based on the CCLM/MDLM/MMLM/MM-MDLM parameters of the current chroma block derived according to method 2 of the embodiment described above.

FIGS. 29A and 29B are diagrams for describing a process of performing CCLM/MDLM/MMLM/MM-MDLM prediction based on the CCLM/MDLM/MMLM/MM-MDLM parameters of the current chroma block derived according to method 3 of the embodiment described above.

FIGS. 30A and 30B are diagrams for describing a process of performing CCLM/MDLM/MMLM/MM-MDLM prediction based on the CCLM/MDLM/MMLM/MM-MDLM parameters of the current chroma block derived according to method 4 of the embodiment described above.

FIGS. 31A and 31B are diagrams for describing a process of performing CCLM/MDLM/MMLM/MM-MDLM prediction based on the CCLM/MDLM/MMLM/MM-MDLM parameters of the current chroma block derived according to method 5 of the embodiment described above.

FIGS. 32A and 32B are diagrams for describing a process of performing CCLM/MDLM/MMLM/MM-MDLM prediction based on the CCLM/MDLM/MMLM/MM-MDLM parameters of the current chroma block derived according to the method of the embodiment described above.

FIGS. 33A and 33B are diagrams for describing a process of performing CCLM/MDLM/MMLM/MM-MDLM prediction based on the CCLM/MDLM/MMLM/MM-MDLM parameters of the current chroma block derived according to the filter of the embodiment described above.

FIGS. 34 and 35 schematically show an example of a video/image encoding method and associated components according to the embodiment(s) of this document.

FIGS. 36 and 37 schematically show an example of a video/image encoding method and associated components according to the embodiment(s) of this document.

FIG. 38 schematically represents a content streaming system configuration.

### DESCRIPTION OF EMBODIMENTS

The present document may be modified in various forms, and specific embodiments thereof will be described and illustrated in the drawings. However, the embodiments are not intended for limiting the embodiments of the document. The terms used in the following description are used to merely describe specific embodiments, but are not intended to limit the technical idea of the document. An expression of a singular number includes an expression of the plural number, so long as it is clearly read differently. The terms such as “include” and “have” are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

Meanwhile, each of the components in the drawings described in this document are shown independently for the convenience of description regarding different characteristic functions, and do not mean that the components are implemented in separate hardware or separate software. For example, two or more of each configuration may be combined to form one configuration, or one configuration may be divided into a plurality of configurations. Embodiments in which each configuration is integrated and/or separated are also included in the scope of this document without departing from the spirit of this document.

Hereinafter, examples of the present embodiment will be described in detail with reference to the accompanying drawings. In addition, like reference numerals are used to indicate like elements throughout the drawings, and the same descriptions on the like elements will be omitted.

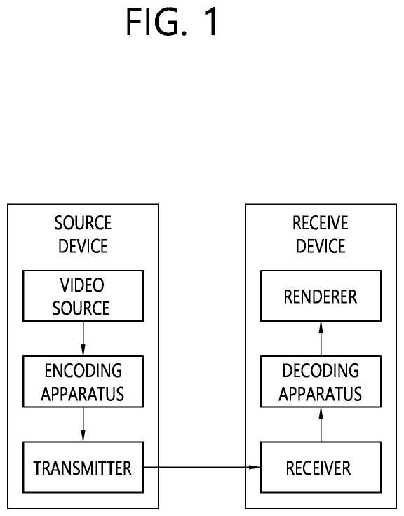

FIG. 1 illustrates an example of a video/image coding system to which the embodiments of the present document may be applied.

Referring to FIG. 1, a video/image coding system may include a source device and a reception device. The source device may transmit encoded video/image information or data to the reception device through a digital storage medium or network in the form of a file or streaming.

The source device may include a video source, an encoding apparatus, and a transmitter. The receiving device may include a receiver, a decoding apparatus, and a renderer. The encoding apparatus may be called a video/image encoding apparatus, and the decoding apparatus may be called a video/image decoding apparatus. The transmitter may be included in the encoding apparatus. The receiver may be included in the decoding apparatus. The renderer may include a display, and the display may be configured as a separate device or an external component.

The video source may acquire video/image through a process of capturing, synthesizing, or generating the video/image. The video source may include a video/image capture device and/or a video/image generating device. The video/image capture device may include, for example, one or more cameras, video/image archives including previously captured video/images, and the like. The video/image generating device may include, for example, computers, tablets and smartphones, and may (electronically) generate video/images. For example, a virtual video/image may be generated through a computer or the like. In this case, the video/image capturing process may be replaced by a process of generating related data.

The encoding apparatus may encode input video/image. The encoding apparatus may perform a series of procedures such as prediction, transform, and quantization for compaction and coding efficiency. The encoded data (encoded video/image information) may be output in the form of a bitstream.

The transmitter may transmit the encoded image/image information or data output in the form of a bitstream to the receiver of the receiving device through a digital storage medium or a network in the form of a file or streaming The digital storage medium may include various storage mediums such as USB, SD, CD, DVD, Blu-ray, HDD, SSD, and the like. The transmitter may include an element for generating a media file through a predetermined file format and may include an element for transmission through a broadcast/communication network. The receiver may receive/extract the bitstream and transmit the received bitstream to the decoding apparatus.

The decoding apparatus may decode the video/image by performing a series of procedures such as dequantization, inverse transform, and prediction corresponding to the operation of the encoding apparatus.

The renderer may render the decoded video/image. The rendered video/image may be displayed through the display.

This document relates to video/image coding. For example, a method/embodiment disclosed in this document may be applied to a method disclosed in the versatile video coding (VVC) standard, the essential video coding (EVC) standard, the AOMedia Video 1 (AV1) standard, the 2nd generation of audio video coding standard (AVS2) or the next generation video/image coding standard (e.g., H.267, H.268, or the like).

This document suggests various embodiments of video/image coding, and the above embodiments may also be performed in combination with each other unless otherwise specified.

In this document, a video may refer to a series of images over time. A picture generally refers to the unit representing one image at a particular time frame, and a slice/tile refers to the unit constituting a part of the picture in terms of coding. A slice/tile may include one or more coding tree units (CTUs). One picture may consist of one or more slices/tiles. One picture may consist of one or more tile groups. One tile group may include one or more tiles. A brick may represent a rectangular region of CTU rows within a tile in a picture (a brick may represent a rectangular region of CTU rows within a tile in a picture). A tile may be partitioned into a multiple bricks, each of which may be constructed with one or more CTU rows within the tile (A tile may be partitioned into multiple bricks, each of which consisting of one or more CTU rows within the tile). A tile that is not partitioned into multiple bricks may also be referred to as a brick. A brick scan may represent a specific sequential ordering of CTUs partitioning a picture, wherein the CTUs may be ordered in a CTU raster scan within a brick, and bricks within a tile may be ordered consecutively in a raster scan of the bricks of the tile, and tiles in a picture may be ordered consecutively in a raster scan of the tiles of the picture (A brick scan is a specific sequential ordering of CTUs partitioning a picture in which the CTUs are ordered consecutively in CTU raster scan in a brick, bricks within a tile are ordered consecutively in a raster scan of the bricks of the tile, and tiles in a picture are ordered consecutively in a raster scan of the tiles of the picture). A tile is a particular tile column and a rectangular region of CTUs within a particular tile column (A tile is a rectangular region of CTUs within a particular tile column and a particular tile row in a picture). The tile column is a rectangular region of CTUs, which has a height equal to the height of the picture and a width that may be specified by syntax elements in the picture parameter set (The tile column is a rectangular region of CTUs having a height equal to the height of the picture and a width specified by syntax elements in the picture parameter set). The tile row is a rectangular region of CTUs, which has a width specified by syntax elements in the picture parameter set and a height that may be equal to the height of the picture (The tile row is a rectangular region of CTUs having a height specified by syntax elements in the picture parameter set and a width equal to the width of the picture). A tile scan may represent a specific sequential ordering of CTUs partitioning a picture, and the CTUs may be ordered consecutively in a CTU raster scan in a tile, and tiles in a picture may be ordered consecutively in a raster scan of the tiles of the picture (A tile scan is a specific sequential ordering of CTUs partitioning a picture in which the CTUs are ordered consecutively in CTU raster scan in a tile whereas tiles in a picture are ordered consecutively in a raster scan of the tiles of the picture). A slice may include an integer number of bricks of a picture, and the integer number of bricks may be included in a single NAL unit (A slice includes an integer number of bricks of a picture that may be exclusively contained in a single NAL unit). A slice may be constructed with multiple complete tiles, or may be a consecutive sequence of complete bricks of one tile (A slice may consists of either a number of complete tiles or only a consecutive sequence of complete bricks of one tile). In this document, a tile group and a slice may be used in place of each other. For example, in this document, a tile group/tile group header may be referred to as a slice/slice header.

A pixel or a pel may mean a smallest unit constituting one picture (or image). Also, ‘sample’ may be used as a term corresponding to a pixel. A sample may generally represent a pixel or a value of a pixel, and may represent only a pixel/pixel value of a luma component or only a pixel/pixel value of a chroma component.

A unit may represent a basic unit of image processing. The unit may include at least one of a specific region of the picture and information related to the region. One unit may include one luma block and two chroma (ex. cb, cr) blocks. The unit may be used interchangeably with terms such as block or area in some cases. In a general case, an M×N block may include samples (or sample arrays) or a set (or array) of transform coefficients of M columns and N rows.

In this document, the symbol “/” and “,” should be interpreted as “and/or.” For example, the expression “A/B” is interpreted as “A and/or B”, and the expression “A, B” is interpreted as “A and/or B.” Additionally, the expression “A/B/C” means “at least one of A, B, and/or C.” Further, the expression “A, B, C” also means “at least one of A, B, and/or C.” (In this document, the term “/” and “,” should be interpreted to indicate “and/or.” For instance, the expression “A/B” may mean “A and/or B.” Further, “A, B” may mean “A and/or B.” Further, “A/B/C” may mean “at least one of A, B, and/or C.” Also, “A/B/C” may mean “at least one of A, B, and/or C.”)

Additionally, in the present document, the term “or” should be interpreted as “and/or.” For example, the expression “A or B” may mean 1) only “A”, 2) only “B”, and/or 3) “both A and B.” In other words, the term “or” in the present document may mean “additionally or alternatively.” (Further, in the document, the term “or” should be interpreted to indicate “and/or.” For instance, the expression “A or B” may comprise 1) only A, 2) only B, and/or 3) both A and B. In other words, the term “or” in this document should be interpreted to indicate “additionally or alternatively.”)

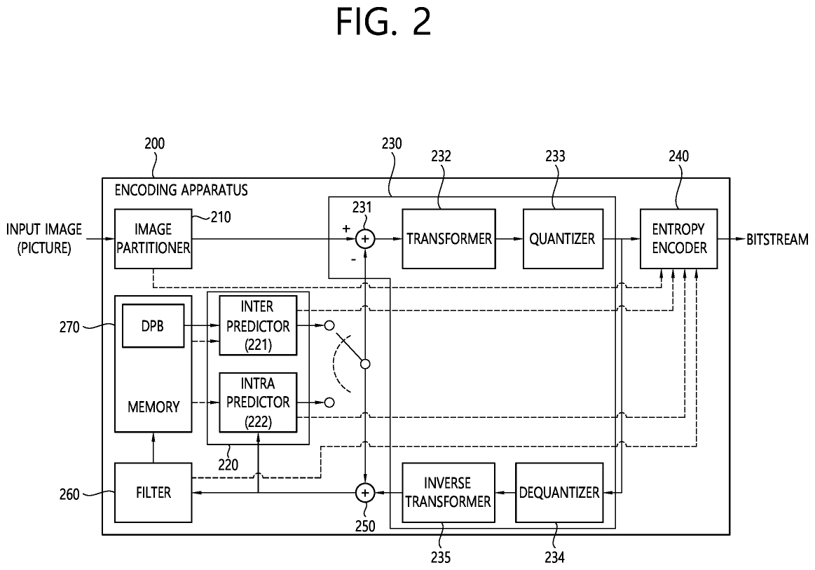

FIG. 2 is a diagram schematically illustrating a configuration of a video/image encoding apparatus to which the embodiments of the present document may be applied. Hereinafter, what is referred to as the video encoding apparatus may include an image encoding apparatus.

Referring to FIG. 2, the encoding apparatus 200 may include and be configured with an image partitioner 210, a predictor 220, a residual processor 230, an entropy encoder 240, an adder 250, a filter 260, and a memory 270. The predictor 220 may include an inter predictor 221 and an intra predictor 222. The residual processor 230 may include a transformer 232, a quantizer 233, a dequantizer 234, and an inverse transformer 235. The residual processor 230 may further include a subtractor 231. The adder 250 may be called a reconstructor or reconstructed block generator. The image partitioner 210, the predictor 220, the residual processor 230, the entropy encoder 240, the adder 250, and the filter 260, which have been described above, may be configured by one or more hardware components (e.g., encoder chipsets or processors) according to an embodiment. In addition, the memory 270 may include a decoded picture buffer (DPB), and may also be configured by a digital storage medium. The hardware component may further include the memory 270 as an internal/external component.

The image partitioner 210 may split an input image (or, picture, frame) input to the encoding apparatus 200 into one or more processing units. As an example, the processing unit may be called a coding unit (CU). In this case, the coding unit may be recursively split according to a Quad-tree binary-tree ternary-tree (QTBTTT) structure from a coding tree unit (CTU) or the largest coding unit (LCU). For example, one coding unit may be split into a plurality of coding units of a deeper depth based on a quad-tree structure, a binary-tree structure, and/or a ternary-tree structure. In this case, for example, the quad-tree structure is first applied and the binary-tree structure and/or the ternary-tree structure may be later applied. Alternatively, the binary-tree structure may also be first applied. A coding procedure according to the present document may be performed based on a final coding unit which is not split any more. In this case, based on coding efficiency according to image characteristics or the like, the maximum coding unit may be directly used as the final coding unit, or as necessary, the coding unit may be recursively split into coding units of a deeper depth, such that a coding unit having an optimal size may be used as the final coding unit. Here, the coding procedure may include a procedure such as prediction, transform, and reconstruction to be described later. As another example, the processing unit may further include a prediction unit (PU) or a transform unit (TU). In this case, each of the prediction unit and the transform unit may be split or partitioned from the aforementioned final coding unit. The prediction unit may be a unit of sample prediction, and the transform unit may be a unit for inducing a transform coefficient and/or a unit for inducing a residual signal from the transform coefficient.

The unit may be interchangeably used with the term such as a block or an area in some cases. Generally, an M×N block may represent samples composed of M columns and N rows or a group of transform coefficients. The sample may generally represent a pixel or a value of the pixel, and may also represent only the pixel/pixel value of a luma component, and also represent only the pixel/pixel value of a chroma component. The sample may be used as the term corresponding to a pixel or a pel configuring one picture (or image).

The encoding apparatus 200 may generate a residual signal (residual block, residual sample array) by subtracting a predicted signal (predicted block, prediction sample array) output from the inter predictor 221 or the intra predictor 222 from the input image signal (original block, original sample array), and the generated residual signal is transmitted to the transformer 232. In this case, as illustrated, the unit for subtracting the predicted signal (predicted block, prediction sample array) from the input image signal (original block, original sample array) within an encoder 200 may be called the subtractor 231. The predictor may perform prediction for a block to be processed (hereinafter, referred to as a current block), and generate a predicted block including prediction samples of the current block. The predictor may determine whether intra prediction is applied or inter prediction is applied in units of the current block or the CU. The predictor may generate various information about prediction, such as prediction mode information, to transfer the generated information to the entropy encoder 240 as described later in the description of each prediction mode. The information about prediction may be encoded by the entropy encoder 240 to be output in a form of the bitstream.

The intra predictor 222 may predict a current block with reference to samples within a current picture. The referenced samples may be located neighboring to the current block, or may also be located away from the current block according to the prediction mode. The prediction modes in the intra prediction may include a plurality of non-directional modes and a plurality of directional modes. The non-directional mode may include, for example, a DC mode or a planar mode. The directional mode may include, for example, 33 directional prediction modes or 65 directional prediction modes according to the fine degree of the prediction direction. However, this is illustrative and the directional prediction modes which are more or less than the above number may be used according to the setting. The intra predictor 222 may also determine the prediction mode applied to the current block using the prediction mode applied to the neighboring block.

The inter predictor 221 may induce a predicted block of the current block based on a reference block (reference sample array) specified by a motion vector on a reference picture. At this time, in order to decrease the amount of motion information transmitted in the inter prediction mode, the motion information may be predicted in units of a block, a sub-block, or a sample based on the correlation of the motion information between the neighboring block and the current block. The motion information may include a motion vector and a reference picture index. The motion information may further include inter prediction direction (L0 prediction, L1 prediction, Bi prediction, or the like) information. In the case of the inter prediction, the neighboring block may include a spatial neighboring block existing within the current picture and a temporal neighboring block existing in the reference picture. The reference picture including the reference block and the reference picture including the temporal neighboring block may also be the same as each other, and may also be different from each other. The temporal neighboring block may be called the name such as a collocated reference block, a collocated CU (colCU), or the like, and the reference picture including the temporal neighboring block may also be called a collocated picture (colPic). For example, the inter predictor 221 may configure a motion information candidate list based on the neighboring blocks, and generate information indicating what candidate is used to derive the motion vector and/or the reference picture index of the current block. The inter prediction may be performed based on various prediction modes, and for example, in the case of a skip mode and a merge mode, the inter predictor 221 may use the motion information of the neighboring block as the motion information of the current block. In the case of the skip mode, the residual signal may not be transmitted unlike the merge mode. A motion vector prediction (MVP) mode may indicate the motion vector of the current block by using the motion vector of the neighboring block as a motion vector predictor, and signaling a motion vector difference.

The predictor 200 may generate a predicted signal based on various prediction methods to be described later. For example, the predictor may not only apply the intra prediction or the inter prediction for predicting one block, but also simultaneously apply the intra prediction and the inter prediction. This may be called a combined inter and intra prediction (CIIP). Further, the predictor may be based on an intra block copy (IBC) prediction mode, or a palette mode in order to perform prediction on a block. The IBC prediction mode or palette mode may be used for content image/video coding of a game or the like, such as screen content coding (SCC). The IBC basically performs prediction in a current picture, but it may be performed similarly to inter prediction in that it derives a reference block in a current picture. That is, the IBC may use at least one of inter prediction techniques described in the present document. The palette mode may be regarded as an example of intra coding or intra prediction. When the palette mode is applied, a sample value in a picture may be signaled based on information about a palette index and a palette table.

The predicted signal generated through the predictor (including the inter predictor 221 and/or the intra predictor 222) may be used to generate a reconstructed signal or used to generate a residual signal. The transformer 232 may generate transform coefficients by applying the transform technique to the residual signal. For example, the transform technique may include at least one of a discrete cosine transform (DCT), a discrete sine transform (DST), a Karhunen-Loève transform (KLT), a graph-based transform (GBT), or a conditionally non-linear transform (CNT). Here, when the relationship information between pixels is illustrated as a graph, the GBT means the transform obtained from the graph. The CNT means the transform which is acquired based on a predicted signal generated by using all previously reconstructed pixels. In addition, the transform process may also be applied to a pixel block having the same size of the square, and may also be applied to the block having a variable size rather than the square.

The quantizer 233 may quantize the transform coefficients to transmit the quantized transform coefficients to the entropy encoder 240, and the entropy encoder 240 may encode the quantized signal (information about the quantized transform coefficients) to the encoded quantized signal to the bitstream. The information about the quantized transform coefficients may be called residual information. The quantizer 233 may rearrange the quantized transform coefficients having a block form in a one-dimensional vector form based on a coefficient scan order, and also generate the information about the quantized transform coefficients based on the quantized transform coefficients of the one dimensional vector form. The entropy encoder 240 may perform various encoding methods, for example, such as an exponential Golomb coding, a context-adaptive variable length coding (CAVLC), and a context-adaptive binary arithmetic coding (CABAC). The entropy encoder 240 may also encode information (e.g., values of syntax elements and the like) necessary for reconstructing video/image other than the quantized transform coefficients together or separately. The encoded information (e.g., encoded video/image information) may be transmitted or stored in units of network abstraction layer (NAL) unit in a form of the bitstream. The video/image information may further include information about various parameter sets such as an adaptation parameter set (APS), a picture parameter set (PPS), a sequence parameter set (SPS), or a video parameter set (VPS). In addition, the video/image information may further include general constraint information. The signaled/transmitted information and/or syntax elements to be described later in this document may be encoded through the aforementioned encoding procedure and thus included in the bitstream. The bitstream may be transmitted through a network, or stored in a digital storage medium. Here, the network may include a broadcasting network and/or a communication network, or the like, and the digital storage medium may include various storage media such as USB, SD, CD, DVD, Blue-ray, HDD, and SSD. A transmitter (not illustrated) for transmitting the signal output from the entropy encoder 240 and/or a storage (not illustrated) for storing the signal may be configured as the internal/external elements of the encoding apparatus 200, or the transmitter may also be included in the entropy encoder 240.

The quantized transform coefficients output from the quantizer 233 may be used to generate a predicted signal. For example, the dequantizer 234 and the inverse transformer 235 apply dequantization and inverse transform to the quantized transform coefficients, such that the residual signal (residual block or residual samples) may be reconstructed. The adder 250 adds the reconstructed residual signal to the predicted signal output from the inter predictor 221 or the intra predictor 222, such that the reconstructed signal (reconstructed picture, reconstructed block, reconstructed sample array) may be generated. As in the case where the skip mode is applied, if there is no residual for the block to be processed, the predicted block may be used as the reconstructed block. The adder 250 may be called a reconstructor or a reconstructed block generator. The generated reconstructed signal may be used for the intra prediction of the next block to be processed within the current picture, and as described later, also used for the inter prediction of the next picture through filtering.

Meanwhile, a luma mapping with chroma scaling (LMCS) may also be applied in a picture encoding and/or reconstruction process.

The filter 260 may apply filtering to the reconstructed signal, thereby improving subjective/objective image qualities. For example, the filter 260 may apply various filtering methods to the reconstructed picture to generate a modified reconstructed picture, and store the modified reconstructed picture in the memory 270, specifically, the DPB of the memory 270. Various filtering methods may include, for example, a deblocking filtering, a sample adaptive offset, an adaptive loop filter, a bilateral filter, and the like. The filter 260 may generate various filtering-related information to transfer the generated information to the entropy encoder 240, as described later in the description of each filtering method. The filtering-related information may be encoded by the entropy encoder 240 to be output in a form of the bitstream.

The modified reconstructed picture transmitted to the memory 270 may be used as the reference picture in the inter predictor 221. If the inter prediction is applied by the inter predictor, the encoding apparatus may avoid the prediction mismatch between the encoding apparatus 200 and the decoding apparatus, and also improve coding efficiency.

The DPB of the memory 270 may store the modified reconstructed picture to be used as the reference picture in the inter predictor 221. The memory 270 may store motion information of the block in which the motion information within the current picture is derived (or encoded) and/or motion information of the blocks within the previously reconstructed picture. The stored motion information may be transferred to the inter predictor 221 to be utilized as motion information of the spatial neighboring block or motion information of the temporal neighboring block. The memory 270 may store the reconstructed samples of the reconstructed blocks within the current picture, and transfer the reconstructed samples to the intra predictor 222.

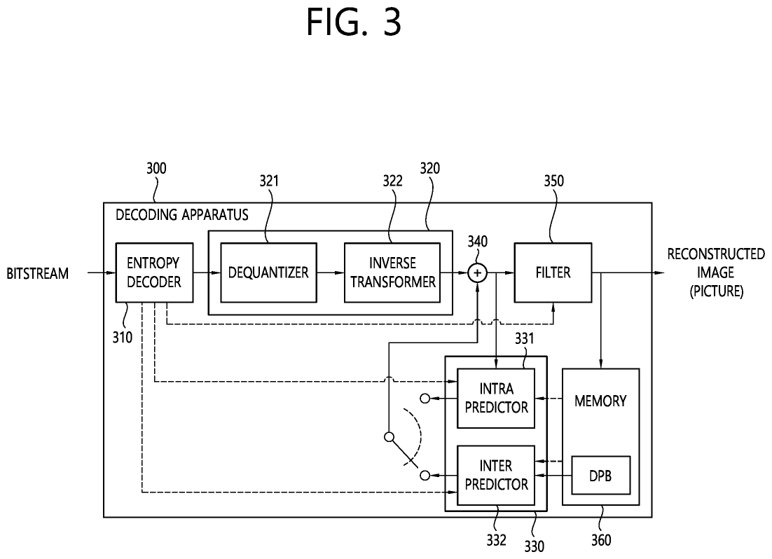

FIG. 3 is a diagram for schematically explaining a configuration of a video/image decoding apparatus to which the embodiments of the the present disclosure is applicable.

Referring to FIG. 3, the decoding apparatus 300 may include and configured with an entropy decoder 310, a residual processor 320, a predictor 330, an adder 340, a filter 350, and a memory 360. The predictor 330 may include an inter predictor 331 and an intra predictor 332. The residual processor 320 may include a dequantizer 321 and an inverse transformer 322. The entropy decoder 310, the residual processor 320, the predictor 330, the adder 340, and the filter 350, which have been described above, may be configured by one or more hardware components (e.g., decoder chipsets or processors) according to an embodiment. Further, the memory 360 may include a decoded picture buffer (DPB), and may be configured by a digital storage medium. The hardware component may further include the memory 360 as an internal/external component.

When the bitstream including the video/image information is input, the decoding apparatus 300 may reconstruct the image in response to a process in which the video/image information is processed in the encoding apparatus. For example, the decoding apparatus 300 may derive the units/blocks based on block split-related information acquired from the bitstream. The decoding apparatus 300 may perform decoding using the processing unit applied to the encoding apparatus. Therefore, the processing unit for the decoding may be, for example, a coding unit, and the coding unit may be split according to the quad-tree structure, the binary-tree structure, and/or the ternary-tree structure from the coding tree unit or the maximum coding unit. One or more transform units may be derived from the coding unit. In addition, the reconstructed image signal decoded and output through the decoding apparatus 300 may be reproduced through a reproducing apparatus.

The decoding apparatus 300 may receive the signal output from the encoding apparatus in a form of the bitstream, and the received signal may be decoded through the entropy decoder 310. For example, the entropy decoder 310 may derive information (e.g., video/image information) necessary for the image reconstruction (or picture reconstruction) by parsing the bitstream. The video/image information may further include information about various parameter sets such as an adaptation parameter set (APS), a picture parameter set (PPS), a sequence parameter set (SPS), and a video parameter set (VPS). In addition, the video/image information may further include general constraint information. The decoding apparatus may decode the picture further based on the information about the parameter set and/or the general constraint information. The signaled/received information and/or syntax elements to be described later in this document may be decoded through the decoding procedure and acquired from the bitstream. For example, the entropy decoder 310 may decode information within the bitstream based on a coding method such as an exponential Golomb coding, a CAVLC, or a CABAC, and output a value of the syntax element necessary for the image reconstruction, and the quantized values of the residual-related transform coefficient. More specifically, the CABAC entropy decoding method may receive a bin corresponding to each syntax element from the bitstream, determine a context model using syntax element information to be decoded and decoding information of the neighboring block and the block to be decoded or information of the symbol/bin decoded in the previous stage, and generate a symbol corresponding to a value of each syntax element by predicting the probability of generation of the bin according to the determined context model to perform the arithmetic decoding of the bin. At this time, the CABAC entropy decoding method may determine the context model and then update the context model using the information of the decoded symbol/bin for a context model of a next symbol/bin. The information about prediction among the information decoded by the entropy decoder 310 may be provided to the predictor (the inter predictor 332 and the intra predictor 331), and a residual value at which the entropy decoding is performed by the entropy decoder 310, that is, the quantized transform coefficients and the related parameter information may be input to the residual processor 320. The residual processor 320 may derive a residual signal (residual block, residual samples, residual sample array). In addition, the information about filtering among the information decoded by the entropy decoder 310 may be provided to the filter 350. Meanwhile, a receiver (not illustrated) for receiving the signal output from the encoding apparatus may be further configured as the internal/external element of the decoding apparatus 300, or the receiver may also be a component of the entropy decoder 310. Meanwhile, the decoding apparatus according to this document may be called a video/image/picture decoding apparatus, and the decoding apparatus may also be classified into an information decoder (video/image/picture information decoder) and a sample decoder (video/image/picture sample decoder). The information decoder may include the entropy decoder 310, and the sample decoder may include at least one of the dequantizer 321, the inverse transformer 322, the adder 340, the filter 350, the memory 360, the inter predictor 332, and the intra predictor 331.

The dequantizer 321 may dequantize the quantized transform coefficients to output the transform coefficients. The dequantizer 321 may rearrange the quantized transform coefficients in a two-dimensional block form. In this case, the rearrangement may be performed based on a coefficient scan order performed by the encoding apparatus. The dequantizer 321 may perform dequantization for the quantized transform coefficients using a quantization parameter (e.g., quantization step size information), and acquire the transform coefficients.

The inverse transformer 322 inversely transforms the transform coefficients to acquire the residual signal (residual block, residual sample array).

The predictor 330 may perform the prediction of the current block, and generate a predicted block including the prediction samples of the current block. The predictor may determine whether the intra prediction is applied or the inter prediction is applied to the current block based on the information about prediction output from the entropy decoder 310, and determine a specific intra/inter prediction mode.

The predictor may generate the predicted signal based on various prediction methods to be described later. For example, the predictor may not only apply the intra prediction or the inter prediction for the prediction of one block, but also apply the intra prediction and the inter prediction at the same time. This may be called a combined inter and intra prediction (CIIP). Further, the predictor may be based on an intra block copy (IBC) prediction mode, or a palette mode in order to perform prediction on a block. The IBC prediction mode or palette mode may be used for content image/video coding of a game or the like, such as screen content coding (SCC). The IBC basically performs prediction in a current picture, but it may be performed similarly to inter prediction in that it derives a reference block in a current picture. That is, the IBC may use at least one of inter prediction techniques described in the present document. The palette mode may be regarded as an example of intra coding or intra prediction. When the palette mode is applied, information about a palette table and a palette index may be included in the video/image information and signaled.

The intra predictor 331 may predict the current block with reference to the samples within the current picture. The referenced samples may be located neighboring to the current block according to the prediction mode, or may also be located away from the current block. The prediction modes in the intra prediction may include a plurality of non-directional modes and a plurality of directional modes. The intra predictor 331 may also determine the prediction mode applied to the current block using the prediction mode applied to the neighboring block.

The inter predictor 332 may induce the predicted block of the current block based on the reference block (reference sample array) specified by the motion vector on the reference picture. At this time, in order to decrease the amount of the motion information transmitted in the inter prediction mode, the motion information may be predicted in units of a block, a sub-block, or a sample based on the correlation of the motion information between the neighboring block and the current block. The motion information may include a motion vector and a reference picture index. The motion information may further include inter prediction direction (L0 prediction, L1 prediction, Bi prediction, or the like) information. In the case of the inter prediction, the neighboring block may include a spatial neighboring block existing within the current picture and a temporal neighboring block existing in the reference picture. For example, the inter predictor 332 may configure a motion information candidate list based on the neighboring blocks, and derive the motion vector and/or the reference picture index of the current block based on received candidate selection information. The inter prediction may be performed based on various prediction modes, and the information about the prediction may include information indicating the mode of the inter prediction of the current block.

The adder 340 may add the acquired residual signal to the predicted signal (predicted block, prediction sample array) output from the predictor (including the inter predictor 332 and/or the intra predictor 331) to generate the reconstructed signal (reconstructed picture, reconstructed block, reconstructed sample array). As in the case where the skip mode is applied, if there is no residual for the block to be processed, the predicted block may be used as the reconstructed block.

The adder 340 may be called a reconstructor or a reconstructed block generator. The generated reconstructed signal may be used for the intra prediction of a next block to be processed within the current picture, and as described later, may also be output through filtering or may also be used for the inter prediction of a next picture.

Meanwhile, a luma mapping with chroma scaling (LMCS) may also be applied in the picture decoding process.

The filter 350 may apply filtering to the reconstructed signal, thereby improving the subjective/objective image qualities. For example, the filter 350 may apply various filtering methods to the reconstructed picture to generate a modified reconstructed picture, and transmit the modified reconstructed picture to the memory 360, specifically, the DPB of the memory 360. Various filtering methods may include, for example, a deblocking filtering, a sample adaptive offset, an adaptive loop filter, a bidirectional filter, and the like.

The (modified) reconstructed picture stored in the DPB of the memory 360 may be used as the reference picture in the inter predictor 332. The memory 360 may store motion information of the block in which the motion information within the current picture is derived (decoded) and/or motion information of the blocks within the previously reconstructed picture. The stored motion information may be transferred to the inter predictor 260 to be utilized as motion information of the spatial neighboring block or motion information of the temporal neighboring block. The memory 360 may store the reconstructed samples of the reconstructed blocks within the current picture, and transfer the stored reconstructed samples to the intra predictor 331.

In the present specification, the exemplary embodiments described in the filter 260, the inter predictor 221, and the intra predictor 222 of the encoding apparatus 200 may be applied equally to or to correspond to the filter 350, the inter predictor 332, and the intra predictor 331 of the decoding apparatus 300, respectively.

Meanwhile, as described above, in performing video coding, prediction is performed to improve compression efficiency. Through this, a predicted block including prediction samples for a current block as a block to be coded (i.e., a coding target block) may be generated. Here, the predicted block includes prediction samples in a spatial domain (or pixel domain). The predicted block is derived in the same manner in an encoding apparatus and a decoding apparatus, and the encoding apparatus may signal information (residual information) on residual between the original block and the predicted block, rather than an original sample value of an original block, to the decoding apparatus, thereby increasing image coding efficiency. The decoding apparatus may derive a residual block including residual samples based on the residual information, add the residual block and the predicted block to generate reconstructed blocks including reconstructed samples, and generate a reconstructed picture including the reconstructed blocks.

The residual information may be generated through a transform and quantization procedure. For example, the encoding apparatus may derive a residual block between the original block and the predicted block, perform a transform procedure on residual samples (residual sample array) included in the residual block to derive transform coefficients, perform a quantization procedure on the transform coefficients to derive quantized transform coefficients, and signal related residual information to the decoding apparatus (through a bit stream). Here, the residual information may include value information of the quantized transform coefficients, location information, a transform technique, a transform kernel, a quantization parameter, and the like. The decoding apparatus may perform dequantization/inverse transform procedure based on the residual information and derive residual samples (or residual blocks). The decoding apparatus may generate a reconstructed picture based on the predicted block and the residual block. Also, for reference for inter prediction of a picture afterward, the encoding apparatus may also dequantize/inverse-transform the quantized transform coefficients to derive a residual block and generate a reconstructed picture based thereon.

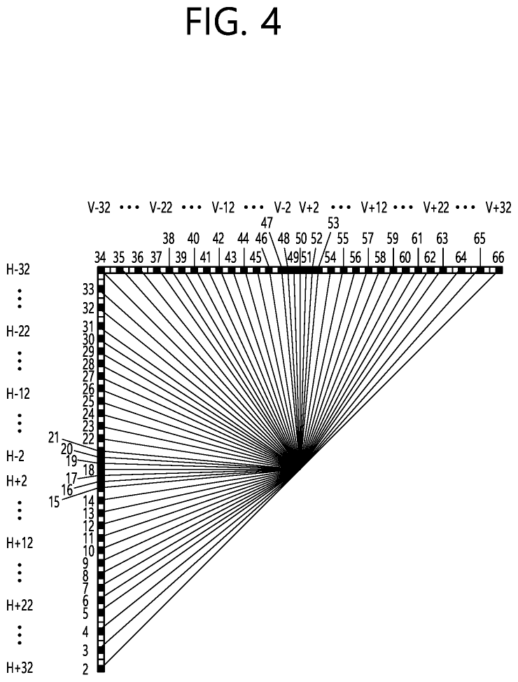

FIG. 4 exemplary illustrates intra directional modes of 65 prediction directions.

Referring to FIG. 4, among intra modes, a directional mode or an angular mode may be discriminated by an intra prediction mode having horizontal directionality and an intra prediction mode having vertical directionality from each other around No. 34 intra prediction mode having top-left diagonal prediction direction. In FIG. 4, H and V mean the horizontal directionality and the vertical directionality, respectively, and numerals of −32 to 32 represent displacements in the unit of 1/32 on a sample grid position. No. 2 to No. 33 intra prediction modes have the horizontal directionality, and No. 34 to No. 66 intra prediction modes have the vertical directionality. No. 18 intra prediction mode and No. 50 intra prediction mode represent a horizontal intra prediction mode (or a horizontal mode) and a vertical intra prediction mode (or a vertical mode), respectively. No. 2 intra prediction mode may be called a bottom-left diagonal intra prediction mode, No. 34 intra prediction mode may be called a top-left diagonal intra prediction mode, and No. 66 intra prediction mode may be called a top-right diagonal intra prediction mode.

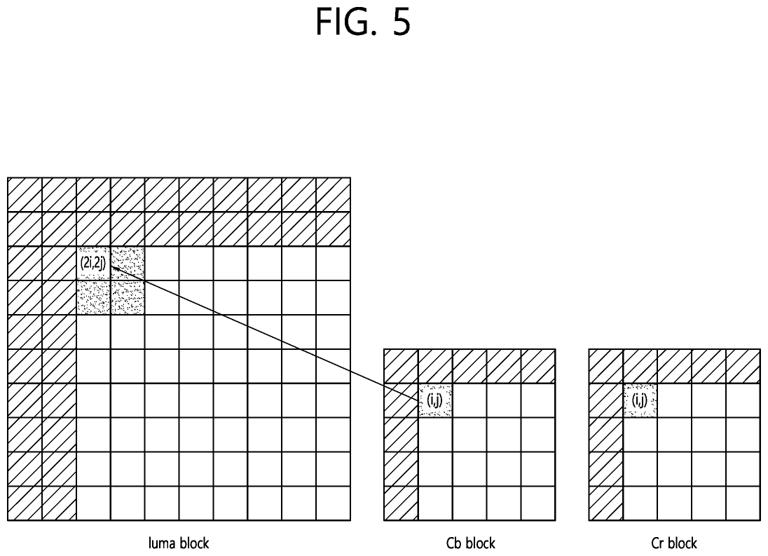

FIG. 5 is a diagram for describing a process of deriving an intra prediction mode of a current chroma block according to an embodiment.

In this specification, the term “current chroma block” may refer to a chroma component block of a current block, which is a current coding unit, and the term “current luma block” may refer to a luma component block of a current block, which is a current coding unit. Therefore, the current luma block and the current chroma block correspond to each other. However, the block shape and the number of blocks of the current luma block and the current chroma block are not always the same to each other, and may be different from each other in some cases. In some cases, the current chroma block may correspond to the current luma region, and in this case, the current luma region may include at least one luma block.

In this specification, the term “reference sample template” may refer to a set of reference samples neighboring the current chroma block for predicting the current chroma block. The reference sample template may be predefined, and information about the reference sample template may be signaled from the encoding apparatus 200 to the decoding apparatus 300.

Referring to FIG. 5, a set of shaded samples arranged in one line and neighboring a 4×4 block which is a current chroma block indicates a reference sample template. It can be seen from FIG. 5 that the reference sample template includes one line of reference samples, whereas the reference sample region in the luma region corresponding to the reference sample template includes two lines thereof.

In an embodiment, when performing intra encoding of a chroma image, a Cross Component Linear Model (CCLM) may be used. The CCLM is a method of predicting a pixel value of a chroma image from a pixel value of a reconstructed luma image, and is based on a characteristic of high correlation between a luma image and a chroma image.

CCLM prediction of Cb and Cr chroma images may be based on the following equation.

Pred_{C}(x,y)=α·Rec′_{L}(x,y)+β [Equation 1]

Here, pred_{c}(x, y) means Cb or Cr chroma image to be predicted, Rec_{L}′(x, y) means a reconstructed luma image which has been adjusted to a chroma block size, and (x, y) means a coordinate of a pixel. In 4:2:0 color format, since the size of luma image is double of that of a chroma image, Rec_{L}′ of a chroma block size should be generated through downsampling, and accordingly, a pixel of luma image to be used in chroma image pred_{c}(x, y) may be used by considering neighboring pixels in addition to Rec_{L} (2x, 2y). The Rec_{L}′(x, y) may be referred to as a downsampled luma sample.

For example, the Rec_{L}′(x, y) may be derived by using 6 neighboring pixels as in the following equation.

Rec′_{L}(x,y)=(2×Rec_{L}(2x, 2y)+2×Rec_{L}(2x, 2y+1)+Rec_{L}(2x−1,2y)+Rec_{L}(2x+1,2y)+Rec_{L}(2x−1,2y+1)+Rec_{L}(2x+1,2y+1)+4)>>3 [Equation 2]

In addition, α and β denote cross-correlation and difference in average values between the Cb or Cr chroma block neighboring template and the luma block neighboring template, as shown in the shaded region of FIG. 5, and α and β are, for example, as shown in Equation 3 below.

$$α = \frac{N \cdot \sum ( L ( n ) \cdot C ( n ) ) - \sum L ( n ) \cdot \sum C ( n )}{N \cdot \sum ( L ( n ) \cdot L ( n ) ) - \sum L ( n ) \cdot \sum L ( n )} \\ β = \frac{\sum C ( n ) - α \cdot \sum L ( n )}{N} \qquad [ Equation 3 ]$$

Here, N may denote the total number of sample pair values used for the CCLM parameter calculation, L(n) may denote a downsampled luma sample value, and C(n) may denote a chroma sample value.

Meanwhile, samples for parameter calculation (i.e., for example, the α and β) for the above-described CCLM prediction may be selected as follows.

When the current chroma block is a chroma block of size N×N, a total of 2N (N horizontal, N vertical) neighboring reference sample pairs (luma and chroma) of the current chroma block may be selected.

When the current chroma block is a chroma block of size N×M or size M×N (here, N<=M), a total of 2N (N horizontal, N vertical) neighboring reference sample pairs of the current chroma block may be selected. Meanwhile, since M is greater than N (e.g., M=2N, or 3N, etc.), N sample pairs may be selected from among M samples through subsampling.

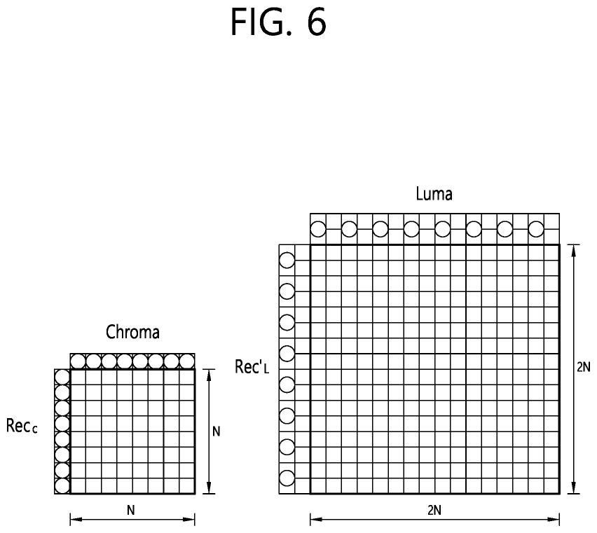

FIG. 6 shows 2N reference samples for parameter calculation for the aforementioned CCLM prediction. Referring to FIG. 6, 2N reference sample pairs derived for parameter calculation for the CCLM prediction may be illustrated. The 2N reference sample pair may include 2N reference samples adjacent to the current chroma block and 2N reference samples adjacent to the current luma block.

As described above, 2N sample pairs may be derived, and when the CCLM parameters α and β are calculated through Equation 3 above using the sample pairs, operations as many times as the number in Table 1 below may be required.

TABLE 1

| operations | Number of operations |
|---|---|
| Multiplications | 2N + 5 |
| Sums | 8N − 1 |
| Division | 2 |

Referring to Table 1, for example, in the case of a 4×4 size chroma block, 21 times multiplication operations and 31 times addition operations may be required to calculate the CCLM parameter, and in the case of a 32×32 size chroma block, 133 times multiplication operations and 255 times addition operation may be required. That is, as the size of the chroma block increases, the operation amount required for CCLM parameter calculation increases rapidly, which may directly lead to a delay problem in hardware implementation. In particular, since the CCLM parameter must be derived through calculation even in the decoding apparatus, it may lead to a delay problem and an increase in implementation cost in hardware implementation of the decoding apparatus.

Accordingly, an embodiment can reduce the computational complexity for deriving the CCLM parameter, thereby reducing the hardware cost of the decoding apparatus and the complexity and time of the decoding process.

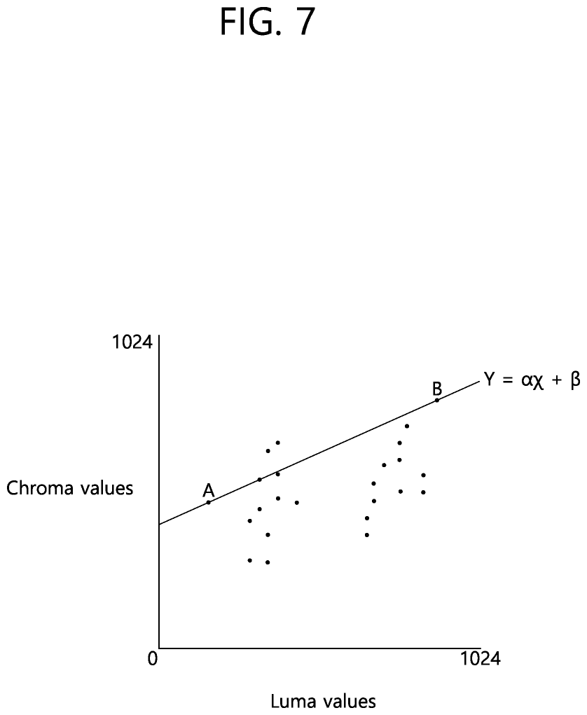

FIG. 7 is a diagram for explaining a simplified CCLM parameter calculation method.

Referring to FIG. 7, according to an embodiment, in order to reduce multiplication and addition operations in calculating α and β, a parameter may be calculated as in Equation 4 by using the slope of change of two luma and chroma sample pairs.

$$α = \frac{{y}_{B} - {y}_{A}}{{x}_{B} - {x}_{A}} , β = {y}_{A} - α {x}_{A} \qquad [ Equation 4 ]$$

Here, (x_{A}, y_{A}) may denote the smallest luma sample value (x_{A}) among reference samples neighboring the current block for CCLM parameter calculation and a chroma sample value (y_{A}) which is a pair thereof, and (x_{B}, y_{B}) may denote the largest luma sample value (x_{B}) among reference samples neighboring the current block for CCLM parameter calculation and a chroma sample value (y_{B}) which is a pair thereof.

When Equation 4 is used, there is an advantage in that multiplication and addition operations can be significantly reduced compared to the conventional method, but a comparison operation is added because the minimum and maximum values of the luma samples neighboring the current block need to be determined. In other words, 4N times comparison operations are required to determine the minimum and maximum values from 2N samples, and the addition of such comparison operations may still cause the delay in hardware implementation.

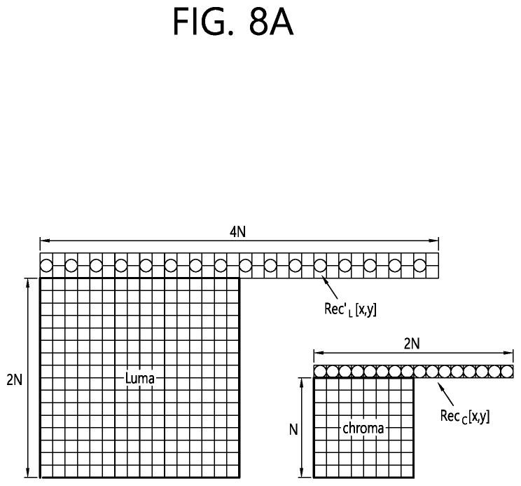

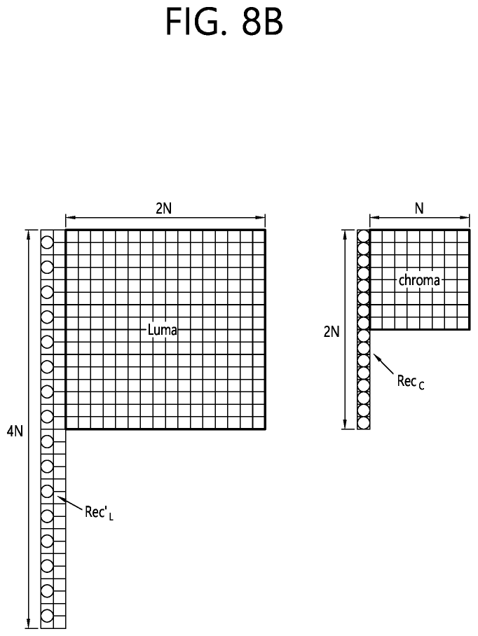

FIGS. 8A and 8B are diagrams for explaining an LM_A mode and an LM_L mode.

Multi-directional LM (MDLM) may perform CCLM prediction by adding the LM_A mode (see FIG. 8A) and the LM_L mode (see FIG. 8B). In other words, referring to FIG. 8A, in the LM_A mode, CCLM may be performed using only the top reference samples of the current block. At this time, CCLM prediction may be performed by extending the existing top reference samples to the right with a total length twice. Here, the LM_A mode may be referred to as an LM_T mode. In other words, referring to FIG. 8B, in the LM_L mode, CCLM is performed using only the left reference samples of the current block. At this time, CCLM prediction is performed by extending the existing left reference samples to the bottom with a total length twice. Calculation of parameters α and β in MDLM may use the slope of change of the two luma and chroma sample pairs described above. Therefore, many comparison operations are required even in MDLM calculation, and since adding such comparison operations still causes the delay in hardware implementation, a method for reducing them may be required.

In an embodiment, after setting an top limit Nₜₕ for selecting a neighboring sample in order to address the problem of increase in the CCLM parameter operation amount by the increase in the chroma block size, the CCLM parameter may be calculated by selecting samples neighboring the chroma block as described later. The Nₜₕ may be referred to as the maximum number of neighboring samples. For example, Nₜₕ may be set to 2, 4, 8 or 16.

The CCLM parameter calculation process may be as follows.

When the current chroma block is a chroma block of size N×N, and Nₜₕ>=N, a total of 2N (N horizontal, N vertical) neighboring reference sample pairs of the current chroma block may be selected.

When the current chroma block is a chroma block of size N×N, and Nₜₕ<N, a total of 2*Nₜₕ (Nₜₕ horizontal, Nₜₕ vertical) neighboring reference sample pairs of the current chroma block may be selected.

When the current chroma block is a chroma block of size N×M or size M×N (here, N<=M), and Nₜₕ>=N, a total of 2N (N horizontal, N vertical) neighboring reference sample pairs of the current chroma block may be selected. Since M is greater than N (e.g., M=2N, or 3N, etc.), N samples may be selected from among M samples through subsampling.

When the current chroma block is a chroma block of size N×M or size M×N (here, N<=M), and Nₜₕ<N, a total of 2*Nₜₕ (Nₜₕ horizontal, Nₜₕ vertical) neighboring reference sample pairs of the current chroma block may be selected. Since M is greater than N (e.g., M=2N, or 3N, etc.), Nₜₕ samples may be selected from among M samples through subsampling.

As described above, this embodiment can limit the number of neighboring reference samples for CCLM parameter calculation by setting Nth, which is the maximum value of the number of selected neighboring samples, through which CCLM parameters can be calculated through relatively lesser calculations even in a large chroma block.

In addition, when Nₜₕ is set to an appropriately small number (e.g., 4 or 8), a worst case operation (e.g., a chroma block of size 32×32) can be avoided when implementing hardware of CCLM parameter calculation, and thus, it is possible to reduce the number of hardware gates required in preparation for the worst case, through which it is possible to obtain an effect of reducing hardware implementation cost.

For example, when the Nₜₕ is 2, 4 and 8, an amount of CCLM parameter calculation according to a chroma block size may be represented as in the following table.

TABLE 2

Number of operations (multiplication + sums)

| | | Proposed | Proposed | Proposed |
|---|---|---|---|---|
| Block | Original | method | method | method |
| size | CCLM | (Nₜₕ = 2) | (Nₜₕ = 4) | (Nₜₕ = 8) |
| N = 2 | 24 | 24 | 24 | 24 |
| N = 4 | 44 | 24 | 44 | 44 |
| N = 8 | 84 | 24 | 44 | 84 |
| N = 16 | 164 | 24 | 44 | 84 |
| N = 32 | 324 | 24 | 44 | 84 |

Meanwhile, the Nₜₕ may be derived with a preset value in the encoding apparatus and the decoding apparatus without the need to transmit additional information indicating the Nth. Alternatively, the additional information indicating the Nₜₕ may be transmitted in units of coding units (CUs), slices, pictures, or sequences, and the Nₜₕ may be derived based on the additional information indicating the Nth. The additional information indicating the Nₜₕ may indicate the value of the Nth. Hereinafter, transmitting or signaling the Nₜₕ value may indicate that information about the Nₜₕ value is transmitted or signaled from the encoder to the decoder.

For example, when additional information indicating Nₜₕ is transmitted in units of CUs, if the intra prediction mode of the current chroma block is the CCLM mode, then a method may be proposed in which the cclm_reduced_sample_flag syntax element is parsed and the CCLM parameter calculation process is performed as described below. The cclm_reduced_sample_flag syntax element may indicate a syntax element of a CCLM reduced sample flag.

When the value of the cclm_reduced_sample_flag syntax element is 0 (false), CCLM parameter calculation is performed through the existing CCLM neighboring sample selection method

When the value of the cclm_reduced_sample_flag syntax element is 1 (true), the Nₜₕ=2 is set, and CCLM parameter calculation is performed through the neighboring sample selection method proposed in the above-described embodiment

Alternatively, when additional information indicating Nₜₕ is transmitted in units of slices, pictures, or sequences, the Nₜₕ value may be decoded based on the additional information transmitted through high level syntax (HLS) as described later. In this case, the information about the Nₜₕ value may be encoded by the encoder and transmitted while being included in the bitstream, and hereinafter is the same. In this document, a slice/slice header may be replaced with a tile/tile header or a tile group/tile group header.

For example, the additional information signaled through the slice header may be represented as shown in the following table.

TABLE 3

| | Descriptor |
|---|---|
| slice_header( ) { | |
| ... | |
| cclm_reduced_sample_num | f(2) |
| ... | |

The cclm_reduced_sample_num syntax element may represent a syntax element of additional information indicating the Nth.

Alternatively, for example, the additional information signaled through a picture parameter set (PPS) may be represented as shown in the following table.

TABLE 4

| | Descriptor |
|---|---|
| pic_parameter_set_rbsp( ) { | |
| ... | |
| cclm_reduced_sample_num | f(2) |
| ... | |

Alternatively, for example, the additional information signaled through a Sequence Parameter Set (SPS) may be represented as shown in the following table.

TABLE 5

| | Descriptor |
|---|---|
| seq_parameter_set_rbsp( ) { | |
| ... | |
| cclm_reduced_sample_num | f(2) |
| ... | |

The Nₜₕ value derived based on the value of the cclm_reduced_sample_num syntax element transmitted through the slice header, the PPS or the SPS (i.e., a value derived by decoding cclm_reduced_sample_num) may be derived as shown in the following table.

TABLE 6

| cclm_reduced_sample_num | Nₜₕ |
|---|---|
| 0 | 2 |
| 1 | 4 |
| 2 | 8 |
| 3 | 16 |

For example, referring to Table 6, the Nₜₕ may be derived based on the cclm_reduced_sample_num syntax element. When the value of the cclm_reduced_sample_num syntax element is 0, the Nₜₕ may be derived as 2; when the value of the cclm_reduced_sample_num syntax element is 1, the Nₜₕ may be derived as 4; when the value of the cclm_reduced_sample_num syntax element is 2, the Nₜₕ may be derived as 8; and when the value of the cclm_reduced_sample_num syntax element is 3, the Nₜₕ may be derived as 16.

According to an embodiment, the operation amount required for the CCLM parameter calculation may not increase even when the block size increases. For example, in the case where the size of the chroma block is 32×32, when calculating the CCLM parameter (Nₜₕ=4) through the method proposed in one embodiment, the operation amount can be reduced by 86%.

The method proposed in one embodiment may be used for a CCLM mode which is a chroma intra prediction mode for a chroma component, and the chroma block predicted through the CCLM mode may be used to obtain a residual image through a difference from an original image in the encoding apparatus, or used to obtain reconstructed image through an addition with a residual signal in the decoding apparatus.

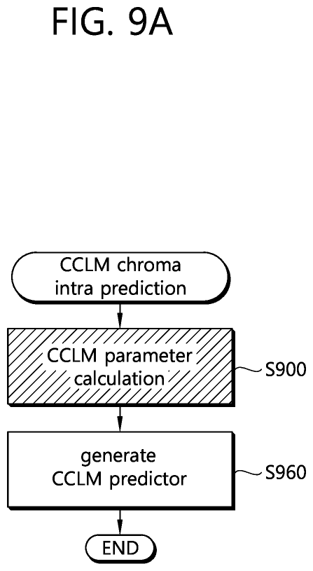

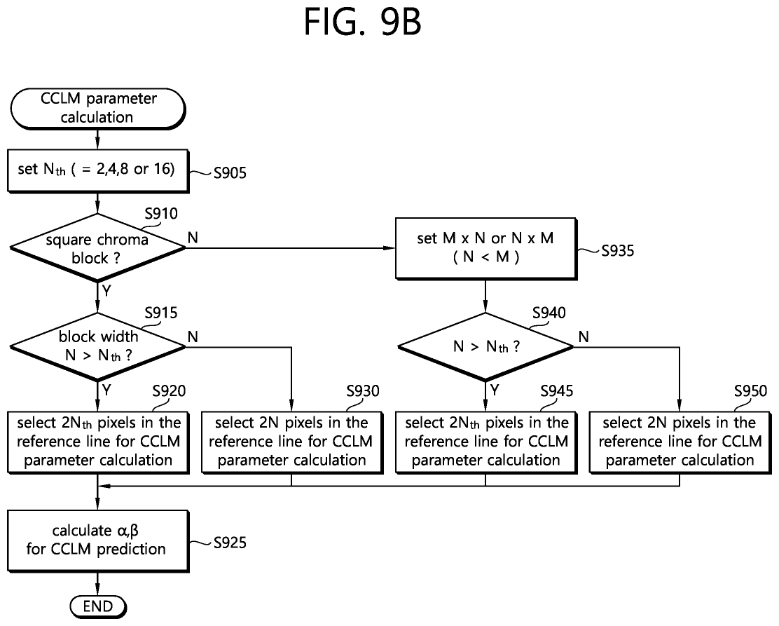

FIGS. 9A and 9B are diagrams for describing a process of performing CCLM prediction for a current chroma block according to an embodiment.

Referring to FIG. 9A, the encoding apparatus/decoding apparatus may calculate a CCLM parameter for the current block (S900). For example, the CCLM parameter may be calculated as an embodiment shown in FIG. 9B.

FIG. 9B may illustrate a specific embodiment of calculating the CCLM parameter. For example, referring to FIG. 9B, the encoding apparatus/decoding apparatus may set Nₜₕ for the current chroma block (S905). The Nₜₕ may be a preset value, or may be derived based on additional information about the signaled Nth. The Nₜₕ may be set to 2, 4, 8, or 16.

Thereafter, the encoding apparatus/decoding apparatus may determine whether or not the current chroma block is a square chroma block (S910).

When the current chroma block is the square chroma block, the encoding apparatus/decoding apparatus may determine whether or not the width N of the current block is greater than the Nₜₕ (S915).

When the N is greater than the Nth, the encoding apparatus/decoding apparatus may select 2 Nₜₕ neighboring samples in a reference line adjacent to the current block as a reference sample for the CCLM parameter calculation (S920).

The encoding apparatus/decoding apparatus may derive parameters α and β for the CCLM prediction based on the selected reference samples (S925).

Additionally, when the N is not greater than the Nth, the encoding apparatus/decoding apparatus may select 2N neighboring samples in a reference line adjacent to the current block as a reference sample for the CCLM parameter calculation (S930). Thereafter the encoding apparatus/decoding apparatus may derive parameters α and β for the CCLM prediction based on the selected reference samples (S925).

Meanwhile, in the case where the current chroma block is not the square chroma block, the size of the current chroma block may be derived as size M×N or size N×M (S935). Here, the M may represent a value greater than the N (N<M).

Thereafter, the encoding apparatus/decoding apparatus may determine whether or not the N is greater than the Nₜₕ (S940).

In the case where the N is greater than the Nth, the encoding apparatus/decoding apparatus may select 2 Nₜₕ neighboring samples in a reference line adjacent to the current block as a reference sample for the CCLM parameter calculation (S945).

The encoding apparatus/decoding apparatus may derive parameters α and β for the CCLM prediction based on the selected reference samples (S925).

Additionally, when the N is not greater than the Nth, the encoding apparatus/decoding apparatus may select 2N neighboring samples in a reference line adjacent to the current block as a reference sample for the CCLM parameter calculation (S950). Thereafter the encoding apparatus/decoding apparatus may derive parameters α and β for the CCLM prediction based on the selected reference samples (S925).

Referring back to FIG. 9a, in the case where the parameters for CCLM prediction for the current chroma block are calculated, the encoding apparatus/decoding apparatus may perform CCLM prediction based on the parameters and generate a prediction sample for the current chroma block (S960). For example, the encoding apparatus/decoding apparatus may generate a prediction sample for the current chroma block based on above Equation 1 in which the calculated parameters and reconstructed samples of the current luma block for the current chroma block are used.

In an embodiment, when Nₜₕ uses a promised value or a preset value in the encoding apparatus and the decoding apparatus without the need to transmit additional information, the encoding apparatus may perform the same operation as the decoding apparatus using the preset Nₜₕ value, and, as shown in FIGS. 9A and 9B, perform the CCLM parameter calculation in the same manner when performing the CCLM chroma intra prediction.

On the other hand, when additional information indicating Nₜₕ is transmitted in units of CUs, slices, pictures, or sequences, the encoding apparatus may determine the Nₜₕ value as follows, and may transmit to the decoding apparatus the additional information about the Nₜₕ indicating the Nₜₕ value. In this case, the information about the Nₜₕ value may be encoded by the encoding apparatus and transmitted while being included in the bitstream, and, in this case, as described above, may be transmitted while being included in the high-level syntax of the syntaxes included in the bitstream.

For example, in the case where the additional information indicating the Nₜₕ value is transmitted in units of CUs, when the intra prediction mode of the current chroma block is the CCLM mode, the encoding apparatus may determine which of the following two cases has better encoding efficiency through Rate-Distortion Optimization (RDO), and may transmit information about the determined method to the decoding apparatus.

1) When it has a good encoding efficiency to perform CCLM parameter calculation through the existing CCLM reference sample selection method, a cclm_reduced_sample_flag syntax element with a value of 0 (false) is transmitted

2) When Nₜₕ is set to 2 and it has a good encoding efficiency to perform CCLM parameter calculation through the CCLM reference sample method proposed in an embodiment, a cclm_reduced_sample_flag syntax element with a value of 1 (true) is transmitted

Alternatively, when the additional information indicating the Nₜₕ value is transmitted in units of slices, pictures, or sequences, the encoding apparatus may transmit additional information indicating the Nₜₕ value with the added high level syntax (HLS) as shown in Table 3, 4, or 5 above. Alternatively, additional information indicating the Nₜₕ value may be included in the HLS as shown in Table 3, 4 or 5 above. For example, the additional information indicating the Nₜₕ value may include a cclm_reduced_sample_num syntax element, and the value of the cclm_reduced_sample_num syntax element may be derived based on Table 6. The encoding apparatus may set the Nₜₕ value in consideration of the size of the input image or in accordance with an encoding target bitrate.

1) For example, when the input image is HD or higher, the encoding apparatus may set Nₜₕ to 8, and when the input image is HD or lower, it may set Nₜₕ to 4.

2) When high quality image encoding is required, the encoding apparatus may set Nₜₕ to 8; when medium quality image encoding is required, it may set Nₜₕ to 4; and when low quality image encoding is required, it may set Nₜₕ to 2.

Meanwhile, in this document, an embodiment different from the above-described embodiment may be proposed for reducing the computational complexity of deriving the CCLM parameter in deriving the CCLM parameter.

For example, in order to address the above-described problem of increase in the CCLM parameter operation amount by the increase in the chroma block size, an embodiment may be proposed in which a neighboring sample selection top limit Nₜₕ is set adaptively to the block size of the current chroma block, and CCLM parameters are calculated by selecting neighboring pixels of the current chroma block based on the set Nth. The Nₜₕ may be referred to as the maximum number of neighboring samples.

For example, the Nₜₕ may be set adaptively to a block size of the current chroma block as follows.

When N<=TH in the current chroma block of size N×M or size M×N (here, N<=M), Nₜₕ may be set to 2

When N>TH in the current chroma block of size N×M or size M×N (here, N<=M), Nₜₕ may be set to 4

In this case, for example, the reference sample used to calculate the CCLM parameter according to the threshold value TH may be selected as follows.

For example, in the case where the TH is 4 (TH=4), when the N of the current chroma block is 2 or 4, two sample pairs for one side of the block are used to calculate the CCLM parameter, and when the N is 8, 16 or 32, four sample pairs for one side of the block are used to calculate the CCLM parameter.

For example, in the case where the TH is 8 (TH=8), when the N of the current chroma block is 2, 4 or 8, two sample pairs for one side of the block are used to calculate the CCLM parameter, and when the N is 16 or 32, four sample pairs for one side of the block are used to calculate the CCLM parameter.

As described above, in this embodiment, the number of samples optimized for the block size may be selected by setting the Nₜₕ adaptively to the block size of the current chroma block.

For example, the CCLM parameter calculation amounts according to the conventional CCLM reference sample selection method and this embodiment may be shown in Table 7 below.

TABLE 7

| | Number of operations (multiplication + sums) | | |
|---|---|---|---|
| | | Proposed | Proposed |
| Block | Original | method | method |
| size | CCLM | (TH = 4) | (TH = 8) |
| N = 2 | 24 | 24 | 24 |
| N = 4 | 44 | 24 | 24 |
| N = 8 | 84 | 44 | 24 |
| N = 16 | 164 | 44 | 44 |
| N = 32 | 324 | 44 | 44 |

Here, N may denote a smaller value of the width and height of the current block. Referring to Table 7, when the CCLM reference sample selection method proposed in this embodiment is used, the operation amount required for CCLM parameter calculation may not increase even though the block size increases.

Meanwhile, the Nₜₕ may be derived with a preset value in the encoding apparatus and the decoding apparatus without the need to transmit additional information indicating the Nth. Alternatively, the additional information indicating the TH may be transmitted in units of coding units (CUs), slices, pictures, or sequences, and the TH may be derived based on the additional information indicating the TH. The additional information indicating the TH may indicate the value of the TH.

For example, when additional information indicating TH is transmitted in units of CUs, if the intra prediction mode of the current chroma block is the CCLM mode, then a method may be proposed in which the cclm_reduced_sample_flag syntax element is parsed and the CCLM parameter calculation process is performed as described below. The cclm_reduced_sample_flag syntax element may indicate a syntax element of a CCLM reduced sample flag.

When the value of the cclm_reduced_sample_flag syntax element is 0 (false), the Nₜₕ is set to 4 for all the blocks, and CCLM parameter calculation is performed through the neighboring sample selection method of the above-described embodiment proposed in FIG. 9

When the value of the cclm_reduced_sample_flag syntax element is 1 (true), the Nₜₕ is set to 4, and CCLM parameter calculation is performed through the neighboring sample selection method proposed in the above-described embodiment

Alternatively, when additional information indicating TH is transmitted in units of slices, pictures, or sequences, the TH value may be decoded based on the additional information transmitted through high level syntax (HLS) as described later.

For example, the additional information signaled through the slice header may be represented as shown in the following table.

TABLE 8

| | Descriptor |
|---|---|
| slice_header( ) { | |
| ... | |
| cclm_reduced_sample_threshold | u(1) |
| ... | |

The cclm_reduced_sample_threshold syntax element may represent a syntax element of additional information indicating the TH.

Alternatively, for example, the additional information signaled through a picture parameter set (PPS) may be represented as shown in the following table.

TABLE 9

| | Descriptor |
|---|---|
| pic_parameter_set_rbsp( ) { | |
| ... | |
| cclm_reduced_sample_threshold | u(1) |
| ... | |

Alternatively, for example, the additional information signaled through a Sequence Parameter Set (SPS) may be represented as shown in the following table.

TABLE 10

| | Descriptor |
|---|---|
| seq_parameter_set_rbsp( ) { | |
| ... | |
| cclm_reduced_sample_threshold | u(1) |
| ... | |

The TH value derived based on the value of the cclm_reduced_sample_threshold syntax element transmitted through the slice header, the PPS or the SPS (i.e., a value derived by decoding cclm_reduced_sample_threshold) may be derived as shown in the following table.

TABLE 11

| cclm_reduced_sample_threshold | TH |
|---|---|
| 0 | 4 |
| 1 | 8 |

For example, referring to Table 11, the TH may be derived based on the cclm_reduced_sample_threshold syntax element. When the value of the cclm_reduced_sample_threshold syntax element is 0, the TH may be derived as 4, and when the value of the cclm_reduced_sample_threshold syntax element is 1, the TH may be derived as 8.

On the other hand, when the TH is derived with a preset value in the encoding apparatus and the decoding apparatus without additional information transmission, the encoding apparatus may perform the CCLM parameter calculation for the CCLM prediction as in the above-described embodiment based on the preset TH value.

Alternatively, the encoding apparatus may determine whether or not to use the threshold TH, and transmit information indicating whether or not the TH is used and additional information indicating the TH value to the decoding apparatus as follows.

In the case where information indicating whether or not TH is used is transmitted in units of CUs, when the intra prediction mode of the current chroma block is the CCLM mode (that is, when CCLM prediction is applied to the current chroma block), the encoding apparatus may determine which of the following two cases has better encoding efficiency through the RDO, and may transmit information about the determined method to the decoding apparatus.

1) When the Nₜₕ is set to 4 for all blocks, and it has a good encoding efficiency to perform CCLM parameter calculation through the neighboring sample section method of the above-described embodiment proposed in FIG. 9, a cclm_reduced_sample_flag syntax element with a value of 0 (false) is transmitted

2) When TH is set to 4 and it has a good encoding efficiency to perform CCLM parameter calculation through the neighboring sample selection method proposed in the above-described embodiment, a cclm_reduced_sample_flag syntax element with a value of 1 (true) is transmitted

Alternatively, when the information indicating whether or not the TH is used is transmitted in units of slices, pictures, or sequences, the encoding apparatus may transmit the information indicating whether or not the TH is used with the added high level syntax (HLS) as shown in Table 8, 9, or 10 above. Alternatively, information indicating whether or not the TH is used may be included in the HLS as shown in Table 8, 9 or 10 above. For example, the information indicating whether or not the TH is used may include a cclm_reduced_sample_threshold syntax element, and the value of the cclm_reduced_sample_threshold syntax element may be derived based on Table 11. The encoding apparatus may set whether or not the TH is used in consideration of the size of the input image or in accordance with an encoding target bitrate.

1) For example, when the input image is HD or higher, the encoding apparatus may set TH to 8, and when the input image is HD or lower, it may set TH to 4.

2) When high quality image encoding is required, the encoding apparatus may set TH to 8, and when low quality image encoding is required, it may set TH to 4.

The method proposed in this embodiment may be used for a CCLM mode which is an intra-prediction mode for a chroma component, and the chroma block predicted through the CCLM mode may be used to derive a residual image through a difference from an original image in the encoding apparatus or used to derive a reconstructed image through an addition with a residual signal in the decoding apparatus.

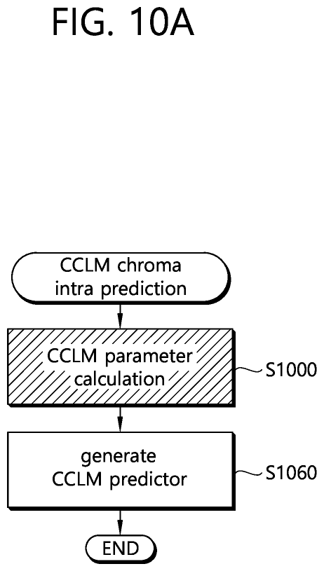

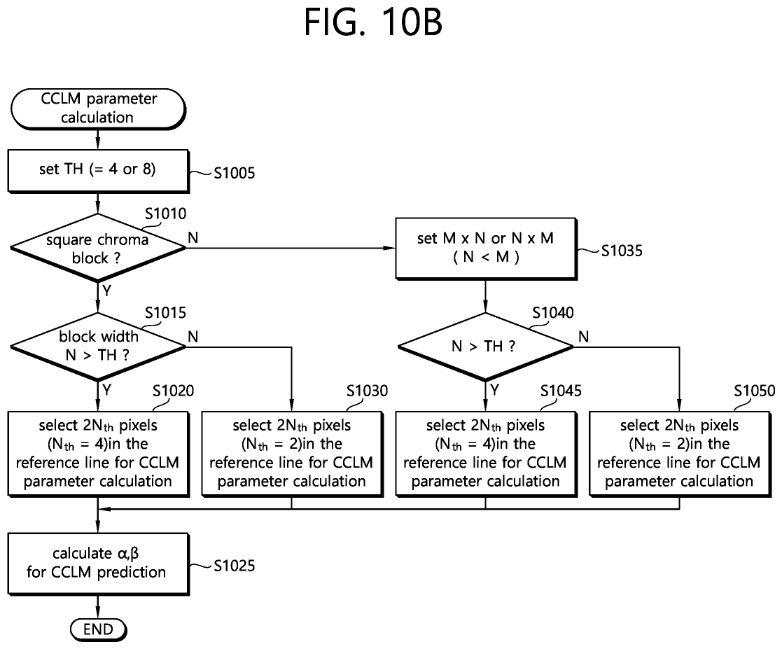

FIGS. 10A and 10B are diagrams for describing a process of performing CCLM prediction for a current chroma block according to an embodiment.

Referring to FIG. 10A, the encoding apparatus/decoding apparatus may calculate a CCLM parameter for the current block (S1000). For example, the CCLM parameter may be calculated as the embodiment shown in FIG. 10B.

FIG. 10B may illustrate a specific embodiment of calculating the CCLM parameter. For example, referring to FIG. 10B, the encoding apparatus/decoding apparatus may set TH for the current chroma block (S1005). The TH may be a preset value, or may be derived based on signaled additional information about the TH. The TH may be set to 4 or 8.

Thereafter, the encoding apparatus/decoding apparatus may determine whether or not the current chroma block is a square chroma block (S1010).

In the case that the current chroma block is the square chroma block, the encoding apparatus/decoding apparatus may determine whether N, which is the width of the current block, is greater than the TH (S1015).

In the case that the N is greater than the TH, the encoding apparatus/decoding apparatus may select 2 Nₜₕ neighboring samples in a reference line adjacent to the current block as a reference sample for the CCLM parameter calculation (S1020). Here, the Nₜₕ may be 4. That is, in the case where the N is greater than the TH, the Nₜₕ may be 4.

The encoding apparatus/decoding apparatus may derive parameters α and β for the CCLM prediction based on the selected reference samples (S1025).

Additionally, in the case where the N is not greater than the TH, the encoding apparatus/decoding apparatus may select 2 Nₜₕ neighboring samples in a reference line adjacent to the current block as a reference sample for the CCLM parameter calculation (S1030). Here, the Nₜₕ may be 2. That is, in the cast where the N is greater than the TH, the Nₜₕ may be 2. Thereafter, the encoding apparatus/decoding apparatus may derive parameters α and β for the CCLM prediction based on the selected reference samples (S1025).

Meanwhile, in the case where the current chroma block is not the square chroma block, the size of the current chroma block may be derived as size M×N or size N×M (S1035). Here, the M may represent a value greater than the N (N<M).

Thereafter, the encoding apparatus/decoding apparatus may determine whether or not the N is greater than the TH (S1040).

In the case where the N is greater than the TH, the encoding apparatus/decoding apparatus may select 2 Nₜₕ neighboring samples in a reference line adjacent to the current block as a reference sample for the CCLM parameter calculation (S1045). Here, the Nₜₕ may be 4. That is, in the case where the N is greater than the TH, the Nₜₕ may be 4.

The encoding apparatus/decoding apparatus may derive parameters α and β for the CCLM prediction based on the selected reference samples (S1025).

Additionally, in the case where the N is not greater than the TH, the encoding apparatus/decoding apparatus may select 2 Nₜₕ neighboring samples in a reference line adjacent to the current block as a reference sample for the CCLM parameter calculation (S1050). Here, the Nₜₕ may be 2. That is, in the cast where the N is greater than the TH, the Nₜₕ may be 2. Thereafter, the encoding apparatus/decoding apparatus may derive parameters α and β for the CCLM prediction based on the selected reference samples (S1025).

Referring back to FIG. 10A, in the case where the parameters for CCLM prediction for the current chroma block are calculated, the encoding apparatus/decoding apparatus may perform CCLM prediction based on the parameters and generate a prediction sample for the current chroma block (S1060). For example, the encoding apparatus/decoding apparatus may generate a prediction sample for the current chroma block based on above Equation 1 in which the calculated parameters and reconstructed samples of the current luma block for the current chroma block are used.

Meanwhile, in this document, an embodiment different from the above-described embodiment may be proposed for reducing the computational complexity of deriving the CCLM parameter in deriving the CCLM parameter.

Particularly, in order to address the problem of increase in CCLM parameter operation amount by the increase in the chroma block size, this embodiment proposes a method of setting a pixel selection top limit Nₜₕ adaptively. In addition, in this embodiment, when N=2 (where N is the smaller value of the width and height of the chroma block), that is, in order to prevent a worst case operation (case in which CCLM prediction is performed on all chroma blocks after all chroma blocks in the CTU are divided into 2×2 size) that occurs when CCLM prediction for a chroma block of size 2×2 is performed, the method of adaptively setting Nₜₕ may be proposed, thereby reducing the operation amount for the CCLM parameter calculation in the worst case by about 40%.

For example, according to this embodiment, the Nₜₕ may be set adaptively to a block size as follows.

Method 1 in this embodiment (proposed method 1)

In the case where N<=2 in the current chroma block of size N×M or size M×N (here, for example, N<M), Nₜₕ may be set to 1 (Nₜₕ=1)

In the case where N=4 in the current chroma block of size N×M or size M×N (here, for example, N<=M), Nₜₕ may be set to 2 (Nₜₕ=2)

In the case where N>4 in the current chroma block of size N×M or size M×N (here, for example, N<=M), Nₜₕ may be set to 4 (Nₜₕ=4)

Alternatively, for example, according to this embodiment, the Nₜₕ may be set adaptively to a block size as follows.

Method 2 in this embodiment (proposed method 2)

In the case where N<=2 in the current chroma block of size N×M or size M×N (here, for example, N<M), Nₜₕ may be set to 1 (Nₜₕ=1)

In the case where N=4 in the current chroma block of size N×M or size M×N (here, for example, N<=M), Nₜₕ may be set to 2 (Nₜₕ=2)

In the case where N=8 in the current chroma block of size N×M or size M×N (here, for example, N<=M), Nₜₕ may be set to 4 (Nₜₕ=4)

In the case where N>8 in the current chroma block of size N×M or size M×N (here, for example, N<=M), Nₜₕ may be set to 8 (Nₜₕ=8)

Alternatively, for example, according to this embodiment, the Nₜₕ may be set adaptively to a block size as follows.

Method 3 in this embodiment (proposed method 3)

In the case where N<=2 in the current chroma block of size N×M or size M×N (here, for example, N<M), Nₜₕ may be set to 1 (Nₜₕ=1)

In the case where N>2 in the current chroma block of size N×M or size M×N (here, for example, N<=M), Nₜₕ may be set to 2 (Nₜₕ=2)

Alternatively, for example, according to this embodiment, the Nₜₕ may be set adaptively to a block size as follows.

Method 4 in this embodiment (proposed method 4)

In the case where N<=2 in the current chroma block of size N×M or size M×N (here, for example, N<M), Nₜₕ may be set to 1 (Nₜₕ=1)

In the case where N>2 in the current chroma block of size N×M or size M×N (here, for example, N<=M), Nₜₕ may be set to 4 (Nₜₕ=4)

Method 1 to method 4 described above in this embodiment can reduce a complexity of the worst case where N=2 by about 40%, and since Nₜₕ may be applied adaptively to each chroma block size, encoding loss may be minimized In addition, for example, since method 2 can apply Nₜₕ up to 8 variably, it may by suitable for high quality image encoding, and since method 3 and method 4 can reduce Nₜₕ to 4 or 2, CCLM complexity may be reduced significantly, they may be suitable to low quality or medium quality image encoding.

As described in method 1 to method 4, according to this embodiment, Nₜₕ may be set adaptively to a block size, and through this, a reference sample number for deriving a CCLM parameter optimized for the block size may be selected.

The encoding apparatus/decoding apparatus may set the top limit Nₜₕ for neighboring sample selection, and then, calculate a CCLM parameter by selecting a chroma block neighboring sample as described above.

The CCLM parameter calculation operation amount according to a chroma block size in the case to which this embodiment described above is applied may be represented as in the following table.

TABLE 12

| | Number of operations (multiplication + sums) | | | | |
|---|---|---|---|---|---|
| | | Proposed | Proposed | | |
| | | method 1 | method 2 | Proposed | Proposed |
| Block | Original | (Nₜₕ = 1, | (Nₜₕ = 1, | method 3 | method 4 |
| size | CCLM | 2, 4) | 2, 4, 8) | (Nₜₕ = 1, 2) | (Nₜₕ = 1, 4) |
| N = 2 | 24 | 14 | 14 | 14 | 14 |
| N = 4 | 44 | 24 | 24 | 24 | 44 |
| N = 8 | 84 | 44 | 44 | 24 | 44 |
| N = 16 | 164 | 44 | 84 | 24 | 44 |
| N = 32 | 324 | 44 | 84 | 24 | 44 |

As shown in Table 12 above, in the case where the methods proposed in this embodiment are used, it can be seen that an amount of operation required for the CCLM parameter calculation is not increased even though the block size is increased.

Meanwhile, according to this embodiment, without the need to transmit additional information, a promised value may be used in the encoding apparatus and the decoding apparatus, or information indicating whether or not the proposed method is used and the value of Nₜₕ may be transmitted in units of CUs, slices, pictures, and sequences.

For example, in the case where information indicating whether or not the proposed method is used is transmitted in units of CUs, when the intra prediction mode of the current chroma block is the CCLM mode (i.e., when CCLM prediction is applied to the current chroma block), the cclm_reduced_sample_flag syntax element is parsed as follows, so that the above-described embodiment may be performed. The cclm_reduced_sample_flag syntax element may indicate a syntax element of a CCLM reduced sample flag.

When the value of the cclm_reduced_sample_flag syntax element is 0 (false), the Nₜₕ is set to 4 for all the blocks, and CCLM parameter calculation is performed through the neighboring sample selection method of the above-described embodiment proposed in FIG. 9

When the value of the cclm_reduced_sample_flag syntax element is 1 (true), CCLM parameter calculation is performed through method 3 of this embodiment described above

Alternatively, when information indicating a method to be applied is transmitted in units of slices, pictures, or sequences, a method to be applied may be selected from among the above-described methods 1 to 4 based on the information transmitted through high level syntax (HLS) as described later, and the CCLM parameter may be calculated based on the selected method.

For example, the information indicating the method to be applied signaled through a slice header may be represented as in the following Table.

TABLE 13

| | Descriptor |
|---|---|
| slice_header( ) { | |
| ... | |
| cclm_reduced_sample_threshold | f(2) |
| ... | |

cclm_reduced_sample_threshold may represent a syntax element of information indicating the method to be applied.

Alternatively, for example, the information indicating the method to be applied signaled through a Picture Parameter Set (PPS) may be represented as in the following table.

TABLE 14

| | Descriptor |
|---|---|
| pic_parameter_set_rbsp( ) { | |
| ... | |
| cclm_reduced_sample_threshold | f(2) |
| ... | |

Alternatively, for example, the information indicating the method to be applied signaled through a Sequence Parameter Set (SPS) may be represented as in the following table.

TABLE 15

| | Descriptor |
|---|---|
| seq_parameter_set_rbsp( ) { | |
| ... | |
| cclm_reduced_sample_threshold | f(2) |
| ... | |

The method selected based on the value of the cclm_reduced_sample_threshold transmitted through the slice header, the PPS or the SPS (i.e., a value derived by decoding cclm_reduced_sample_threshold) may be derived as shown in the following table.

TABLE 16

| cclm_reduced_sample_threshold | Proposed method |
|---|---|
| 0 | 1 (Nₜₕ = 1, 2, 4) |
| 1 | 2 (Nₜₕ = 1, 2, 4, 8) |
| 2 | 3 (Nₜₕ = 1, 2) |
| 3 | 4 (Nₜₕ = 1, 4) |

Referring to Table 16, when the value of the cclm_reduced_sample_threshold syntax element is 0, the method applied to the current chroma block may be selected as said method 1; when the value of the cclm_reduced_sample_threshold syntax element is 1, the method applied to the current chroma block may be selected as said method 2; when the value of the cclm_reduced_sample_threshold syntax element is 2, the method applied to the current chroma block may be selected as said method 3; and when the value of the cclm_reduced_sample_threshold syntax element is 3, the method applied to the current chroma block may be selected as method 4 above.

The method proposed in this embodiment may be used for a CCLM mode which is an intra-prediction mode for a chroma component, and the chroma block predicted through the CCLM mode may be used to derive a residual image through a difference from an original image in the encoding apparatus or used to derive reconstructed image through an addition with a residual signal in the decoding apparatus.

Meanwhile, when information indicating one of the methods is transmitted in units of CUs, slices, pictures and sequences, the encoding apparatus may determine one of the methods 1 to 4, and then transmit the information to the decoding apparatus as follows.

In the case where information indicating whether or not the method of the above-described embodiment is used is transmitted in units of CUs, when the intra prediction mode of the current chroma block is the CCLM mode (that is, when CCLM prediction is applied to the current chroma block), the encoding apparatus may determine which of the following two cases has better encoding efficiency through the RDO, and may transmit information about the determined method to the decoding apparatus.

1) When the Nₜₕ is set to 4 for all blocks, and it has a good encoding efficiency to perform CCLM parameter calculation through the neighboring sample section method of the above-described embodiment proposed in FIG. 9, a cclm_reduced_sample_flag syntax element with a value of 0 (false) is transmitted

2) When it is set that said method 3 is applied and it has a good encoding efficiency to perform CCLM parameter calculation through the neighboring sample selection method proposed in the above-described embodiment, a cclm_reduced_sample_flag syntax element with a value of 1 (true) is transmitted

Alternatively, in the case where the information indicating whether or not the method of the embodiment described above is applied is transmitted in units of slices, pictures or sequences, the encoding apparatus may add a high level syntax (HLS) as represented in Table 13, 14 or 15 described above, and transmit the information representing one method of said methods. Alternatively, information indicating one of the methods may be included in the HLS as shown in Table 13, 14, or 15 described above. For example, the information indicating one of the methods may include a cclm_reduced_sample_threshold syntax element, and the value of the cclm_reduced_sample_threshold syntax element may be derived based on Table 16. The encoding apparatus may set a method to be applied from among said methods in consideration of the size of the input image or in accordance with an encoding target bitrate.

1) For example, when the input image is HD or higher, the encoding apparatus may apply said method 2 (Nₜₕ=1, 2, 4 or 8), and when the input image is HD or lower, it may apply said method 1 (Nₜₕ=1, 2 or 4).

2) When high quality image encoding is required, the encoding apparatus may apply said method 2 (Nₜₕ=1, 2, 4 or 8), and when low quality image encoding is required, it may apply said method 3 (Nₜₕ=1 or 2) or said method 4 (Nₜₕ=1 or 4).

The method proposed in this embodiment may be used for a CCLM mode which is an intra-prediction mode for a chroma component, and the chroma block predicted through the CCLM mode may be used to derive a residual image through a difference from an original image in the encoding apparatus or used to derive reconstructed image through an addition with a residual signal in the decoding apparatus.

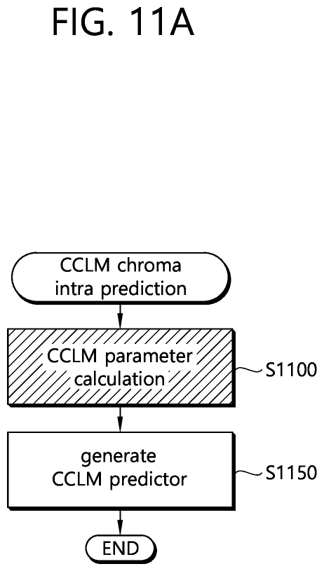

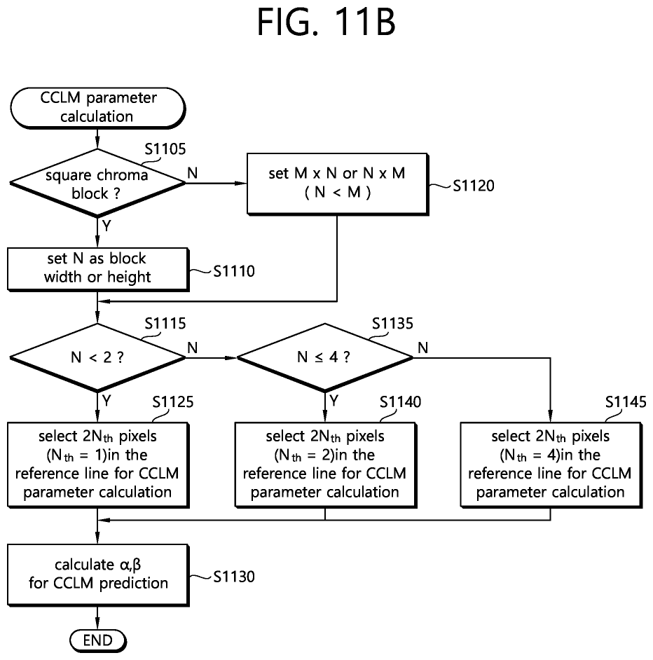

FIGS. 11A and 11B are diagrams for describing a process of performing CCLM prediction based on the CCLM parameters of the current chroma block derived according to method 1 of the embodiment described above.

Referring to FIG. 11A, the encoding apparatus/decoding apparatus may calculate a CCLM parameter for the current block (S1100). For example, the CCLM parameter may be calculated as this embodiment shown in FIG. 11B.

FIG. 11B may illustrate a specific embodiment of calculating the CCLM parameter. For example, referring to FIG. 11B, the encoding apparatus/decoding apparatus may determine whether the current chroma block is a square chroma block (S1105).

In the case where the current chroma block is a square chroma block, the encoding apparatus/decoding apparatus may set a width or a height of the current block to N (S1110), and determine whether or not the N is smaller than 2 (N<2) (S1115).

Alternatively, in the case where the current chroma block is not a square chroma block, the size of the current chroma block may be derived as size M×N or size N×M (S1120), and the encoding apparatus/decoding apparatus may determine whether or not the N is smaller than 2 (S1115). Here, the M may represent a value greater than the N (N<M).

In the case that the N is smaller than 2, the encoding apparatus/decoding apparatus may select 2Nₜₕ neighboring samples in a reference line adjacent to the current block as a reference sample for the CCLM parameter calculation (S1125). Here, the Nₜₕ may be 1 (Nₜₕ=1).

The encoding apparatus/decoding apparatus may derive parameters α and β for the CCLM prediction based on the selected reference samples (S1130).

Meanwhile, in the case where the N is not smaller than 2, the encoding apparatus/decoding apparatus may determine whether or not the N is 4 or less (N<=4) (S1135).

In the case where the N is 4 or less, the encoding apparatus/decoding apparatus may select 2 Nₜₕ neighboring samples in a reference line adjacent to the current block as a reference sample for the CCLM parameter calculation (S1140). Here, the Nₜₕ may be 2 (Nₜₕ=2). Thereafter, the encoding apparatus/decoding apparatus may derive parameters α and β for the CCLM prediction based on the selected reference samples (S1130).

Alternatively, in the case where the N is greater than 4, the encoding apparatus/decoding apparatus may select 2 Nₜₕ neighboring samples in a reference line adjacent to the current block as a reference sample for the CCLM parameter calculation (S1145). Here, the Nₜₕ may be 4 (Nₜₕ=4). Thereafter, the encoding apparatus/decoding apparatus may derive parameters α and β for the CCLM prediction based on the selected reference samples (S1130).

Referring back to FIG. 11A, in the case where the parameters for CCLM prediction for the current chroma block are calculated, the encoding apparatus/decoding apparatus may perform CCLM prediction based on the parameters and generate a prediction sample for the current chroma block (S1150). For example, the encoding apparatus/decoding apparatus may generate a prediction sample for the current chroma block based on above Equation 1 in which the calculated parameters and reconstructed samples of the current luma block for the current chroma block are used.

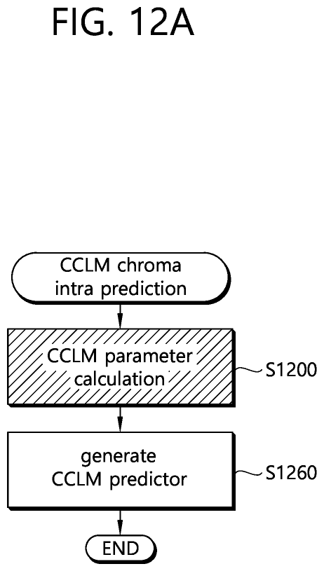

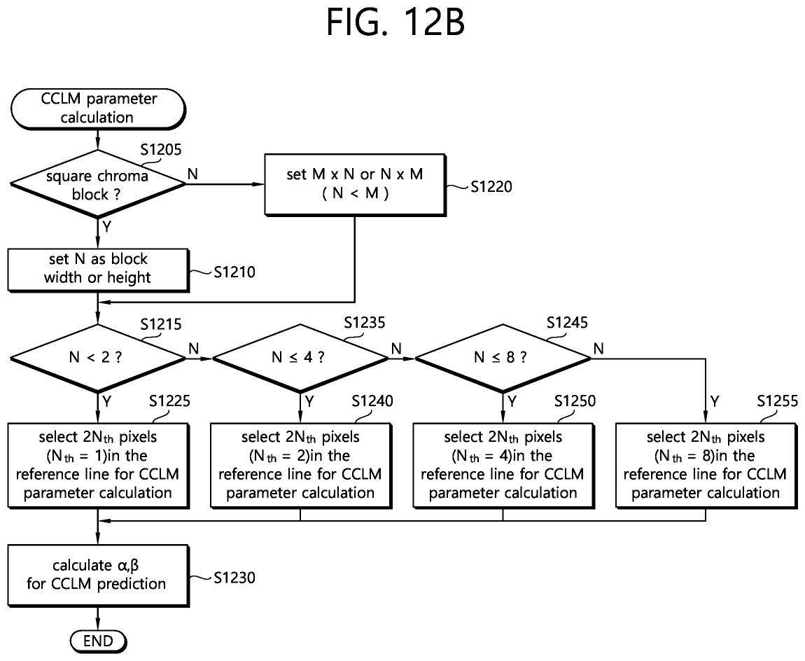

FIGS. 12A and 12B are diagrams for describing a process of performing CCLM prediction based on the CCLM parameters of the current chroma block derived according to method 2 of the embodiment described above.

Referring to FIG. 12A, the encoding apparatus/decoding apparatus may calculate a CCLM parameter for the current block (S1200). For example, the CCLM parameter may be calculated as the embodiment shown in FIG. 12B.

FIG. 12B may illustrate a specific embodiment of calculating the CCLM parameter. For example, referring to FIG. 12B, the encoding apparatus/decoding apparatus may determine whether or not the current chroma block is a square chroma block (S1205).

In the case where the current chroma block is a square chroma block, the encoding apparatus/decoding apparatus may set a width or a height of the current block to N (S1210), and determine whether or not the N is smaller than 2 (N<2) (S1215).

Alternatively, in the case where the current chroma block is not a square chroma block, the size of the current chroma block may be derived as size M×N or size N×M (S1220), and the encoding apparatus/decoding apparatus may determine whether or not the N is smaller than 2 (S1215). Here, the M may represent a value greater than the N (N<M).

In the case where the N is smaller than 2, the encoding apparatus/decoding apparatus may select 2 Nₜₕ neighboring samples in a reference line adjacent to the current block as a reference sample for the CCLM parameter calculation (S1225). Here, the Nₜₕ may be 1 (Nth=1).

The encoding apparatus/decoding apparatus may derive parameters α and β for the CCLM prediction based on the selected reference samples (S1230).

Meanwhile, in the case where the N is not smaller than 2, the encoding apparatus/decoding apparatus may determine whether or not the N is 4 or less (N<=4) (S1235).

In the case where the N is 4 or less, the encoding apparatus/decoding apparatus may select 2 Nₜₕ neighboring samples in a reference line adjacent to the current block as a reference sample for the CCLM parameter calculation (S1240). Here, the Nₜₕ may be 2 (Nₜₕ=2). Thereafter, the encoding apparatus/decoding apparatus may derive parameters α and β for the CCLM prediction based on the selected reference samples (S1230).

Meanwhile, in the case where the N is greater than 4, the encoding apparatus/decoding apparatus may determine whether or not the N is 8 or less (N<=8) (S1245).

In the case that the N is less than or equal to 8, the encoding apparatus/decoding apparatus may select 2 Nₜₕ neighboring samples in a reference line adjacent to the current block as a reference sample for the CCLM parameter calculation (S1250). Here, the Nₜₕ may be 4 (Nₜₕ=4). Thereafter, the encoding apparatus/decoding apparatus may derive parameters α and β for the CCLM prediction based on the selected reference samples (S1230).

Alternatively, in the case where the N is greater than 8, the encoding apparatus/decoding apparatus may select 2 Nₜₕ neighboring samples in a reference line adjacent to the current block as a reference sample for the CCLM parameter calculation (S1255). Here, the Nₜₕ may be 8 (Nₜₕ=8). Thereafter, the encoding apparatus/decoding apparatus may derive parameters α and β for the CCLM prediction based on the selected reference samples (S1230).

Referring back to FIG. 12A, in the case where the parameters for CCLM prediction for the current chroma block are calculated, the encoding apparatus/decoding apparatus may perform CCLM prediction based on the parameters and generate a prediction sample for the current chroma block (S1260). For example, the encoding apparatus/decoding apparatus may generate a prediction sample for the current chroma block based on above Equation 1 in which the calculated parameters and reconstructed samples of the current luma block for the current chroma block are used.

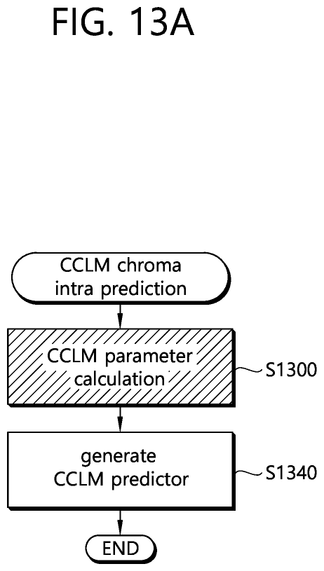

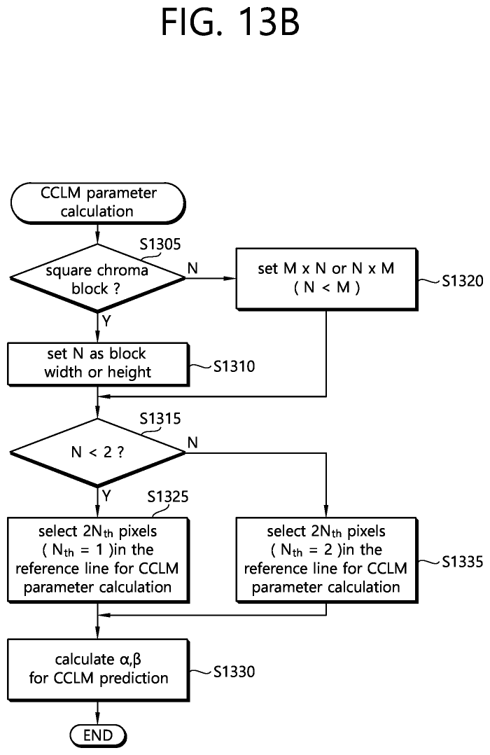

FIGS. 13A and 13B are diagrams for describing a process of performing CCLM prediction based on the CCLM parameters of the current chroma block derived according to method 3 of the embodiment described above.

Referring to FIG. 13A, the encoding apparatus/decoding apparatus may calculate a CCLM parameter for the current block (S1300). For example, the CCLM parameter may be calculated as the embodiment shown in FIG. 13B.

FIG. 13B may illustrate a specific embodiment of calculating the CCLM parameter. For example, referring to FIG. 13B, the encoding apparatus/decoding apparatus may determine whether or not the current chroma block is a square chroma block (S1305).

In the case where the current chroma block is a square chroma block, the encoding apparatus/decoding apparatus may set a width or a height of the current block to N (S1310), and determine whether or not the N is smaller than 2 (N<2) (S1315).

Alternatively, in the case where the current chroma block is not a square chroma block, the size of the current chroma block may be derived as size M×N or size N×M (S1320), and the encoding apparatus/decoding apparatus may determine whether or not the N is smaller than 2 (S1315). Here, the M may represent a value greater than the N (N<M).

In the case where the N is smaller than 2, the encoding apparatus/decoding apparatus may select 2 Nₜₕ neighboring samples in a reference line adjacent to the current block as a reference sample for the CCLM parameter calculation (S1325). Here, the Nₜₕ may be 1 (Nth=1).

The encoding apparatus/decoding apparatus may derive parameters α and β for the CCLM prediction based on the selected reference samples (S1330).

Meanwhile, in the case where the N is not smaller than 2, the encoding apparatus/decoding apparatus may select 2 Nₜₕ neighboring samples in a reference line adjacent to the current block as a reference sample for the CCLM parameter calculation (step, S1335). Here, the Nₜₕ may be 2 (Nₜₕ=2). Thereafter, the encoding apparatus/decoding apparatus may derive parameters α and β for the CCLM prediction based on the selected reference samples (S1330).

Referring back to FIG. 13A, in the case where the parameters for CCLM prediction for the current chroma block are calculated, the encoding apparatus/decoding apparatus may perform CCLM prediction based on the parameters and generate a prediction sample for the current chroma block (S1340). For example, the encoding apparatus/decoding apparatus may generate a prediction sample for the current chroma block based on above Equation 1 in which the calculated parameters and reconstructed samples of the current luma block for the current chroma block are used.

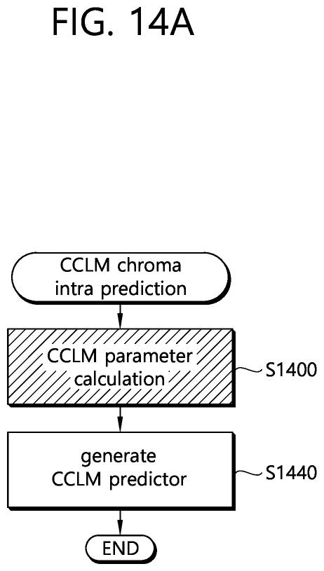

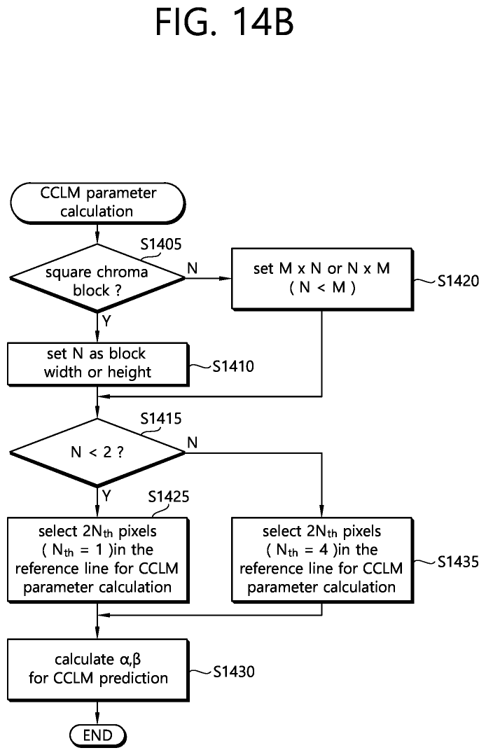

FIGS. 14A and 14B are diagrams for describing a process of performing CCLM prediction based on the CCLM parameters of the current chroma block derived according to method 4 of the embodiment described above.

Referring to FIG. 14A, the encoding apparatus/decoding apparatus may calculate a CCLM parameter for the current block (S1400). For example, the CCLM parameter may be calculated as this embodiment shown in FIG. 14B.

FIG. 14B may illustrate a specific embodiment of calculating the CCLM parameter. For example, referring to FIG. 14B, the encoding apparatus/decoding apparatus may determine whether or not the current chroma block is a square chroma block (S1405).

In the case where the current chroma block is a square chroma block, the encoding apparatus/decoding apparatus may set a width or a height of the current block to N (S1410), and determine whether or not the N is smaller than 2 (N<2) (S1415).

Alternatively, in the case where the current chroma block is not a square chroma block, the size of the current chroma block may be derived as size M×N or size N×M (S1420), and the encoding apparatus/decoding apparatus may determine whether or not the N is smaller than 2 (S1415). Here, the M may represent a value greater than the N (N<M).

In the case where the N is smaller than 2, the encoding apparatus/decoding apparatus may select 2 Nₜₕ neighboring samples in a reference line adjacent to the current block as a reference sample for the CCLM parameter calculation (S1425). Here, the Nₜₕ may be 1 (Nth=1).

The encoding apparatus/decoding apparatus may derive parameters α and β for the CCLM prediction based on the selected reference samples (S1430).

Meanwhile, in the case where the N is not smaller than 2, the encoding apparatus/decoding apparatus may select 2 Nₜₕ neighboring samples in a reference line adjacent to the current block as a reference sample for the CCLM parameter calculation (S1435). Here, the Nₜₕ may be 4 (Nₜₕ=4). Thereafter, the encoding apparatus/decoding apparatus may derive parameters α and β for the CCLM prediction based on the selected reference samples (S1430).

Referring back to FIG. 14A, in the case where the parameters for CCLM prediction for the current chroma block are calculated, the encoding apparatus/decoding apparatus may perform CCLM prediction based on the parameters and generate a prediction sample for the current chroma block (S1440). For example, the encoding apparatus/decoding apparatus may generate a prediction sample for the current chroma block based on above Equation 1 in which the calculated parameters and reconstructed samples of the current luma block for the current chroma block are used.

Meanwhile, in this document, an embodiment different from the above-described embodiment may be proposed for reducing the computational complexity of deriving the CCLM parameter in deriving the CCLM parameter.

Particularly, in order to address the problem of increase in CCLM parameter operation amount by the increase in the chroma block size, this embodiment proposes a method of setting a pixel selection top limit Nₜₕ adaptively.

For example, according to this embodiment, the Nₜₕ may be set adaptively to a block size as follows.

Method 1 in this embodiment (proposed method 1)

In the case where a current chroma block is a chroma block of size 2×2, Nₜₕ may be set to 1 (Nₜₕ=1)

In the case where N=2 in the current chroma block of size N×M or size M×N (here, for example, N<M), Nₜₕ may be set to 2 (Nₜₕ=2)

In the case where N>2 in the current chroma block of size N×M or size M×N (here, for example, N<=M), Nth may be set to 4 (Nₜₕ=4)

Alternatively, for example, according to this embodiment, the Nₜₕ may be set adaptively to a block size as follows.

Method 2 in this embodiment (proposed method 2)

In the case where a current chroma block is a chroma block of size 2×2, Nₜₕ may be set to 1 (Nₜₕ=1)

In the case where N=2 in the current chroma block of size N×M or size M×N (here, for example, N<M), Nₜₕ may be set to 2 (Nₜₕ=2)

In the case where N=4 in the current chroma block of size N×M or size M×N (here, for example, N<=M), Nₜₕ may be set to 2 (Nₜₕ=2)

In the case where N>4 in the current chroma block of size N×M or size M×N (here, for example, N<=M), Nₜₕ may be set to 4 (Nₜₕ=4)

Alternatively, for example, according to this embodiment, the Nₜₕ may be set adaptively to a block size as follows.

Method 3 in this embodiment (proposed method 3)

In the case where a current chroma block is a chroma block of size 2×2, Nₜₕ may be set to 1 (Nₜₕ=1)

In the case where N=2 in the current chroma block of size N×M or size M×N (here, for example, N<M), Nₜₕ may be set to 2 (Nₜₕ=2)

In the case where N=4 in the current chroma block of size N×M or size M×N (here, for example, N<=M), Nₜₕ may be set to 4 (Nₜₕ=4)

In the case where N>4 in the current chroma block of size N×M or size M×N (here, for example, N<=M), Nₜₕ may be set to 8 (Nₜₕ=8)

Method 1 to method 3 described above in this embodiment may reduce a complexity of the worst case in the case where the current chroma block is 2×2 by about 40%, and since Nₜₕ may be applied adaptively to each chroma block size, encoding loss may be minimized In addition, for example, since said methods 1 and 3 can apply Nₜₕ as 4 in the case of N>2, they may by suitable for high quality image encoding, and since said method 2 can reduce Nₜₕ to 2 in the case of N=4, CCLM complexity may be reduced significantly, it may be suitable to low quality or medium quality image encoding.

As described in methods 1 to 3, according to this embodiment, Nₜₕ may be set adaptively to a block size, and through this, a reference sample number for deriving an optimized CCLM parameter may be selected.

The encoding apparatus/decoding apparatus may set the top limit Nₜₕ for neighboring sample selection, and then, calculate a CCLM parameter by selecting a chroma block neighboring sample as described above.

The CCLM parameter calculation operation amount according to a chroma block size in the case to which this embodiment described above is applied may be represented as in the following table.

TABLE 17

Number of operations (multiplication + sums)

| | | Proposed | Proposed | Proposed |
|---|---|---|---|---|
| | | method 1 | method 2 | method 2 |
| Block | Original | (Nₜₕ = 1, | (Nₜₕ = 1, | (Nₜₕ = 1, |
| size | CCLM | 2, 4) | 2, 2, 4) | 2, 4, 8) |
| 2 × 2 | 24 | 14 | 14 | 14 |
| N = 2 | 24 | 24 | 24 | 24 |
| N = 4 | 44 | 44 | 24 | 44 |
| N = 8 | 84 | 44 | 44 | 84 |
| N = 16 | 164 | 44 | 44 | 84 |
| N = 32 | 324 | 44 | 44 | 84 |

As shown in Table 17 above, in the case where the methods proposed in this embodiment are used, it can be seen that an amount of operation required for the CCLM parameter calculation is not increased even though the block size is increased.

Meanwhile, according to this embodiment, without the need to transmit additional information, a promised value may be used in the encoding apparatus and the decoding apparatus, or information indicating whether or not the proposed method is used and the value of Nₜₕ may be transmitted in units of CUs, slices, pictures, and sequences.

For example, in the case where information indicating whether or not the proposed method is used is transmitted in units of CUs, when the intra prediction mode of the current chroma block is the CCLM mode (i.e., when CCLM prediction is applied to the current chroma block), the cclm_reduced_sample_flag syntax element is parsed as follows, so that the above-described embodiment may be performed. The cclm_reduced_sample_flag syntax element may indicate a syntax element of a CCLM reduced sample flag.

When the value of the cclm_reduced_sample_flag syntax element is 0 (false), the Nₜₕ is set to 2 for all the blocks, and CCLM parameter calculation is performed through the neighboring sample selection method of the above-described embodiment proposed in FIG. 9

When the value of the cclm_reduced_sample_flag syntax element is 1 (true), CCLM parameter calculation is performed through method 1 of this embodiment described above

Alternatively, when information indicating a method to be applied is transmitted in units of slices, pictures, or sequences, a method to be applied may be selected from among the above-described methods 1 to 3 based on the information transmitted through high level syntax (HLS) as described later, and the CCLM parameter may be calculated based on the selected method.

For example, the information indicating the method to be applied signaled through a slice header may be represented as in the following Table.

TABLE 18

| | Descriptor |
|---|---|
| slice_header( ) { | |
| ... | |
| cclm_reduced_sample_threshold | f(2) |
| ... | |

cclm_reduced_sample_threshold may represent a syntax element of information indicating the method to be applied.

Alternatively, for example, the information indicating the method to be applied signaled through a Picture Parameter Set (PPS) may be represented as in the following table.

TABLE 19

| | Descriptor |
|---|---|
| pic_parameter_set_rbsp( ) { | |
| ... | |
| cclm_reduced_sample_threshold | f(2) |
| ... | |

Alternatively, for example, the information indicating the method to be applied signaled through a Sequence Parameter Set (SPS) may be represented as in the following table.

TABLE 20

| | Descriptor |
|---|---|
| seq_parameter_set_rbsp( ) { | |
| ... | |
| cclm_reduced_sample_threshold | f(2) |
| ... | |

The method selected based on the value of the cclm_reduced_sample_threshold transmitted through the slice header, the PPS or the SPS (i.e., a value derived by decoding cclm_reduced_sample_threshold) may be derived as shown in the following table.

TABLE 21

| cclm_reduced_sample_threshold | Proposed method |
|---|---|
| 0 | Not apply |
| 1 | 1 (Nₜₕ = 1, 2, 4) |
| 2 | 2 (Nₜₕ = 1, 2, 2, 4) |
| 3 | 3 (Nₜₕ = 1, 2, 4, 8) |

Referring to Table 21, when the value of the cclm_reduced_sample_threshold syntax element is 0, the methods in the above-described embodiment may not be applied to the current chroma block; when the value of the cclm_reduced_sample_threshold syntax element is 1, the method applied to the current chroma block may be selected as said method 1; when the value of the cclm_reduced_sample_threshold syntax element is 2, the method applied to the current chroma block may be selected as said method 2; and when the value of the cclm_reduced_sample_threshold syntax element is 3, the method applied to the current chroma block may be selected as said method 3.

The method proposed in this embodiment may be used for a CCLM mode which is an intra-prediction mode for a chroma component, and the chroma block predicted through the CCLM mode may be used to derive a residual image through a difference from an original image in the encoding apparatus or used to derive reconstructed image through an addition with a residual signal in the decoding apparatus.

Meanwhile, when information indicating one of the methods is transmitted in units of CUs, slices, pictures and sequences, the encoding apparatus may determine one of the methods 1 to 3, and then transmit the information to the decoding apparatus as follows.

In the case where information indicating whether or not the method of the above-described embodiment is used is transmitted in units of CUs, when the intra prediction mode of the current chroma block is the CCLM mode (that is, when CCLM prediction is applied to the current chroma block), the encoding apparatus may determine which of the following two cases has better encoding efficiency through the RDO, and may transmit information about the determined method to the decoding apparatus.

1) When the Nₜₕ is set to 2 for all blocks, and it has a good encoding efficiency to perform CCLM parameter calculation through the neighboring sample section method of the above-described embodiment proposed in FIG. 9, a cclm_reduced_sample_flag syntax element with a value of 0 (false) is transmitted

2) When it is set that said method 1 is applied and it has a good encoding efficiency to perform CCLM parameter calculation through the neighboring sample selection method proposed in the above-described embodiment, a cclm_reduced_sample_flag syntax element with a value of 1 (true) is transmitted

Alternatively, in the case where the information indicating whether or not the method of the embodiment described above is applied is transmitted in units of slices, pictures or sequences, the encoding apparatus may add a high level syntax (HLS) as represented in Table 18, 19 or 20 described above, and transmit the information representing one method of said methods. Alternatively, information indicating one of the methods may be included in the HLS as shown in Table 18, 19, or 20 described above. For example, the information indicating one of the methods may include a cclm_reduced_sample_threshold syntax element, and the value of the cclm_reduced_sample_threshold syntax element may be derived based on Table 21. The encoding apparatus may set a method to be applied from among said methods in consideration of the size of the input image or in accordance with an encoding target bitrate.

1) For example, when the input image is HD or higher, the encoding apparatus may apply said method 3 (Nₜₕ=1, 2, 4 or 8), and when the input image is HD or lower, it may apply said method 1 (Nₜₕ=1, 2 or 4).

2) When high quality image encoding is required, the encoding apparatus may apply said method 3 (Nₜₕ=1, 2, 4 or 8), and when low quality image encoding is required, it may apply said method 2 (Nₜₕ=1, 2, 2 or 4) or said method 1 (Nₜₕ=1, 2 or 4).

The method proposed in this embodiment may be used for a CCLM mode which is an intra-prediction mode for a chroma component, and the chroma block predicted through the CCLM mode may be used to derive a residual image through a difference from an original image in the encoding apparatus or used to derive reconstructed image through an addition with a residual signal in the decoding apparatus.

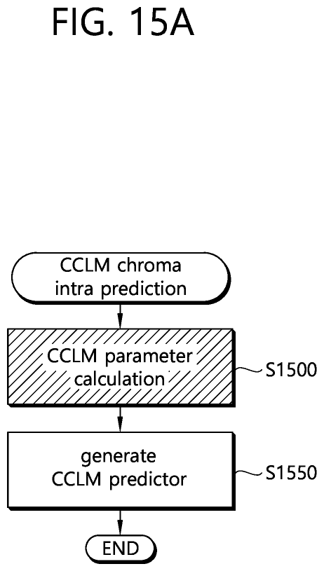

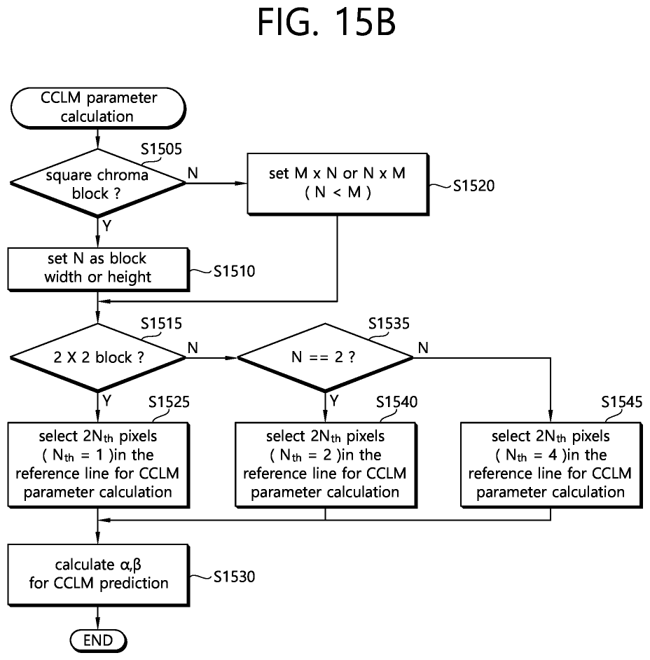

FIGS. 15A and 15B are diagrams for describing a process of performing CCLM prediction based on the CCLM parameters of the current chroma block derived according to method 1 of the embodiment described above.

Referring to FIG. 15A, the encoding apparatus/decoding apparatus may calculate a CCLM parameter for the current block (S1500). For example, the CCLM parameter may be calculated as the embodiment shown in FIG. 15B.

FIG. 15B may illustrate a specific embodiment of calculating the CCLM parameter. For example, referring to FIG. 15B, the encoding apparatus/decoding apparatus may determine whether or not the current chroma block is a square chroma block (S1505).

In the case where the current chroma block is a square chroma block, the encoding apparatus/decoding apparatus may set a width or a height of the current block to N (S1510) and determine whether or not the size of the current chroma block is size 2×2 (S1515).

Alternatively, in the case where the current chroma block is not a square chroma block, the size of the current chroma block may be derived as size M×N or size N×M (S1520), and the encoding apparatus/decoding apparatus may determine whether or not the size of the current chroma block is size 2×2 (S1515). Here, the M may represent a value greater than the N (N<M).

In the case where the size of the current chroma block is size 2×2, the encoding apparatus/decoding apparatus may select 2 Nₜₕ neighboring samples in a reference line adjacent to the current block as a reference sample for the CCLM parameter calculation (S1525). Here, the Nₜₕ may be 1 (Nth=1).

The encoding apparatus/decoding apparatus may derive parameters α and β for the CCLM prediction based on the selected reference samples (S1530).

Meanwhile, in the case where the size of the current chroma block is not size 2×2, the encoding apparatus/decoding apparatus may determine whether or not the N is 2 (N==2) (S1535).

In the case where the N is 2, the encoding apparatus/decoding apparatus may select 2 Nₜₕ neighboring samples in a reference line adjacent to the current block as a reference sample for the CCLM parameter calculation (S1540). Here, the Nₜₕ may be 2 (Nₜₕ=2). Thereafter, the encoding apparatus/decoding apparatus may derive parameters α and β for the CCLM prediction based on the selected reference samples (S1530).

Alternatively, in the case where the N is not 2, the encoding apparatus/decoding apparatus may select 2 Nₜₕ neighboring samples in a reference line adjacent to the current block as a reference sample for the CCLM parameter calculation (S1545). Here, the Nₜₕ may be 4 (Nₜₕ=4). Thereafter, the encoding apparatus/decoding apparatus may derive parameters α and β for the CCLM prediction based on the selected reference samples (S1530).

Referring back to FIG. 15A, in the case where the parameters for CCLM prediction for the current chroma block are calculated, the encoding apparatus/decoding apparatus may perform CCLM prediction based on the parameters and generate a prediction sample for the current chroma block (S1550). For example, the encoding apparatus/decoding apparatus may generate a prediction sample for the current chroma block based on above Equation 1 in which the calculated parameters and reconstructed samples of the current luma block for the current chroma block are used.

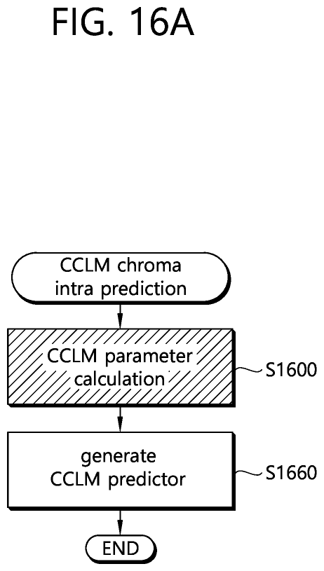

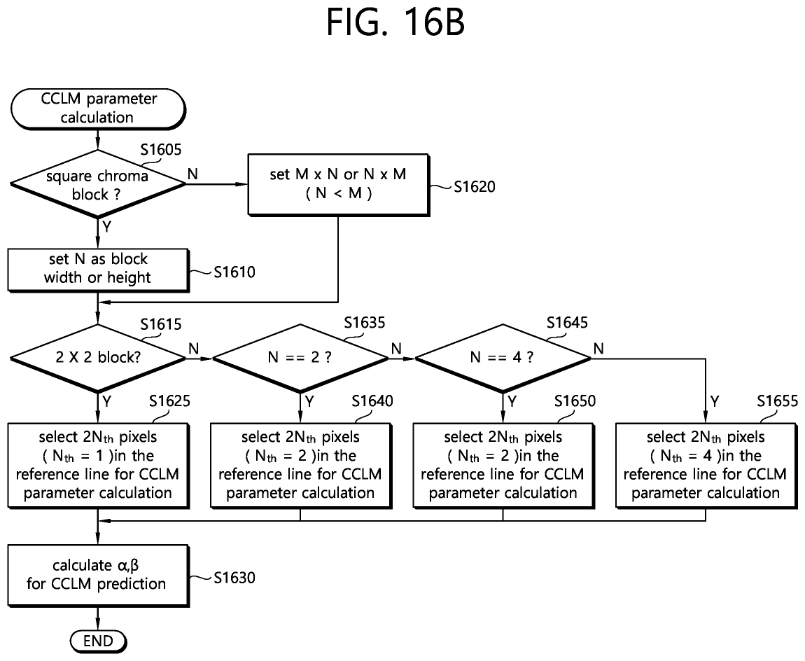

FIGS. 16A and 16B are diagrams for describing a process of performing CCLM prediction based on the CCLM parameters of the current chroma block derived according to method 2 of the embodiment described above.

Referring to FIG. 16A, the encoding apparatus/decoding apparatus may calculate a CCLM parameter for the current block (S1600). For example, the CCLM parameter may be calculated as the embodiment shown in FIG. 16B.

FIG. 16B may illustrate a specific embodiment of calculating the CCLM parameter. For example, referring to FIG. 16B, the encoding apparatus/decoding apparatus may determine whether or not the current chroma block is a square chroma block (S1605).

In the case where the current chroma block is a square chroma block, the encoding apparatus/decoding apparatus may set a width or a height of the current block to N (S1610) and determine whether or not the size of the current chroma block is size 2×2 (S1615).

Alternatively, in the case where the current chroma block is not a square chroma block, the size of the current chroma block may be derived as size M×N or size N×M (S1620), and the encoding apparatus/decoding apparatus may determine whether or not the size of the current chroma block is size 2×2 (S1615). Here, the M may represent a value greater than the N (N<M).

In the case where the size of the current chroma block is size 2×2, the encoding apparatus/decoding apparatus may select 2 Nₜₕ neighboring samples in a reference line adjacent to the current block as a reference sample for the CCLM parameter calculation (S1625). Here, the Nₜₕ may be 1 (Nth=1).

The encoding apparatus/decoding apparatus may derive parameters α and β for the CCLM prediction based on the selected reference samples (S1630).

Meanwhile, in the case where the size of the current chroma block is not size 2×2, the encoding apparatus/decoding apparatus may determine whether or not the N is 2 (N==2) (S1635).

In the case where the N is 2, the encoding apparatus/decoding apparatus may select 2 Nₜₕ neighboring samples in a reference line adjacent to the current block as a reference sample for the CCLM parameter calculation (S1640). Here, the Nₜₕ may be 2 (Nₜₕ=2). Thereafter, the encoding apparatus/decoding apparatus may derive parameters α and β for the CCLM prediction based on the selected reference samples (S1630).

Meanwhile, in the case where the N is not 2, the encoding apparatus/decoding apparatus may determine whether or not the N is 4 (N==4) (S1645).

In the case that the N is 4, the encoding apparatus/decoding apparatus may select 2 Nₜₕ neighboring samples in a reference line adjacent to the current block as a reference sample for the CCLM parameter calculation (S1650). Here, the Nₜₕ may be 2 (Nₜₕ=2). Thereafter, the encoding apparatus/decoding apparatus may derive parameters α and β for the CCLM prediction based on the selected reference samples (S1630).

Alternatively, in the case where the N is not 4, the encoding apparatus/decoding apparatus may select 2 Nₜₕ neighboring samples in a reference line adjacent to the current block as a reference sample for the CCLM parameter calculation (S1655). Here, the Nₜₕ may be 4 (Nₜₕ=4). Thereafter, the encoding apparatus/decoding apparatus may derive parameters α and β for the CCLM prediction based on the selected reference samples (S1630).

Referring back to FIG. 16A, in the case where the parameters for CCLM prediction for the current chroma block are calculated, the encoding apparatus/decoding apparatus may perform CCLM prediction based on the parameters and generate a prediction sample for the current chroma block (S1660). For example, the encoding apparatus/decoding apparatus may generate a prediction sample for the current chroma block based on above Equation 1 in which the calculated parameters and reconstructed samples of the current luma block for the current chroma block are used.

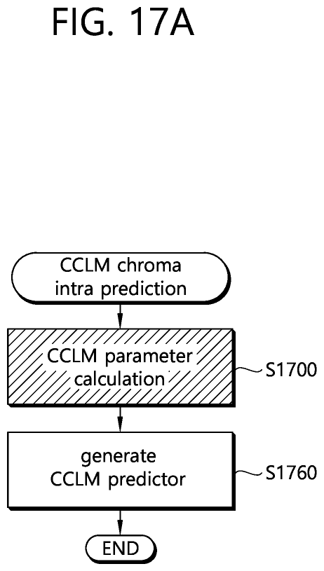

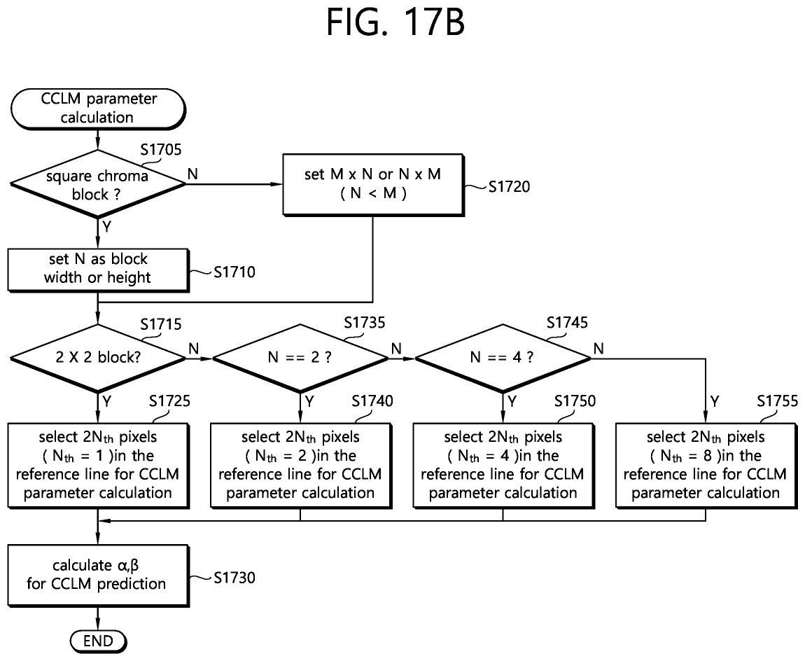

FIGS. 17A and 17B are diagrams for describing a process of performing CCLM prediction based on the CCLM parameters of the current chroma block derived according to method 3 of the embodiment described above.

Referring to FIG. 17A, the encoding apparatus/decoding apparatus may calculate a CCLM parameter for the current block (S1700). For example, the CCLM parameter may be calculated as the embodiment shown in FIG. 17B.

FIG. 17B may illustrate a specific embodiment of calculating the CCLM parameter. For example, referring to FIG. 17B, the encoding apparatus/decoding apparatus may determine whether or not the current chroma block is a square chroma block (S1705).

In the case where the current chroma block is a square chroma block, the encoding apparatus/decoding apparatus may set a width or a height of the current block to N (S1710) and determine whether or not the size of the current chroma block is size 2×2 (S1715).

Alternatively, in the case where the current chroma block is not a square chroma block, the size of the current chroma block may be derived as size M×N or size N×M (S1720), and the encoding apparatus/decoding apparatus may determine whether or not the size of the current chroma block is size 2×2 (S1715). Here, the M may represent a value greater than the N (N<M).

In the case where the size of the current chroma block is size 2×2, the encoding apparatus/decoding apparatus may select 2 Nₜₕ neighboring samples in a reference line adjacent to the current block as a reference sample for the CCLM parameter calculation (S1725). Here, the Nₜₕ may be 1 (Nth=1).

The encoding apparatus/decoding apparatus may derive parameters α and β for the CCLM prediction based on the selected reference samples (S1730).

Meanwhile, in the case where the size of the current chroma block is not size 2×2, the encoding apparatus/decoding apparatus may determine whether or not the N is 2 (N==2) (S1735).

In the case where the N is 2, the encoding apparatus/decoding apparatus may select 2 Nₜₕ neighboring samples in a reference line adjacent to the current block as a reference sample for the CCLM parameter calculation (S1740). Here, the Nₜₕ may be 2 (Nₜₕ=2). Thereafter, the encoding apparatus/decoding apparatus may derive parameters α and β for the CCLM prediction based on the selected reference samples (S1730).

Meanwhile, in the case where the N is not 2, the encoding apparatus/decoding apparatus may determine whether or not the N is 4 (N==4) (S1745).

In the case that the N is 4, the encoding apparatus/decoding apparatus may select 2 Nₜₕ neighboring samples in a reference line adjacent to the current block as a reference sample for the CCLM parameter calculation (S1750). Here, the Nₜₕ may be 4 (Nₜₕ=4). Thereafter, the encoding apparatus/decoding apparatus may derive parameters α and β for the CCLM prediction based on the selected reference samples (S1730).

Alternatively, in the case where the N is not 4, the encoding apparatus/decoding apparatus may select 2 Nₜₕ neighboring samples in a reference line adjacent to the current block as a reference sample for the CCLM parameter calculation (S1755). Here, the Nₜₕ may be 8 (Nₜₕ=8). Thereafter, the encoding apparatus/decoding apparatus may derive parameters α and β for the CCLM prediction based on the selected reference samples (S1730).

Referring back to FIG. 17A, in the case where the parameters for CCLM prediction for the current chroma block are calculated, the encoding apparatus/decoding apparatus may perform CCLM prediction based on the parameters and generate a prediction sample for the current chroma block (S1760). For example, the encoding apparatus/decoding apparatus may generate a prediction sample for the current chroma block based on above Equation 1 in which the calculated parameters and reconstructed samples of the current luma block for the current chroma block are used.

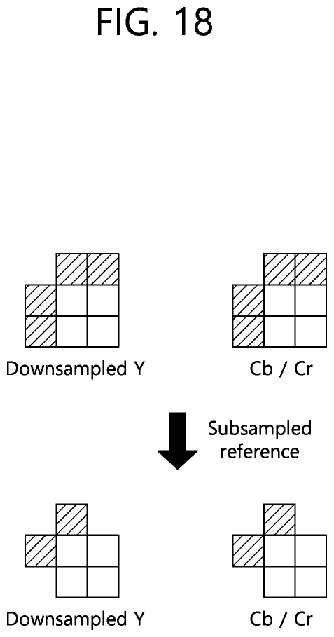

FIG. 18 is a diagram for describing a method of selecting a subsampled sample.

Meanwhile, in this document, in the case where subsampling of a reference sample is required as in the above-described embodiments when selecting a neighboring sample for deriving the CCLM parameter, a method of efficiently selecting a subsampled sample may be proposed.

As shown on the left side of FIG. 18, in a 2×2 chroma block with N=2, CCLM parameters α and β may be calculated using four neighboring reference samples (hatched samples). Further, when Nₜₕ is set to 1 in the 2×2 chroma block, the CCLM parameter may be calculated using two (i.e., half of four) neighboring reference samples (hatched samples) as shown on the right side of FIG. 18. That is, in the case where subsampling is performed, the CCLM parameter may be calculated using fewer neighboring reference samples than before.

However, when using half neighboring reference samples through subsampling, the samples are gathered together top left of the current block, and thus a problem may occur in that the diversity of neighboring reference samples cannot be considered when calculating the CCLM parameter, which may cause a decrease in CCLM parameter accuracy.

Accordingly, this embodiment proposes a method of selecting a sample farthest from top left of the current block first when subsampling the neighboring reference sample. In the case of using this method, by preferentially selecting a sample farther from the top left, more diverse sample values can be selected during the CCLM parameter calculation.

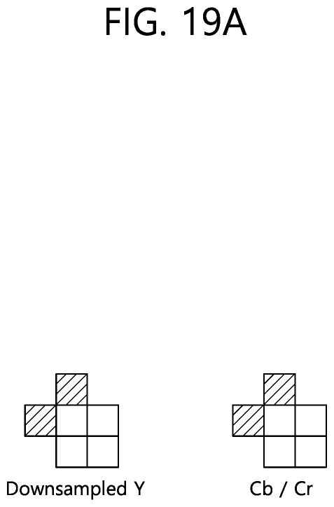

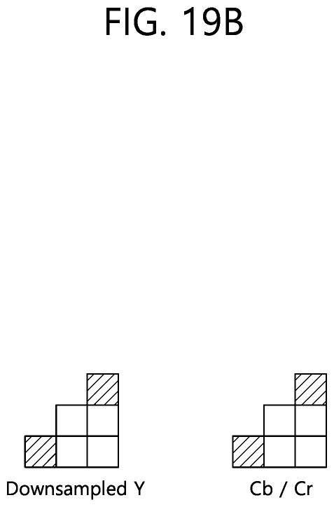

FIGS. 19A and 19B show examples of neighboring reference sample positions for a 2×2 block selected through the subsampling.

For example, when the current block is a block of size 2×2, neighboring samples of the current block may include two left neighboring samples and two top neighboring samples, and one left neighboring sample and one top neighboring sample may be selected through subsampling as the neighboring reference samples.

Referring to FIG. 19A, one left neighboring sample may be selected as a sample located left of the top left sample position of the current block, and one top neighboring sample may be selected as a sample located top of the top left sample position of the current block. That is, the neighboring reference samples may be selected as one left neighboring sample located left of the top left sample position of the current block and one top neighboring sample located top of the top left sample position of the current block. Accordingly, all of the neighboring reference samples may be located adjacent to the top left sample position of the current block.

However, as described above, in this embodiment, the neighboring reference sample may be selected as a sample that is not adjacent to the top left sample position of the current block for diversity of neighboring reference samples.

For example, referring to FIG. 19A, one left neighboring sample may be selected as a sample located left of the bottom left sample position of the current block, and one top neighboring sample may be selected as a sample located top of the top right sample position of the current block. That is, the neighboring reference samples may be selected as one left neighboring sample located left of the bottom left sample position of the current block and one top neighboring sample located top of the top right sample position of the current block.

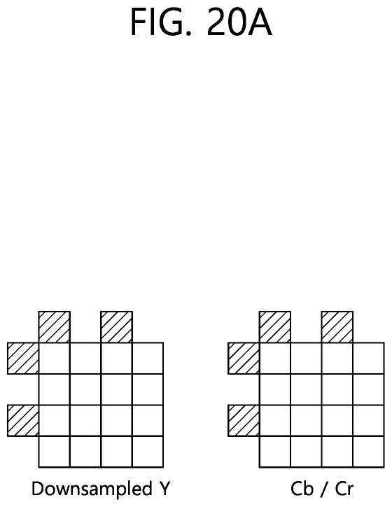

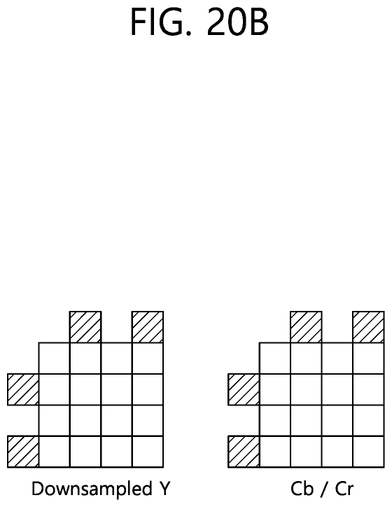

FIGS. 20A and 20B show examples of neighboring reference sample positions for a 4×4 block selected through the subsampling.

For example, when the current block is a block of size 4×4, neighboring samples of the current block may include four left neighboring samples and four top neighboring samples, and two left neighboring samples and two top neighboring samples may be selected through subsampling as the neighboring reference samples.

Referring to FIG. 20A, based on the top left sample position (0, 0) of the current block, two left neighboring samples may be selected as samples located at (−1, 0) and (−1, 2), and the two top neighboring samples may be selected as samples located at (0, −1) and (2, −1). That is, the neighboring reference samples may be selected as two left neighboring samples located at (−1, 0) and (−1, 2), and two top neighboring samples located at (0, −1) and (2, −1). Accordingly, two of the neighboring reference samples may be located adjacent to the top left sample position of the current block.

However, as described above, in this embodiment, some of the neighboring reference samples may be selected as samples that are not adjacent to the top left sample position of the current block for diversity of neighboring reference samples.

Referring to FIG. 20B, based on the top left sample position (0, 0) of the current block, two left neighboring samples may be selected as samples located at (−1, 1) and (−1, 3), and the two top neighboring samples may be selected as samples located at (1, −1) and (3, −1). That is, the neighboring reference samples may be selected as two left neighboring samples located at (−1, 1) and (−1, 3), and two top neighboring samples located at (1, −1) and (3, −1).

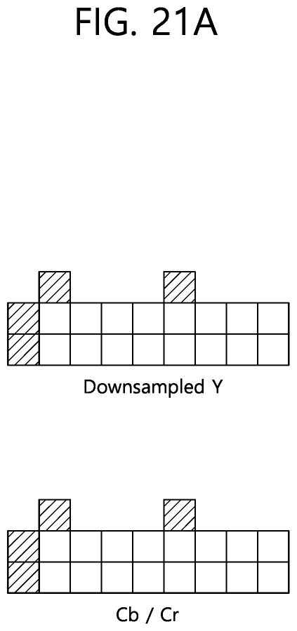

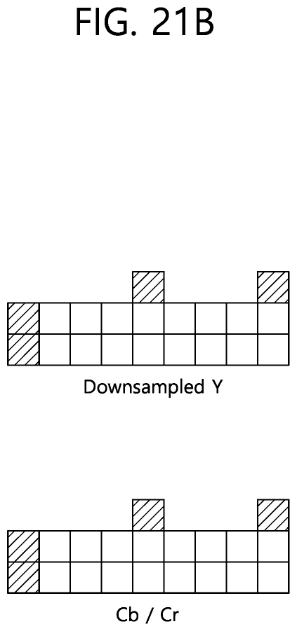

FIGS. 21A and 21B show examples of neighboring reference sample positions for an 8×2 block selected through the subsampling.

For example, when the current block is a block of size 8×2, neighboring samples of the current block may include two left neighboring samples and eight top neighboring samples, and two left neighboring samples and two top neighboring samples may be selected through subsampling as the neighboring reference samples.

Referring to FIG. 21A, based on the top left sample position (0, 0) of the current block, two left neighboring samples may be selected as samples located at (−1, 0) and (−1, 1), and the two top neighboring samples may be selected as samples located at (0, −1) and (4, −1). That is, the neighboring reference samples may be selected as two left neighboring samples located at (−1, 0) and (−1, 1), and two top neighboring samples located at (0, −1) and (4, −1). Accordingly, two of the neighboring reference samples may be located adjacent to the top left sample position of the current block.

However, as described above, in this embodiment, some of the neighboring reference samples may be selected as samples that are not adjacent to the top left sample position of the current block for diversity of neighboring reference samples.

Referring to FIG. 21B, based on the top left sample position (0, 0) of the current block, two left neighboring samples may be selected as samples located at (−1, 1) and (−1, 2), and the two top neighboring samples may be selected as samples located at (3, −1) and (7, −1). That is, the neighboring reference samples may be selected as two left neighboring samples located at (−1, 1) and (−1, 2), and two top neighboring samples located at (3, −1) and (7, −1).

That is, even in the case of a non-square chroma block such as n×2 or 2×n, sample selection can be performed from the distal of the top left through subsampling, through which, as described above, more diverse sample values can be selected during the CCLM parameter calculation, and thus, the accuracy of the CCLM parameter calculation can be improved.

For example, Equation 5 may be used for a method of selecting a sample through subsampling from among neighboring samples. This may be a method of selecting a sample through existing subsampling.

Idx_w=(x*width)/subsample_num

Idx_h=(y*height)/subsample_num [Equation 5]

In Equation 5, x is a variable and may increase from 0 to the number of reference samples after subsampling of the top reference samples of the chroma block minus 1, width may denote the width of the chroma block, and subsample_num may denote the number of reference samples after the subsampling. Idx_w may denote a position of a chroma sample selected during the subsampling. For example, in the case where two samples are selected from a chroma block having a width of 16, then width is 16, x is 0 or 1, and subsample_num is 2, and thus 0 or 8 may be selected as the Idx_w value. In other words, the Idx_w value may indicate the x-coordinate value of the subsampled top neighboring reference sample, and when the Idx_w value is 0 or 8, the position of the subsampled top neighboring reference sample may be (0, −1) or (8, −1).

Additionally, in Equation 5, y is a variable and may increase from 0 to the number of reference samples after subsampling of the top reference samples of the chroma block minus 1. height may denote the height of the chroma block, and subsample_num may denote the number of reference samples after the subsampling. Idx_h may denote a position of a chroma sample selected during the subsampling. For example, in the case where four samples are selected from a chroma block having a height of 32, then height is 32, x is 0, 1, 2 or 3, and subsample_num is 4, and thus 0, 8, 16 or 24 may be selected as the Idx_h value. In other words, the Idx_h value may indicate the y-coordinate value of the subsampled left neighboring reference sample, and when the Idx_h value is 0, 8, 16 or 24, the position of the subsampled left neighboring reference sample may be (−1, 0), (−1, 8), (−1, 16) or (−1, 24).

However, according to the method of selecting a sample located far from the top left of the current block described in this embodiment, Equation 6 may be, for example, used for a method of selecting a sample through subsampling from among neighboring samples.

Idx_w=width−1−(x*width)/subsample_num_width

Idx_h=height−1−(y*height)/subsample_num_height [Equation 6]

In Equation 6, x is a variable and may increase from 0 to the number of reference samples after subsampling of the top reference samples of the chroma block minus 1. width may denote the width of the chroma block, and subsample_num_width may denote the number of samples after the subsampling. Idx_w may denote a position of a chroma sample selected during the subsampling. For example, in the case where two samples are selected from a chroma block having a width of 16, then width is 16, x is 0 or 1, and subsample_num_width is 2, and thus 15 or 7 may be selected as the Idx_w value. In other words, the Idx_w value may indicate the x-coordinate value of the subsampled top neighboring reference sample, and when the Idx_w value is 15 or 7, the position of the subsampled top neighboring reference sample may be (15, −1) or (7, −1).

Additionally, in Equation 6, y is a variable and may increase to the number of reference samples after subsampling of the left reference samples of the chroma block minus 1. height may indicate the height of the chroma block, and subsample_num_height may indicate the number of samples after the subsampling of the height (or the left of the current block). Idx_h may denote a position of a chroma sample selected during the subsampling. For example, in the case where four samples are selected from a chroma block having a height of 32, then height is 32, x is 0, 1, 2 or 3, and subsample_num_height is 4, and thus 31, 23, 15 or 7 may be selected as the Idx_h value. In other words, the Idx_h value may indicate the y-coordinate value of the subsampled left neighboring reference sample, and when the Idx_h value is 31, 23, 15 or 7, the position of the subsampled left neighboring reference sample may be (−1, 31), (−1, 23), (−1, 15) or (−1, 7).

In Equation 6, subsample_num_width and subsample_num_height may be automatically determined as shown in Table 22, for example. That is, subsample_num_width and subsample_num_height may be set to the preset values as shown in Table 22, for example.

TABLE 22

| | (subsample_num_width, |
|---|---|
| Chroma block size | subsample_num_height) |
| 2 × 2, 2 × N, N × 2 (N > 2) | (2, 2) |
| 4 × 4, 4 × N, N × 4 (N > 4) | (4, 4) |
| 8 × 8, 8 × N, N × 8 (N > 8) | (8, 8) |
| 16 × 16, 16 × N, N × 16 (N > 16) | (16, 16) |
| 32 × 32, 32 × N, N × 32 (N > 32) | (32, 32) |
| 64 × 64 | (64, 64) |

For example, referring to Table 22, the subsampling may be performed on the longer of the width and height of the current chroma block according to the smaller thereof, and may be represented as Equation (7).

subsample_num_width=subsample_num_height=min(width, height)) [Equation 7]

Alternatively, for example, subsample_num_width and subsample_num_height may be determined as in Equation 8 according to the Nₜₕ value.

subsample_num_width=min(width,height) if Nₜₕ>=width

subsample_num_width=min(Nₜₕ, height) if Nₜₕ<width

subsample_num_height=min(width,height) if Nₜₕ>=height

subsample_num_height=min(Nₜₕ, width) if Nₜₕ<height [Equation 8]

In Equations 7 and 8, min(A, B) may denote an equation by which a smaller value is derived from among A and B.

Alternatively, for example, an optimal subsampling in accordance with the shape of the current block may be performed using a preset look-up table (LUT) as shown in Table 23. That is, optimal subsampling may be performed based on the size and shape of the current block.

TABLE 23

| | (subsample_num_width, |
|---|---|
| Chroma block size | subsample_num_height) |
| 2 × 2, 2 × 4, 2 × 8, 2 × 16, 2 × 32 | (2, 2), (2, 2), (2, 6), (2, 14), (2, 30) |
| 4 × 2, 8 × 2, 16 × 2, 32 × 2 | (2, 2), (6, 2), (14, 2), (30, 2) |
| 4 × 4, 4 × 8, 4 × 16, 4 × 32 | (4, 4), (4, 4), (4, 12), (4, 28) |
| 8 × 4, 16 × 4, 32 × 4 | (4, 4), (12, 4), (28, 4) |
| 8 × 8, 8 × 16, 8 × 32 | (8, 8), (8, 8), (8, 24) |
| 16 × 8, 32 × 8 | (8, 8), (24, 8) |
| 16 × 16, 16 × 32 | (16, 16), (16, 16) |
| 32 × 16 | (16, 16) |
| 32 × 32 | (32, 32) |

For example, in the case where the LUT as shown in Table 23 is used, the number of neighboring reference samples can be increased compared to the existing subsampling method, and through this, the CCLM parameter can be calculated with high accuracy. For example, for six subsamplings in Table 23 (or in the case where subsample_num_width or subsample_num_hight is six), six positions (idx_w or idx_h) which appear earlier among eight subsampled samples (or which are derived earlier according to the lower variable x or y) may be selected, while, for twelve or fourteen subsamplings (or in the case where subsample_num_width or subsample_num_hight is twelve or fourteen), twelve or fourteen positions (idx_w or idx_h) which appear earlier among sixteen subsampled samples (or which are derived earlier according to the lower variable x or y) may be selected. For twenty four or twenty eight subsamplings (or in the case where subsample_num_width or subsample_num_hight is twenty four or twenty eight), twenty four or twenty eight positions (idx_w or idx_h) which appear earlier among thirty two subsampled samples (or which are derived earlier according to the lower variable x or y) may be selected.

Alternatively, for example, simplified subsampling as shown in Table 24 may be performed to prevent increase in hardware complexity.

TABLE 24

| | (subsample_num_width, |
|---|---|
| Chroma block size | subsample_num_height) |
| 2 × 2, 2 × 4, 2 × 8, 2 × 16, 2 × 32 | (2, 2), (2, 2), (2, 6), (2, 6), (2, 6) |
| 4 × 2, 8 × 2, 16 × 2, 32 × 2 | (2, 2), (6, 2), (6, 2), (6, 2) |
| 4 × 4, 4 × 8, 4 × 16, 4 × 32 | (4, 4), (4, 4), (2, 6), (2, 6) |
| 8 × 4, 16 × 4, 32 × 4 | (4, 4), (6, 2), (6, 2) |
| 8 × 8, 8 × 16, 8 × 32 | (4, 4), (4, 4), (2, 6) |
| 16 × 8, 32 × 8 | (4, 4), (6, 2) |
| 16 × 16, 16 × 32 | (4, 4), (4, 4) |
| 32 × 16 | (4, 4) |
| 32 × 32 | (4, 4) |

That is, by adjusting the sum of subsample_num_width and subsample_num_height to at most 8 as shown in Table 24, it is possible to efficiently calculate the CCLM parameter while reducing the increase in hardware complexity. For example, for six subsamplings in Table 24 (or in the case where subsample_num_width or subsample_num_hight is six), six positions (idx_w or idx_h) which appear earlier among eight subsampled samples (or which are derived earlier according to the lower variable x or y) may be selected.

Meanwhile, in this embodiment, they may be derived as preset values in the encoding apparatus and the decoding apparatus without the need to transmit additional information. Alternatively, information about whether or not to use the method according to the present embodiment or information about values may be transmitted in units of coding units (CUs), slices, pictures, or sequences.

For example, when subsampling is performed using the LUT shown in Table 23 or 24, the encoding apparatus may use the subsample_num_width or subsample_num_hight value based on Table 23 or 24. Alternatively, when Nth is used, the subsample_num_width or subsample_num_hight value may be determined according to the Nₜₕ value. Alternatively, as shown in Table 22, a default value of subsample_num_width or subsample_num_hight may be used.

For example, in the case where information about whether or not to use the method according to this embodiment (or additional information about the subsampling method) is transmitted in units of CUs, when the intra prediction mode of the current chroma block is the CCLM mode, a method of parsing the cclm_subsample_flag syntax element and performing the CCLM parameter calculation process may be proposed as described below.

In the case where the value of the cclm_subsample_flag syntax element is 0 (false), a sample selection and a CCLM parameter calculation are performed through the existing subsampling method (e.g., a method using Equation 5)

In the case where the value of the cclm_subsample_flag syntax element is 1 (true), a sample selection and a CCLM parameter calculation are performed through the subsampling method (e.g., a method using Equation 6) according to this embodiment

Alternatively, when additional information indicating the subsampling method is transmitted in units of slices, pictures, or sequences, as described below, subsampling may be determined and decoded based on the additional information transmitted through high level syntax (HLS). In this case, the additional information may be encoded by the encoder and transmitted while being included in the bitstream, and hereinafter is the same. In this document, a slice/slice header may be replaced with a tile/tile header or a tile group/tile group header.

For example, the additional information signaled through the slice header may be represented as shown in the following table.

TABLE 25

| | Descriptor |
|---|---|
| slice_header( ) { | |
| ... | |
| cclm_subsample_flag | f(1) |
| ... | |

The cclm_subsample_flag syntax element may indicate a syntax element of the additional information.

Alternatively, for example, the additional information signaled through a picture parameter set (PPS) may be represented as shown in the following table.

TABLE 26

| | Descriptor |
|---|---|
| pic_parameter_set_rbsp( ) { | |
| ... | |
| cclm_subsample_flag | f(1) |
| ... | |

Alternatively, for example, the additional information signaled through a Sequence Parameter Set (SPS) may be represented as shown in the following table.

TABLE 27

| | Descriptor |
|---|---|
| seq_parameter_set_rbsp( ) { | |
| ... | |
| cclm_subsample_flag | f(1) |
| ... | |

Additional information derived based on the value of the cclm_subsample_flag syntax element transmitted through the slice header, the PPS or the SPS (that is, a value derived by decoding the cclm_subsample_flag syntax element) may be derived as shown in the following table.

TABLE 28

| cclm_subsample_flag | proposed method |
|---|---|
| 0 | not apply (e.g. using Eq. 5) |
| 1 | apply (e.g. using Eq. 6) |

Referring to Table 28, when the value of the cclm_subsample_flag syntax element is 0, the method applied to the current chroma block may be selected as the existing subsampling method, and when the value of the cclm_subsample_flag syntax element is 1, the method applied to the current chroma block may be selected as the subsampling method according to the embodiment.

The method proposed in this embodiment may be used for a CCLM mode which is an intra-prediction mode for a chroma component, and the chroma block predicted through the CCLM mode may be used to derive a residual image through a difference from an original image in the encoding apparatus or used to derive reconstructed image through an addition with a residual signal in the decoding apparatus.

Meanwhile, in the case where information indicating whether or not the subsampling method is applied in units of CUs, slices, pictures and sequences is transmitted, the encoding apparatus may determine a subsampling method from among the existing subsampling methods and the subsampling methods according to the present embodiments, and then transmit the information to the decoding apparatus as follows.

In the case where information indicating whether or not the method of the above-described embodiment is used is transmitted in units of CUs, when the intra prediction mode of the current chroma block is the CCLM mode (that is, when CCLM prediction is applied to the current chroma block), the encoding apparatus may determine which of the following two cases has better encoding efficiency through the RDO, and may transmit information about the determined method to the decoding apparatus.

1) When it has a good encoding efficiency to perform the CCLM parameter calculation through the existing subsampling method, a cclm_subsample_flag syntax element with a value of 0 (false) is transmitted (e.g., using Equation 5)

2) When it has a good encoding efficiency to perform the CCLM parameter calculation through the subsampling method according to this embodiment, a cclm_subsample_flag syntax element with a value of 1 (true) is transmitted (e.g., using Equation 6)

Alternatively, when information indicating whether or not the method of this embodiment is applied is transmitted in units of slices, pictures, or sequences, the encoding apparatus may transmit information indicating whether or not the method is applied by adding high level syntax (HLS) as shown in Table 25, 26, or 27 described above. Alternatively, as in Table 25, 26, or 27 described above, information indicating whether or not the method is applied may be included in HLS. For example, the information indicating whether or not the method is applied may include a cclm_subsample_flag syntax element, and the value of the cclm_subsample_flag syntax element may be derived based on Table 28. The encoding apparatus may set a method to be applied from among said methods in consideration of the size of the input image or in accordance with an encoding target bitrate.

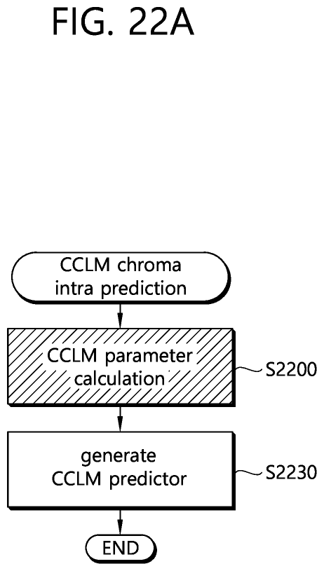

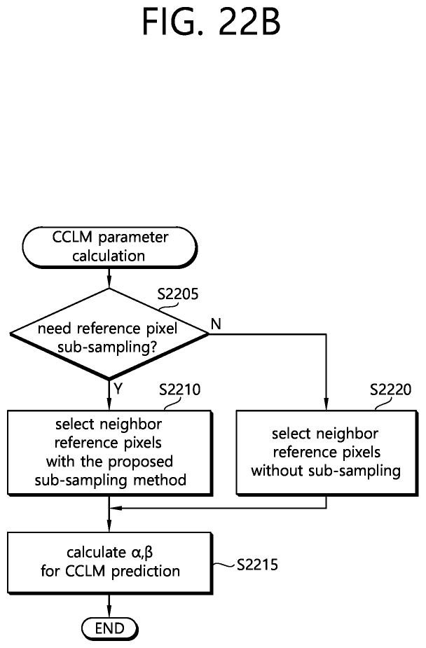

FIGS. 22A and 22B are diagrams for describing a process of performing CCLM prediction based on the CCLM parameters of the current chroma block derived according to the method of the embodiment described above.

Referring to FIG. 22A, the encoding apparatus/decoding apparatus may calculate a CCLM parameter for the current block (S2200). For example, the CCLM parameter may be calculated as the embodiment shown in FIG. 22B.

FIG. 22B may illustrate a specific embodiment of calculating the CCLM parameter. For example, referring to FIG. 22B, the encoding apparatus/decoding apparatus may determine whether or not the current chroma block needs reference pixel subsampling (or reference sample subsampling) (S2205).

When the current chroma block needs reference pixel subsampling, the encoding device/decoding device may select a neighboring reference pixel using the subsampling method proposed according to the embodiment (S2210), and derive parameters α and β for CCLM prediction using the selected neighboring reference pixel (S2215).

Alternatively, when the current chroma block does not need reference pixel subsampling, the encoding device/decoding device may select a neighboring reference pixel without the subsampling (S2220), and derive parameters α and β for CCLM prediction using the selected neighboring reference pixel (S2215).

Referring back to FIG. 22A, in the case where the parameters for CCLM prediction for the current chroma block are calculated, the encoding apparatus/decoding apparatus may perform CCLM prediction based on the parameters and generate a prediction sample for the current chroma block (S2230). For example, the encoding apparatus/decoding apparatus may generate a prediction sample for the current chroma block based on above Equation 1 in which the calculated parameters and reconstructed samples of the current luma block for the current chroma block are used.

Meanwhile, in this document, an embodiment different from the above-described embodiment may be proposed for reducing the computational complexity of deriving the CCLM parameter in deriving the CCLM parameter.

For example, for parameter calculations in CCLM and MDLM, samples may be selected as follows.

In CCLM, in the case of an N×N chroma block, a total of 2N (N horizontal, N vertical) block neighboring reference sample pairs are selected.

In CCLM, in the case of an N×M, M×N (N<=M) chroma block, a total of 2N (N horizontal, N vertical) block neighboring reference sample pairs are selected. Since M is greater than N (e.g., M=2N, 3N), N samples are selected through subsampling from M pixels.

In MDLM, in the case of an N×M chroma block, 2N top reference sample pairs are selected in LM_A mode.

In MDLM, in the case of an M×N chroma block, 2N left reference sample pairs are selected in LM_L mode.

Particularly, in order to address the problem of increase in CCLM parameter operation amount by the increase in the chroma block size, this embodiment proposes a method of setting a sample selection top limit Nₜₕ adaptively. Additionally, in the case of N=2, that is, in order to prevent a worst case operation (after all chroma blocks in the CTU are split into 2×2, CCLM prediction is performed on all blocks) occurring during CCLM prediction of a 2×2 chroma block, Nₜₕ can be adaptively set, thereby reducing the amount of comparison operation in the worst case by 50%.

To this end, the Nₜₕ may be set adaptively to the block size as follows.

Method 1 in this embodiment (proposed method 1)

In the case of N=2 in the current chroma block of size N×M or size M×N, the Nₜₕ is set to 1 (Nₜₕ=1)

In the case of N=4 in the current chroma block of size N×M or size M×N, the Nₜₕ is set to 2 (Nₜₕ=2)

In the case of N>4 in the current chroma block of size N×M or size M×N, the Nₜₕ is set to 4 (Nₜₕ=4)

Alternatively, for example, according to this embodiment, the Nₜₕ may be set adaptively to a block size as follows.

Method 2 in this embodiment (proposed method 2)

In the case of N=2 in the current chroma block of size N×M or size M×N, the Nₜₕ is set to 1 (Nₜₕ=1)

In the case of N=4 in the current chroma block of size N×M or size M×N, the Nₜₕ is set to 2 (Nₜₕ=2)

Alternatively, for example, according to this embodiment, the Nₜₕ may be set adaptively to a block size as follows.

Method 3 in this embodiment (proposed method 3)

In the case of N>4 in the current chroma block of size N×M or size M×N, the Nₜₕ is set to 4 (Nₜₕ=4)

Alternatively, for example, according to this embodiment, the Nₜₕ may be set adaptively to a block size as follows.

Method 4 in this embodiment (proposed method 4)

In the case of N>2 in the current chroma block of size N×M or size M×N, the Nₜₕ is set to 2 (Nₜₕ=2)

In the above-mentioned methods, when N=2, the total number of samples for CCLM parameter calculation means 4 (2N), and Nth=1 means that only two (2Nth) are used for CCLM parameter calculation. Additionally, when N=4, the total number of samples for CCLM parameter calculation means 8 (2N), and Nth=2 means that only four (2Nth) are used for CCLM parameter calculation.

In Method 1 of this embodiment, when using 4 samples (when using CCLM in 2×N and N×2, and LM_A mode in 2×N and LM_L mode in N×2 for MDLM), the comparison operation in the worst case can be reduced by half by using half of the samples. Further, even when eight samples are used (when using conventional CCLM in 4×N and N×4, and LM_A mode in 4×N and LM_L mode in N×4 for MDLM), the amount of comparison operation can be greatly reduced by using half of the samples, and even when using more than that, CCLM parameter operation can be performed using only up to 8 samples.

In method 2 of this embodiment, when using 4 samples (when using CCLM in 2×N and N×2, and LM_A mode in 2×N and LM_L mode in N×2 for MDLM), the comparison operation in the worst case can be reduced by half by using half the samples, and even when using more than that, CCLM parameter operation can be performed using only up to 4 samples.

Method 3 of this embodiment can perform CCLM parameter operation using only up to 8 samples, and method 4 of this embodiment can perform CCLM parameter operation using only up to 4 samples. That is, in said method 4, the CCLM parameter can be calculated using only 4 samples in all blocks.

Methods 1 to 4 described above can reduce the amount of worst case comparison operation in the case of N=2 by 50%, and since Nₜₕ can be applied adaptively to each chroma block size, encoding loss can be minimized

In other words, by setting Nₜₕ adaptively to the block size, the number of samples optimized for the block size can be selected, and after setting Nth, the CCLM parameter can be calculated through Equation 4 by selecting chroma block neighboring samples.

For example, Table 29 may represent the CCLM parameter calculation operation amount according to the chroma block size when the above-described methods are applied.

TABLE 29

| | Number of comparison operations | | | | |
|---|---|---|---|---|---|
| | | Proposed | | | |
| | | method 1 | Proposed | Proposed | Proposed |
| Block | Original | (Nₜₕ = 1, | method 2 | method 3 | method 4 |
| size | CCLM | 2, 4) | (Nₜₕ = 1, 2) | (Nₜₕ = 4) | (Nₜₕ = 2) |
| N = 2 | 8 | 4 | 4 | 8 | 8 |
| N = 4 | 16 | 8 | 8 | 16 | 8 |
| N = 8 | 32 | 16 | 8 | 16 | 8 |
| N = 16 | 64 | 16 | 8 | 16 | 8 |
| N = 32 | 128 | 16 | 8 | 16 | 8 |

Referring to Table 29, in the case where the methods proposed in this embodiment are used, it can be seen that an amount of operation required for the CCLM parameter calculation is not increased even though the block size is increased.

The following table may represent experimental result data in the case of using method 1 among the above methods.

TABLE 30

All Intra Main10
Over VTM-3.0rc1

| | Y | U | V | EncT | DecT |
|---|---|---|---|---|---|
| Class A1 | −0.05% | −0.27% | −0.43% | 99% | 99% |
| Class A2 | 0.01% | 0.05% | 0.06% | 100% | 99% |
| Class B | 0.00% | −0.24% | −0.32% | 99% | 98% |
| Class C | −0.04% | −0.05% | −0.03% | 97% | 91% |
| Class E | −0.02% | −0.04% | −0.06% | 98% | 95% |
| Overall | −0.02% | −0.12% | −0.17% | 99% | 96% |
| Class D | 0.02% | 0.07% | 0.00% | 98% | 97% |

The following table may represent experimental result data in the case of using method 2 among the above methods.

TABLE 31

| | All Intra Main10 | | | | |
|---|---|---|---|---|---|
| | Over VTM-3.0rc1 | | | | |
| | Y | U | V | EncT | DecT |
| Class A1 | 0.01% | −0.02% | −0.13% | 99% | 99% |
| Class A2 | 0.07% | 0.42% | 0.24% | 98% | 97% |
| Class B | 0.03% | −0.10% | −0.15% | 98% | 96% |
| Class C | −0.01% | 0.17% | 0.12% | 98% | 93% |
| Class E | −0.02% | 0.10% | −0.02% | 98% | 97% |
| Overall | 0.02% | 0.09% | 0.00% | 98% | 96% |
| Class D | 0.03% | 0.22% | 0.25% | 98% | 99% |

Referring to Table 30, in method 1, there is no coding loss even though the CCLM parameter calculation operation amount is reduced (Nₜₕ=1, 2 or 4), and, however, rather a slight performance gain (Y 0.02%, Cb 0.12%, Cr 0.17% performance gain) can be obtained. In addition, it can be confirmed that the encoding and decoding complexity are reduced to 99% and 96%.

Further, referring to Table 31, it can be seen that, in said method 2, there is almost no coding efficiency loss even when the CCLM parameter calculation operation amount is greatly reduced (Nₜₕ=1, 2), and that the encoding and decoding complexity are also reduced to 99% and 96%.

Meanwhile, according to this embodiment, without the need to transmit additional information, a promised value may be used in the encoding apparatus and the decoding apparatus, or information indicating whether or not the proposed method is used and the value may be transmitted in units of CUs, slices, pictures, and sequences.

For example, in the case where information indicating whether or not the proposed method is used is transmitted in units of CUs, when the intra prediction mode of the current chroma block is the CCLM mode (i.e., when CCLM prediction is applied to the current chroma block), the cclm_reduced_sample_flag syntax element is parsed as follows, so that the above-described embodiment may be performed. The cclm_reduced_sample_flag syntax element may indicate a syntax element of a CCLM reduced sample flag.

When the value of the cclm_reduced_sample_flag syntax element is 0 (false), the Nₜₕ is set to 4 for all the blocks, and CCLM parameter calculation is performed through the neighboring sample selection method of the above-described embodiment proposed in FIG. 9

When the value of the cclm_reduced_sample_flag syntax element is 1 (true), CCLM parameter calculation is performed through method 2 (Nth=1 or 2) of this embodiment described above

Alternatively, when information indicating a method to be applied is transmitted in units of slices, pictures, or sequences, a method to be applied may be selected from among the above-described methods 1 to 4 based on the information transmitted through high level syntax (HLS) as described later, and the CCLM parameter may be calculated based on the selected method.

For example, the information indicating the method to be applied signaled through a slice header may be represented as in the following Table.

TABLE 32

| | Descriptor |
|---|---|
| slice_header( ) { | |
| ... | |
| cclm_reduced_sample_threshold | f(2) |
| ... | |

cclm_reduced_sample_threshold may represent a syntax element of information indicating the method to be applied.

Alternatively, for example, the information indicating the method to be applied signaled through a Picture Parameter Set (PPS) may be represented as in the following table.

TABLE 33

| | Descriptor |
|---|---|
| pic_parameter_set_rbsp( ) { | |
| ... | |
| cclm_reduced_sample_threshold | f(2) |
| ... | |

Alternatively, for example, the information indicating the method to be applied signaled through a Sequence Parameter Set (SPS) may be represented as in the following table.

TABLE 34

| | Descriptor |
|---|---|
| seq_parameter_set_rbsp( ) { | |
| ... | |
| cclm_reduced_sample_threshold | f(2) |
| ... | |

The method selected based on the value of the cclm_reduced_sample_threshold transmitted through the slice header, the PPS or the SPS (i.e., a value derived by decoding cclm_reduced_sample_threshold) may be derived as shown in the following table.

TABLE 35

| cclm_reduced_sample_threshold | Proposed method |
|---|---|
| 0 | 1 (Nₜₕ = 1, 2, 4) |
| 1 | 2 (Nₜₕ = 1, 2) |
| 2 | 3 (Nₜₕ = 4) |
| 3 | 4 (Nₜₕ = 2) |

Referring to Table 35, when the value of the cclm_reduced_sample_threshold syntax element is 0, the method applied to the current chroma block may be selected as said method 1; when the value of the cclm_reduced_sample_threshold syntax element is 1, the method applied to the current chroma block may be selected as said method 2; when the value of the cclm_reduced_sample_threshold syntax element is 2, the method applied to the current chroma block may be selected as said method 3; and when the value of the cclm_reduced_sample_threshold syntax element is 3, the method applied to the current chroma block may be selected as method 4 above.

The method proposed in this embodiment may be used for a CCLM mode which is an intra-prediction mode for a chroma component, and the chroma block predicted through the CCLM mode may be used to derive a residual image through a difference from an original image in the encoding apparatus or used to derive reconstructed image through an addition with a residual signal in the decoding apparatus.

Meanwhile, when information indicating one of the methods is transmitted in units of CUs, slices, pictures and sequences, the encoding apparatus may determine one of the methods 1 to 4, and then transmit the information to the decoding apparatus as follows.

In the case where information indicating whether or not the method of the above-described embodiment is used is transmitted in units of CUs, when the intra prediction mode of the current chroma block is the CCLM mode (that is, when CCLM prediction is applied to the current chroma block), the encoding apparatus may determine which of the following two cases has better encoding efficiency through the RDO, and may transmit information about the determined method to the decoding apparatus.

1) When the Nₜₕ is set to 4 for all blocks, and it has a good encoding efficiency to perform CCLM parameter calculation through the neighboring sample section method of the above-described embodiment proposed in FIG. 9, a cclm_reduced_sample_flag syntax element with a value of 0 (false) is transmitted

2) When it is set that said method 2 is applied and it has a good encoding efficiency to perform CCLM parameter calculation through the neighboring sample selection method proposed in the above-described embodiment, a cclm_reduced_sample_flag syntax element with a value of 1 (true) is transmitted

Alternatively, in the case where the information indicating whether or not the method of the embodiment described above is applied is transmitted in units of slices, pictures or sequences, the encoding apparatus may add a high level syntax (HLS) as represented in Table 32, 33 or 34 described above, and transmit the information representing one method of said methods. Alternatively, information indicating one of the methods may be included in the HLS as shown in Table 32, 33, or 34 described above. For example, the information indicating one of the methods may include a cclm_reduced_sample_threshold syntax element, and the value of the cclm_reduced_sample_threshold syntax element may be derived based on Table 35. The encoding apparatus may set a method to be applied from among said methods in consideration of the size of the input image or in accordance with an encoding target bitrate.

1) For example, when the input image is HD or higher, the encoding apparatus may apply said method 1 (Nₜₕ=1, 2 or 4), and when the input image is HD or lower, it may apply said method 2 (Nₜₕ=1 or 2).

2) When high quality image encoding is required, the encoding apparatus may apply said method 3 (Nₜₕ=4), and when low quality image encoding is required, it may apply said method 4 (Nₜₕ=2).

The method proposed in this embodiment may be used for a CCLM mode which is an intra-prediction mode for a chroma component, and the chroma block predicted through the CCLM mode may be used to derive a residual image through a difference from an original image in the encoding apparatus or used to derive reconstructed image through an addition with a residual signal in the decoding apparatus.

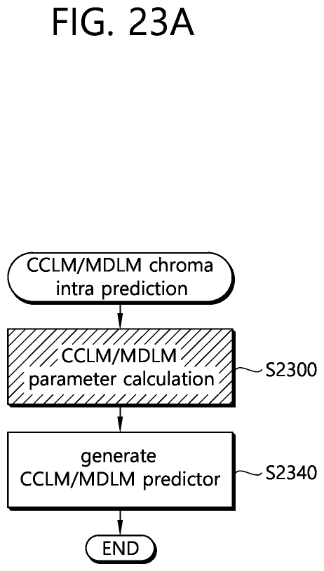

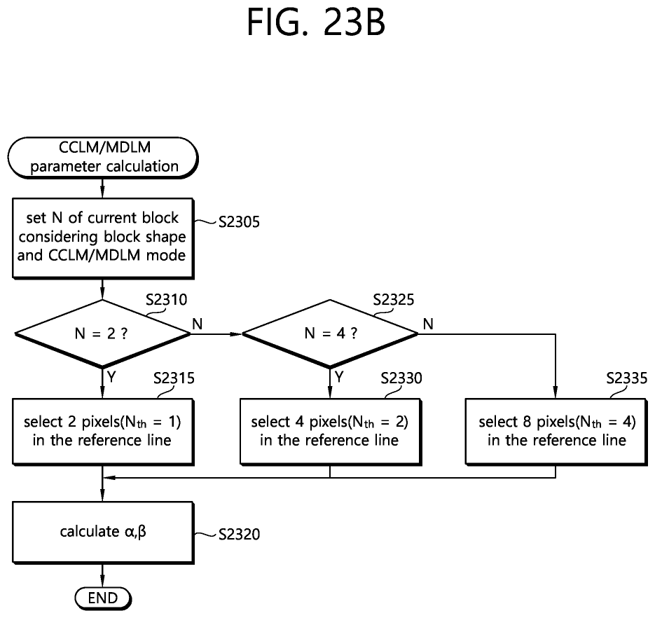

FIGS. 23A and 23B are diagrams for describing a process of performing CCLM/MDLM prediction based on the CCLM/MDLM parameters of the current chroma block derived according to method 1 of the embodiment described above.

Referring to FIG. 23A, the encoding apparatus/decoding apparatus may calculate a CCLM/MDLM parameter for the current block (S2300). For example, the CCLM/MDLM parameter may be calculated as the embodiment shown in FIG. 23B.

FIG. 23B may illustrate a specific embodiment of calculating the CCLM/MDLM parameter. For example, referring to FIG. 23B, the encoding apparatus/decoding apparatus may set N of the current block in consideration of the shape of the block and the CCLM/MDLM mode (S2305).

The encoding apparatus/decoding apparatus may determine whether or not N is 2 (N==2) (S2310).

In the case where the N is 2, the encoding apparatus/decoding apparatus may select two samples in a reference line adjacent to the current block (S2315). Here, the Nₜₕ may be 1 (Nth=1). Thereafter, the encoding apparatus/decoding apparatus may derive parameters α and β for the CCLM/MDLM prediction based on the selected samples (S2320).

Alternatively, in the case where the N is not 2, the encoding apparatus/decoding apparatus may determine whether or not the N is 4 (N==4) (S2325).

In the case where the N is 4, the encoding apparatus/decoding apparatus may select four samples in a reference line adjacent to the current block (S2330). Here, the Nₜₕ may be 2 (Nₜₕ=2). Thereafter, the encoding apparatus/decoding apparatus may derive parameters α and β for the CCLM/MDLM prediction based on the selected samples (S2320).

Alternatively, in the case where the N is not 4, the encoding apparatus/decoding apparatus may select eight samples in a reference line adjacent to the current block (S2335). Here, the Nₜₕ may be 4 (Nₜₕ=4). Thereafter, the encoding apparatus/decoding apparatus may derive parameters α and β for the CCLM/MDLM prediction based on the selected samples (S2320).

Referring back to FIG. 23A, in the case where the parameters for CCLM/MDLM prediction for the current chroma block are calculated, the encoding apparatus/decoding apparatus may perform CCLM/MDLM prediction based on the parameters and generate a prediction sample for the current chroma block (S2340). For example, the encoding apparatus/decoding apparatus may generate a prediction sample for the current chroma block based on above Equation 1 in which the calculated parameters and reconstructed samples of the current luma block for the current chroma block are used.

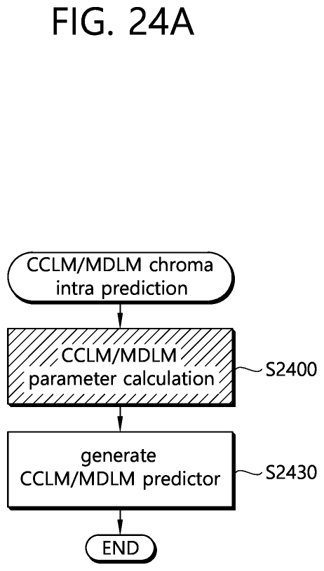

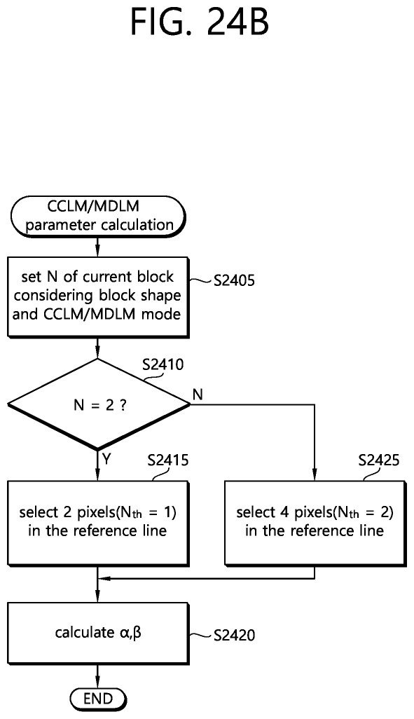

FIGS. 24A and 24B are diagrams for describing a process of performing CCLM/MDLM prediction based on the CCLM/MDLM parameters of the current chroma block derived according to method 2 of the embodiment described above.

Referring to FIG. 24A, the encoding apparatus/decoding apparatus may calculate a CCLM/MDLM parameter for the current block (S2400). For example, the CCLM/MDLM parameter may be calculated as the embodiment shown in FIG. 24B.

FIG. 24B may illustrate a specific embodiment of calculating the CCLM/MDLM parameter. For example, referring to FIG. 24B, the encoding apparatus/decoding apparatus may set N of the current block in consideration of the shape of the block and the CCLM/MDLM mode (S2405).

The encoding apparatus/decoding apparatus may determine whether or not N is 2 (N==2) (S2410).

In the case where the N is 2, the encoding apparatus/decoding apparatus may select two samples in a reference line adjacent to the current block (S2415). Here, the Nₜₕ may be 1 (Nth=1). Thereafter, the encoding apparatus/decoding apparatus may derive parameters α and β for the CCLM/MDLM prediction based on the selected samples (S2420).

Alternatively, in the case where the N is not 2, the encoding apparatus/decoding apparatus may select four samples in a reference line adjacent to the current block (S2425). Here, the Nₜₕ may be 2 (Nₜₕ=2). Thereafter, the encoding apparatus/decoding apparatus may derive parameters α and β for the CCLM/MDLM prediction based on the selected samples (S2420).

Referring back to FIG. 24A, in the case where the parameters for CCLM/MDLM prediction for the current chroma block are calculated, the encoding apparatus/decoding apparatus may perform CCLM/MDLM prediction based on the parameters and generate a prediction sample for the current chroma block (S2430). For example, the encoding apparatus/decoding apparatus may generate a prediction sample for the current chroma block based on above Equation 1 in which the calculated parameters and reconstructed samples of the current luma block for the current chroma block are used.

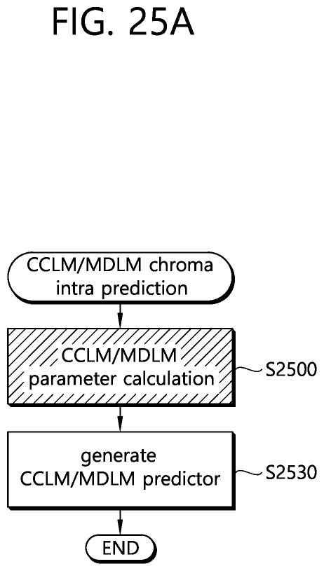

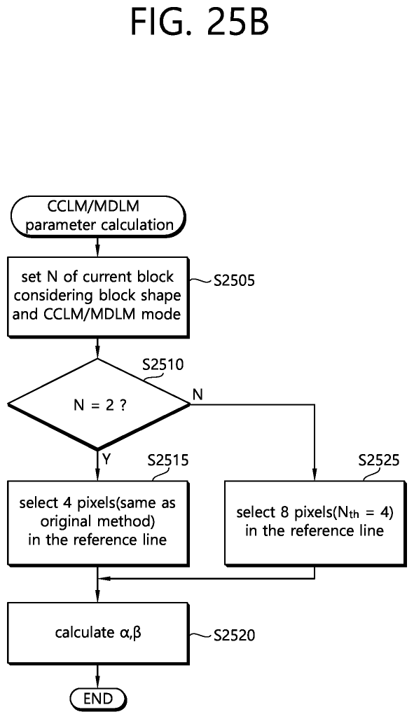

FIGS. 25A and 25B are diagrams for describing a process of performing CCLM/MDLM prediction based on the CCLM/MDLM parameters of the current chroma block derived according to method 3 of the embodiment described above.

Referring to FIG. 25A, the encoding apparatus/decoding apparatus may calculate a CCLM/MDLM parameter for the current block (S2500). For example, the CCLM/MDLM parameter may be calculated as the embodiment shown in FIG. 25B.

FIG. 25B may illustrate a specific embodiment of calculating the CCLM/MDLM parameter. For example, referring to FIG. 25B, the encoding apparatus/decoding apparatus may set N of the current block in consideration of the shape of the block and the CCLM/MDLM mode (S2505).

The encoding apparatus/decoding apparatus may determine whether or not N is 2 (N==2) (S2510).

In the case where the N is 2, the encoding apparatus/decoding apparatus may select four samples in a reference line adjacent to the current block (S2515). This may be the same as the existing method. Thereafter, the encoding apparatus/decoding apparatus may derive parameters α and β for the CCLM/MDLM prediction based on the selected samples (S2520).

Alternatively, in the case where the N is not 2, the encoding apparatus/decoding apparatus may select eight samples in a reference line adjacent to the current block (S2525). Here, the Nₜₕ may be 4 (Nₜₕ=4). Thereafter, the encoding apparatus/decoding apparatus may derive parameters α and β for the CCLM/MDLM prediction based on the selected samples (S2520).

Referring back to FIG. 25A, in the case where the parameters for CCLM/MDLM prediction for the current chroma block are calculated, the encoding apparatus/decoding apparatus may perform CCLM/MDLM prediction based on the parameters and generate a prediction sample for the current chroma block (S2530). For example, the encoding apparatus/decoding apparatus may generate a prediction sample for the current chroma block based on above Equation 1 in which the calculated parameters and reconstructed samples of the current luma block for the current chroma block are used.

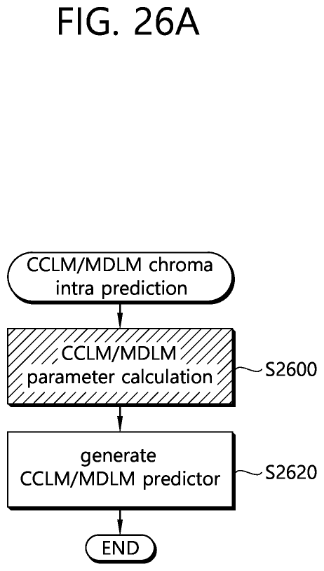

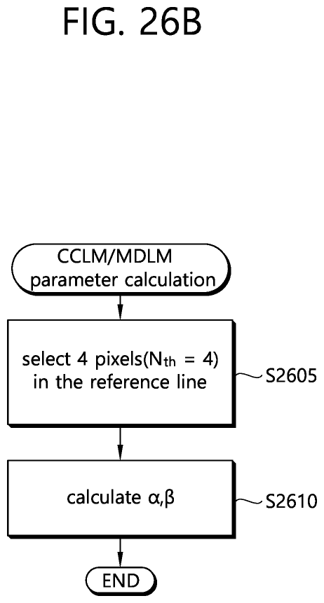

FIGS. 26A and 26B are diagrams for describing a process of performing CCLM/MDLM prediction based on the CCLM/MDLM parameters of the current chroma block derived according to method 4 of the embodiment described above.

Referring to FIG. 26A, the encoding apparatus/decoding apparatus may calculate a CCLM/MDLM parameter for the current block (S2600). For example, the CCLM/MDLM parameter may be calculated as the embodiment shown in FIG. 26B.

FIG. 26B may illustrate a specific embodiment of calculating the CCLM/MDLM parameter. For example, referring to FIG. 26B, the encoding apparatus/decoding apparatus may select four samples in a reference line adjacent to the current block (S2605). Here, the Nₜₕ may be 4 (Nₜₕ=4). Thereafter, the encoding apparatus/decoding apparatus may derive parameters α and β for the CCLM/MDLM prediction based on the selected samples (S2610).

Referring back to FIG. 26A, in the case where the parameters for CCLM/MDLM prediction for the current chroma block are calculated, the encoding apparatus/decoding apparatus may perform CCLM/MDLM prediction based on the parameters and generate a prediction sample for the current chroma block (S2620). For example, the encoding apparatus/decoding apparatus may generate a prediction sample for the current chroma block based on above Equation 1 in which the calculated parameters and reconstructed samples of the current luma block for the current chroma block are used.

Meanwhile, in this document, an embodiment different from the above-described embodiment may be proposed for reducing the computational complexity of deriving the CCLM parameter in deriving the CCLM parameter.

For example, for parameter calculation in CCLM, MDLM, MMLM or MM-MDLM, samples may be selected as follows. Here, multi model LM (MMLM) or multi model (MM)-MDLM may indicate a mode which uses two linear models for chroma sample prediction from a luma sample.

In CCLM, in the case of an N×N chroma block, a total of 2N (N horizontal, N vertical) block neighboring reference sample pairs are selected.

In CCLM, in the case of an N×M or M×N (N<=M) chroma block, a total of 2N (N horizontal, N vertical) neighboring reference sample pairs are selected. Since M is greater than N (e.g., M=2N or 3N), N samples are selected through subsampling from M samples.

In MDLM, in the case of an N×M chroma block, 2N top reference sample pairs are selected in LM_A mode.

In MDLM, in the case of an M×N chroma block, 2N left reference sample pairs are selected in LM_L mode.

In CCLM, in the case of an N×M or M×N (N<=M) chroma block, a total of 2N (N horizontal, N vertical) neighboring reference sample pairs are selected. Since M is greater than N (e.g., M=2N or 3N), N samples are selected through subsampling from M samples.

In MM-MDLM, in the case of an N×M chroma block, 2N top reference sample pairs are selected in MMLM_A mode.

In MM-MDLM, in the case of an M×N chroma block, 2N left reference sample pairs are selected in MMLM_L mode.

As described above, when CCLM parameters α and β are calculated through Equation 4 using 2N sample pairs, 4N comparison operations may be required for CCLM or MDLM.

In the case of MMLM or MM-MDLM, first, an addition operation for average value calculation and a comparison operation may be added using 2N sample pairs, and then, the maximum/minimum sample values are calculated through the comparison operation by dividing them into two groups based on the average value using the same 2N sample pairs, and then based on this, two pairs of CCLM parameters α and β may be calculated. Accordingly, in MMLM or MM-MDLM, 8N comparison operations, 2N+3 addition operations, 2 multiplication operations, and 2 bit shift operations may be required. That is, in the case of MMLM or MM-MDLM, compared to CCLM or MDLM, double number of comparison, additional addition, and multiplication operations may be required.

In the case of a 4×4 chroma block, 16 comparison operations are required to calculate the CCLM parameter, and in the case of a 32×32 chroma block, 128 comparison operations are required. In the case of MMLM, double number of comparison operations is required, and addition, multiplication, and bit shift operations are added. That is, as the size of the chroma block increases, the operation amount required for CCLM parameter calculation increases rapidly, which may directly lead to a delay problem in hardware implementation. In particular, since the CCLM parameter should be obtained through calculation even in the decoding apparatus, it may lead to a delay problem and an increase in implementation cost in hardware implementation of the decoding apparatus.

In order to address the problem of increase in CCLM parameter operation amount by the increase in the chroma block size, this embodiment proposes a method of setting a sample selection top limit Nₜₕ adaptively. In the case of N=2, that is, in order to prevent a worst case operation (after all chroma blocks in the CTU are split into 2×2, CCLM prediction is performed on all blocks) occurring during CCLM prediction of a 2×2 chroma block, Nₜₕ can be adaptively set, thereby reducing the amount of comparison operation in the worst case by at least 50%.

To this end, the Nₜₕ may be set adaptively to the block size as follows.

Method 1 in this embodiment (proposed method 1)

In the current chroma block of size N×M or size M×N, Nth is set to N/2 (Nₜₕ=N/2)

Alternatively, for example, according to this embodiment, the Nₜₕ may be set adaptively to a block size as follows.

Method 2 in this embodiment (proposed method 2)

In the case of N=2 in the current chroma block of size N×M or size M×N, the Nₜₕ is set to 1 (Nₜₕ=1)

In the case of N=4 in the current chroma block of size N×M or size M×N, the Nₜₕ is set to 2 (Nₜₕ=2)

In the case of N>4 in the current chroma block of size N×M or size M×N, the Nₜₕ is set to 4 (Nₜₕ=4)

Alternatively, for example, according to this embodiment, the N^{th} may be set adaptively to a block size as follows.

Method 3 in this embodiment (proposed method 3)

In the case of N=2 in the current chroma block of size N×M or size M×N, the Nₜₕ is set to 1 (Nₜₕ=1)

In the case of N=4 in the current chroma block of size N×M or size M×N, the Nₜₕ is set to 2 (Nₜₕ=2)

In the case of N=8 in the current chroma block of size N×M or size M×N, the Nₜₕ is set to 4 (Nₜₕ=4)

In the case of N>8 in the current chroma block of size N×M or size M×N, the Nₜₕ is set to 8 (Nₜₕ=8)

Alternatively, for example, according to this embodiment, the N^{th} may be set adaptively to a block size as follows.

Method 4 in this embodiment (proposed method 4)

In the case of CCLM or MDLM mode, Nₜₕ of method 2 of this embodiment is applied

In the case of MMLM or MM-MDLM mode, Nₜₕ of method 3 of this embodiment is applied

Alternatively, for example, according to this embodiment, the Nₜₕ may be set adaptively to a block size as follows.

Method 5 in this embodiment (proposed method 5)

In the case of CCLM or MDLM mode, Nₜₕ of method 2 of this embodiment is applied

In the case of MMLM or MM-MDLM mode, Nₜₕ of method 1 of this embodiment is applied

In the above-mentioned methods, when N=2, the total number of samples for CCLM parameter calculation means 4 (2N), and Nth=1 means that only two (2Nth) are used for CCLM parameter calculation. Additionally, when N=4, the total number of samples for CCLM parameter calculation means 8 (2N), and Nth=2 means that only four (2Nth) are used for CCLM parameter calculation.

In method 1 of this embodiment, since the parameters α and β are always calculated using half of the samples in all block sizes, the operation amount for parameter calculation can be reduced by half.

In method 2 of this embodiment, when using 4 samples (when using CCLM/MMLM mode in 2×N or N×2, when using LM_A/MMLM_A mode among MDLM/MM-MDLM modes in 2×N, or when using LM_L/MMLM_L mode among MDLM/MM-MDLM mode in N×2), the comparison operation in the worst case can be reduced to half by using half of the samples. Additionally, even when using 8 samples (when using CCLM/MMLM mode in 4×N or N×4, when using LM_A/MMLM_A mode among MDLM/MM-MDLM mode in 4×N, or when using LM_L/MMLM_L mode among MDLM/MM-MDLM mode in N×4), the comparison operation amount can be greatly reduced by using half of the samples, and even when using more than that, CCLM parameter operation can be performed using only up to 8 samples.

In method 3 of this embodiment, similar to said method 2, when 4/8/16 samples are used, CCLM parameter operation can be performed using only half (2/4/8 samples), and even when using more than that, CCLM parameter operation can be performed using only up to 16 samples.

Method 4 of this embodiment is a combination of said method 2 and said method 3, and Nₜₕ may be applied separately to the cases of LM and MMLM. That is, in the case of CCLM or MDLM mode, Nₜₕ of said method 2 may be applied, and in the case of MMLM or MM-MDLM, Nₜₕ of said method 3 may be applied. That is, in method 4, by applying more samples to MMLM or MM-MDLM requiring higher accuracy for parameter calculation, it is possible to minimize the coding loss caused by a decrease in the number of samples.

Similar to said method 4, method 5 of this embodiment is a combination of said method 1 and said method 2, and Nₜₕ may be applied separately to the cases of LM and MMLM.

Above-described methods 1 to 5 of this embodiment can reduce the amount of worst case comparison operation in the case of N=2 by 50%, and since Nₜₕ can be applied adaptively to each chroma block size, the coding loss can be minimized. As described above, by setting Nₜₕ adaptively to the block size, the number of samples optimized for the block size can be selected.

In addition, methods 1 to 5 of this embodiment can be applied simultaneously together with the subsampling method of the embodiment proposed in FIG. 22 described above.

After setting the Nth, the CCLM parameter may be calculated by selecting the chroma block neighboring sample as in the above-described embodiment proposed in FIG. 9.

For example, Table 36 may represent the number of samples for the CCLM parameter calculation according to the chroma block size in the CCLM mode or the MDLM mode when the above-described methods are applied.

TABLE 36

| | Number of reference pixels for CCLM parameter calculation | | | | | |
|---|---|---|---|---|---|---|
| Block | CCLM/ | Proposed | Proposed | Proposed | Proposed | Proposed |
| size | MDLM | method 1 | method 2 | method 3 | method 4 | method 5 |
| N = 2 | 4 | 2 | 2 | 2 | 2 | 2 |
| N = 4 | 8 | 4 | 4 | 4 | 4 | 4 |
| N = 8 | 16 | 8 | 8 | 8 | 8 | 8 |
| N = 16 | 32 | 16 | 8 | 16 | 8 | 8 |
| N = 32 | 64 | 32 | 8 | 16 | 8 | 8 |

For example, Table 37 may represent the number of samples for the CCLM parameter calculation according to the chroma block size in the MMLM mode or the MM-MDLM mode when the above-described methods are applied.

TABLE 37

| | Number of reference pixels for CCLM parameter calculation | | | | | |
|---|---|---|---|---|---|---|
| Block | MMLM/ | Proposed | Proposed | Proposed | Proposed | Proposed |
| size | MM-MDLM | method 1 | method 2 | method 3 | method 4 | method 5 |
| N = 2 | 4 | 2 | 2 | 2 | 2 | 2 |
| N = 4 | 8 | 4 | 4 | 4 | 4 | 4 |
| N = 8 | 16 | 8 | 8 | 8 | 8 | 8 |
| N = 16 | 32 | 16 | 8 | 16 | 16 | 16 |
| N = 32 | 64 | 32 | 8 | 16 | 16 | 32 |

Meanwhile, according to this embodiment, without the need to transmit additional information, a promised value may be used in the encoding apparatus and the decoding apparatus, or information indicating whether or not the proposed method is used and the value may be transmitted in units of CUs, slices, pictures, and sequences.

For example, in the case where information indicating whether or not the proposed method is used is transmitted in units of CUs, when the intra prediction mode of the current chroma block is the CCLM mode (i.e., when CCLM prediction is applied to the current chroma block), the cclm_reduced_sample_flag syntax element is parsed as follows, so that the above-described embodiment may be performed. The cclm_reduced_sample_flag syntax element may indicate a syntax element of a CCLM reduced sample flag.

When the value of the cclm_reduced_sample_flag syntax element is 0 (false), the Nₜₕ is set to 4 for all the blocks, and CCLM parameter calculation is performed through the neighboring sample selection method of the above-described embodiment proposed in FIG. 9

When the value of the cclm_reduced_sample_flag syntax element is 1 (true), CCLM parameter calculation is performed through method 3 of this embodiment described above

Alternatively, when information indicating a method to be applied is transmitted in units of slices, pictures, or sequences, a method to be applied may be selected from among the above-described methods 1 to 5 based on the information transmitted through high level syntax (HLS) as described later, and the CCLM parameter may be calculated based on the selected method.

For example, the information indicating the method to be applied signaled through a slice header may be represented as in the following Table.

TABLE 38

| | Descriptor |
|---|---|
| slice_header( ) { | |
| ... | |
| cclm_reduced_sample_threshold | f(2) |
| ... | |

cclm_reduced_sample_threshold may represent a syntax element of information indicating the method to be applied.

Alternatively, for example, the information indicating the method to be applied signaled through a Picture Parameter Set (PPS) may be represented as in the following table.

TABLE 39

| | Descriptor |
|---|---|
| pic_parameter_set_rbsp( ) { | |
| ... | |
| cclm_reduced_sample_threshold | f(2) |
| ... | |

Alternatively, for example, the information indicating the method to be applied signaled through a Sequence Parameter Set (SPS) may be represented as in the following table.

TABLE 40

| | Descriptor |
|---|---|
| seq_parameter_set_rbsp( ) { | |
| ... | |
| cclm_reduced_sample_threshold | f(2) |
| ... | |

The method selected based on the value of the cclm_reduced_sample_threshold transmitted through the slice header, the PPS or the SPS (i.e., a value derived by decoding cclm_reduced_sample_threshold) may be derived as shown in the following table.

TABLE 41

| cclm_reduced_sample_threshold | Proposed method |
|---|---|
| 0 | 1 |
| 1 | 2 |
| 2 | 3 |
| 3 | 4 |
| 4 | 5 |

Referring to Table 41, when the value of the cclm_reduced_sample_threshold syntax element is 0, the method applied to the current chroma block may be selected as said method 1; when the value of the cclm_reduced_sample_threshold syntax element is 1, the method applied to the current chroma block may be selected as said method 2; when the value of the cclm_reduced_sample_threshold syntax element is 2, the method applied to the current chroma block may be selected as said method 3; when the value of the cclm_reduced_sample_threshold syntax element is 3, the method applied to the current chroma block may be selected as said method 4; and when the value of the cclm_reduced_sample_threshold syntax element is 4, the method applied to the current chroma block may be selected as said method 5.

The method proposed in this embodiment may be used for a CCLM mode which is an intra-prediction mode for a chroma component, and the chroma block predicted through the CCLM mode may be used to derive a residual image through a difference from an original image in the encoding apparatus or used to derive reconstructed image through an addition with a residual signal in the decoding apparatus.

Meanwhile, when information indicating one of the methods is transmitted in units of CUs, slices, pictures and sequences, the encoding apparatus may determine one of the methods 1 to 5, and then transmit the information to the decoding apparatus as follows.

In the case where information indicating whether or not the method of the above-described embodiment is used is transmitted in units of CUs, when the intra prediction mode of the current chroma block is the CCLM mode (that is, when CCLM prediction is applied to the current chroma block), the encoding apparatus may determine which of the following two cases has better encoding efficiency through the RDO, and may transmit information about the determined method to the decoding apparatus.

1) When the Nₜₕ is set to 4 for all blocks, and it has a good encoding efficiency to perform CCLM parameter calculation through the neighboring sample section method of the above-described embodiment proposed in FIG. 9, a cclm_reduced_sample_flag syntax element with a value of 0 (false) is transmitted

2) When it is set that said method 3 is applied and it has a good encoding efficiency to perform CCLM parameter calculation through the neighboring sample selection method proposed in the above-described embodiment, a cclm_reduced_sample_flag syntax element with a value of 1 (true) is transmitted

Alternatively, in the case where the information indicating whether or not the method of the embodiment described above is applied is transmitted in units of slices, pictures or sequences, the encoding apparatus may add a high level syntax (HLS) as represented in Table 38, 39 or 40 described above, and transmit the information representing one method of said methods. Alternatively, information indicating one of the methods may be included in the HLS as shown in Table 38, 39, or 40 described above. For example, the information indicating one of the methods may include a cclm_reduced_sample_threshold syntax element, and the value of the cclm_reduced_sample_threshold syntax element may be derived based on Table 41. The encoding apparatus may set a method to be applied from among said methods in consideration of the size of the input image or in accordance with an encoding target bitrate.

1) For example, when the input image is HD or higher, the encoding apparatus may apply said method 2, and when the input image is HD or lower, it may apply said method 3.

2) When high quality image encoding is required, the encoding apparatus may apply said method 1, and when low quality image encoding is required, it may apply said method 2.

The method proposed in this embodiment may be used for a CCLM mode which is an intra-prediction mode for a chroma component, and the chroma block predicted through the CCLM mode may be used to derive a residual image through a difference from an original image in the encoding apparatus or used to derive reconstructed image through an addition with a residual signal in the decoding apparatus.

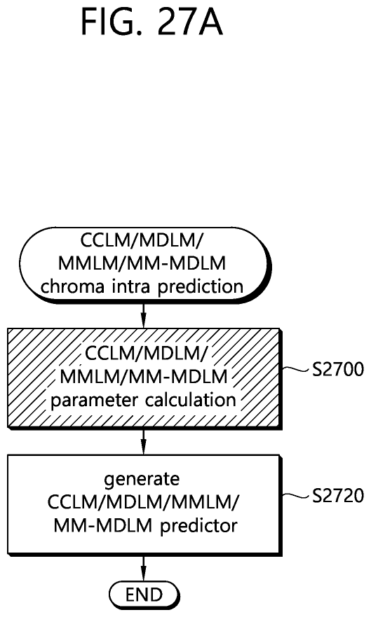

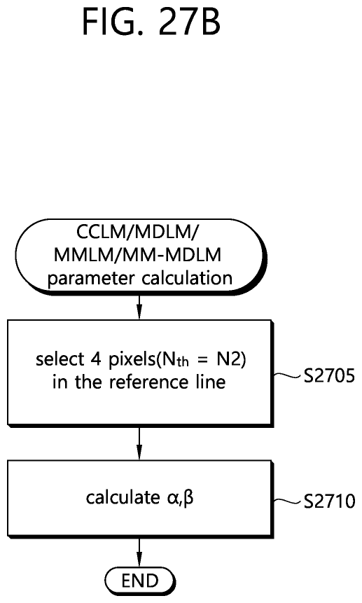

FIGS. 27A and 27B are diagrams for describing a process of performing CCLM/MDLM/MMLM/MM-MDLM prediction based on the CCLM/MDLM/MMLM/MM-MDLM parameters of the current chroma block derived according to method 1 of the embodiment described above.

Referring to FIG. 27A, the encoding apparatus/decoding apparatus may calculate a CCLM/MDLM/MMLM/MM-MDLM parameter for the current block (S2700). For example, the CCLM/MDLM/MMLM/MM-MDLM parameter may be calculated as the embodiment shown in FIG. 27B.

FIG. 27B may illustrate a specific embodiment of calculating the CCLM/MDLM/MMLM/MM-MDLM parameter. For example, referring to FIG. 27B, the encoding apparatus/decoding apparatus may select N samples in a reference line adjacent to the current block (S2705). Here, the Nₜₕ may be N/2 (Nth=N/2). Thereafter, the encoding apparatus/decoding apparatus may derive parameters α and β for the CCLM/MDLM/MMLM/MM-MDLM prediction based on the selected samples (S2710).

Referring back to FIG. 27A, in the case where the parameters for CCLM/MDLM/MMLM/MM-MDLM prediction for the current chroma block are calculated, the encoding apparatus/decoding apparatus may perform CCLM/MDLM/MMLM/MM-MDLM prediction based on the parameters and generate a prediction sample for the current chroma block (S2720). For example, the encoding apparatus/decoding apparatus may generate a prediction sample for the current chroma block based on above Equation 1 in which the calculated parameters and reconstructed samples of the current luma block for the current chroma block are used.

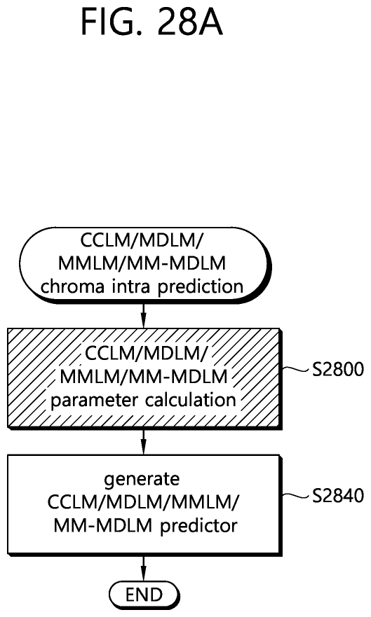

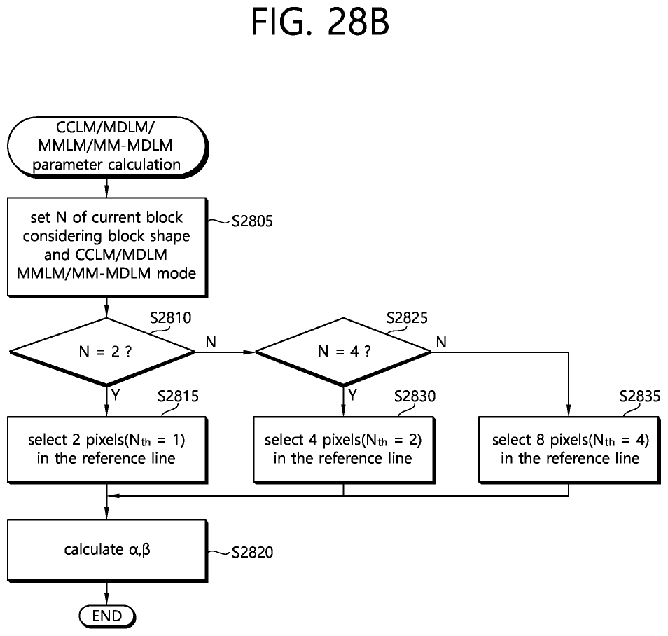

FIGS. 28A and 28B are diagrams for describing a process of performing CCLM/MDLM/MMLM/MM-MDLM prediction based on the CCLM/MDLM/MMLM/MM-MDLM parameters of the current chroma block derived according to method 2 of the embodiment described above.

Referring to FIG. 28A, the encoding apparatus/decoding apparatus may calculate a CCLM/MDLM/MMLM/MM-MDLM parameter for the current block (S2800). For example, the CCLM/MDLM/MMLM/MM-MDLM parameter may be calculated as the embodiment shown in FIG. 28B.

FIG. 28B may illustrate a specific embodiment of calculating the CCLM/MDLM/MMLM/MM-MDLM parameter. For example, referring to FIG. 28B, the encoding apparatus/decoding apparatus may set N of the current block in consideration of the shape of the block and the CCLM/MDLM/MMLM/MM-MDLM mode (S2805).

The encoding apparatus/decoding apparatus may determine whether or not N is 2 (N==2) (S2810).

In the case where the N is 2, the encoding apparatus/decoding apparatus may select two samples in a reference line adjacent to the current block (S2815). Here, the Nₜₕ may be 1 (Nth=1). Thereafter, the encoding apparatus/decoding apparatus may derive parameters α and β for the CCLM/MDLM/MMLM/MM-MDLM prediction based on the selected samples (S2820).

Alternatively, in the case where the N is not 2, the encoding apparatus/decoding apparatus may determine whether or not the N is 4 (N==4) (S2825).

In the case where the N is 4, the encoding apparatus/decoding apparatus may select four samples in a reference line adjacent to the current block (S2830). Here, the Nₜₕ may be 2 (Nₜₕ=2). Thereafter, the encoding apparatus/decoding apparatus may derive parameters α and β for the CCLM/MDLM/MMLM/MM-MDLM prediction based on the selected samples (S2820).

Alternatively, in the case where the N is not 4, the encoding apparatus/decoding apparatus may select eight samples in a reference line adjacent to the current block (S2830). Here, the Nₜₕ may be 4 (Nₜₕ=4). Thereafter, the encoding apparatus/decoding apparatus may derive parameters α and β for the CCLM/MDLM/MMLM/MM-MDLM prediction based on the selected samples (S2820).

Referring back to FIG. 28A, in the case where the parameters for CCLM/MDLM/MMLM/MM-MDLM prediction for the current chroma block are calculated, the encoding apparatus/decoding apparatus may perform CCLM/MDLM/MMLM/MM-MDLM prediction based on the parameters and generate a prediction sample for the current chroma block (S2840). For example, the encoding apparatus/decoding apparatus may generate a prediction sample for the current chroma block based on above Equation 1 in which the calculated parameters and reconstructed samples of the current luma block for the current chroma block are used.

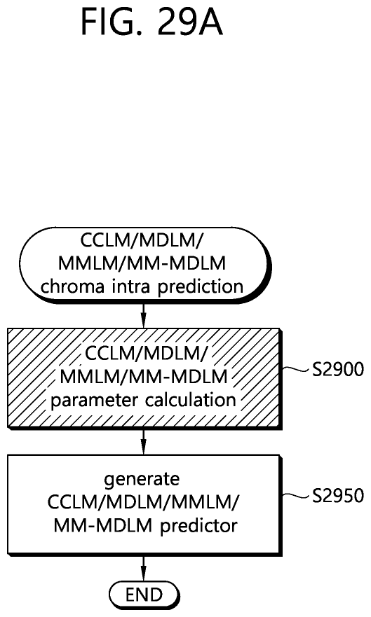

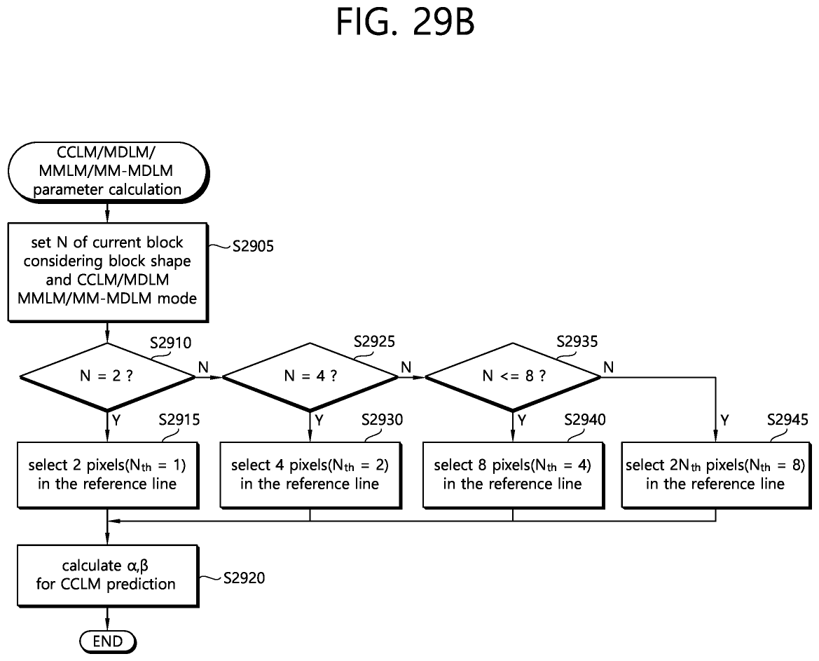

FIGS. 29A and 29B are diagrams for describing a process of performing CCLM/MDLM/MMLM/MM-MDLM prediction based on the CCLM/MDLM/MMLM/MM-MDLM parameters of the current chroma block derived according to method 3 of the embodiment described above.

Referring to FIG. 29A, the encoding apparatus/decoding apparatus may calculate a CCLM/MDLM/MMLM/MM-MDLM parameter for the current block (S2900). For example, the CCLM/MDLM/MMLM/MM-MDLM parameter may be calculated as the embodiment shown in FIG. 29B.

FIG. 29B may illustrate a specific embodiment of calculating the CCLM/MDLM/MMLM/MM-MDLM parameter. For example, referring to FIG. 29B, the encoding apparatus/decoding apparatus may set N of the current block in consideration of the shape of the block and the CCLM/MDLM/MMLM/MM-MDLM mode (S2905).

The encoding apparatus/decoding apparatus may determine whether or not N is 2 (N==2) (S2910).

In the case where the N is 2, the encoding apparatus/decoding apparatus may select two samples in a reference line adjacent to the current block (S2915). Here, the Nₜₕ may be 1 (Nth=1). Thereafter, the encoding apparatus/decoding apparatus may derive parameters α and β for the CCLM/MDLM/MMLM/MM-MDLM prediction based on the selected samples (S2920).

Alternatively, in the case where the N is not 2, the encoding apparatus/decoding apparatus may determine whether or not the N is 4 (N==4) (S2925).

In the case where the N is 4, the encoding apparatus/decoding apparatus may select four samples in a reference line adjacent to the current block (S2930). Here, the Nₜₕ may be 2 (Nₜₕ=2). Thereafter, the encoding apparatus/decoding apparatus may derive parameters α and β for the CCLM/MDLM/MMLM/MM-MDLM prediction based on the selected samples (S2920).

Alternatively, in the case where the N is not 4, the encoding apparatus/decoding apparatus may determine whether or not the N is less than or equal to 8 (N<=8) (S2935).

In the case where the N is less than or equal to 8, the encoding apparatus/decoding apparatus may select eight samples in a reference line adjacent to the current block (S2940). Here, the Nₜₕ may be 4 (Nₜₕ=4). Thereafter, the encoding apparatus/decoding apparatus may derive parameters α and β for the CCLM/MDLM/MMLM/MM-MDLM prediction based on the selected samples (S2920).

Alternatively, in the case where the N is not less than or equal to 8, the encoding apparatus/decoding apparatus may select 2 Nₜₕ samples in a reference line adjacent to the current block (S2945). Here, Nₜₕ may be 8 (Nₜₕ=8). Thereafter, the encoding apparatus/decoding apparatus may derive parameters α and β for the CCLM/MDLM/MMLM/MM-MDLM prediction based on the selected samples (S2920).

Referring back to FIG. 29A, in the case where the parameters for CCLM/MDLM/MMLM/MM-MDLM prediction for the current chroma block are calculated, the encoding apparatus/decoding apparatus may perform CCLM/MDLM/MMLM/MM-MDLM prediction based on the parameters and generate a prediction sample for the current chroma block (S2950). For example, the encoding apparatus/decoding apparatus may generate a prediction sample for the current chroma block based on above Equation 1 in which the calculated parameters and reconstructed samples of the current luma block for the current chroma block are used.

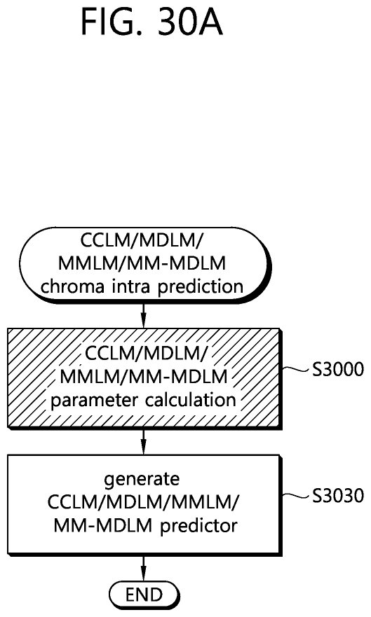

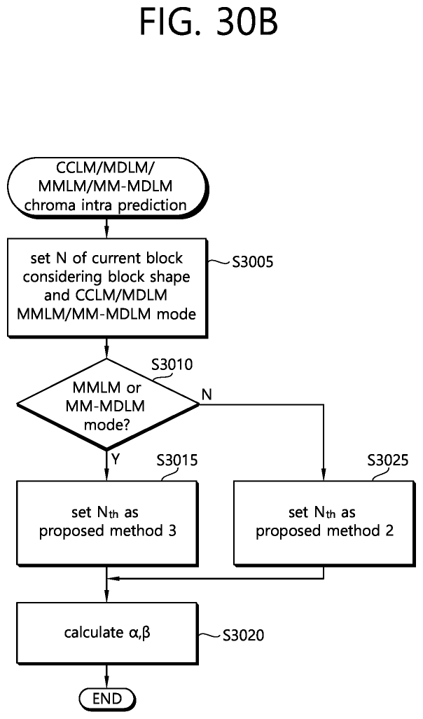

FIGS. 30A and 30B are diagrams for describing a process of performing CCLM/MDLM/MMLM/MM-MDLM prediction based on the CCLM/MDLM/MMLM/MM-MDLM parameters of the current chroma block derived according to method 4 of the embodiment described above.

Referring to FIG. 30A, the encoding apparatus/decoding apparatus may calculate a CCLM/MDLM/MMLM/MM-MDLM parameter for the current block (S3000). For example, the CCLM/MDLM/MMLM/MM-MDLM parameter may be calculated as the embodiment shown in FIG. 30B.

FIG. 30B may illustrate a specific embodiment of calculating the CCLM/MDLM/MMLM/MM-MDLM parameter. For example, referring to FIG. 30B, the encoding apparatus/decoding apparatus may set N of the current block in consideration of the shape of the block and the CCLM/MDLM/MMLM/MM-MDLM mode (S3005).

The encoding apparatus/decoding apparatus may determine whether the mode applied to the current block is the MMLM mode or the MM-MDLM mode (S3010).

When the mode applied to the current block is the MMLM mode or the MM-MDLM mode, the encoding apparatus/decoding apparatus may set Nth according to method 3 of the embodiment proposed in FIG. 29 (S3015). Thereafter, the encoding apparatus/decoding apparatus may derive parameters α and β for the CCLM/MDLM/MMLM/MM-MDLM prediction based on the selected samples (S3020).

Alternatively, when the mode applied to the current block is not the MMLM mode nor the MM-MDLM mode, the encoding apparatus/decoding apparatus may set Nₜₕ according to method 2 of the embodiment proposed in FIG. 28 (S3025). Thereafter, the encoding apparatus/decoding apparatus may derive parameters α and β for the CCLM/MDLM/MMLM/MM-MDLM prediction based on the selected samples (S3020).

Referring back to FIG. 30A, in the case where the parameters for CCLM/MDLM/MMLM/MM-MDLM prediction for the current chroma block are calculated, the encoding apparatus/decoding apparatus may perform CCLM/MDLM/MMLM/MM-MDLM prediction based on the parameters and generate a prediction sample for the current chroma block (S3030). For example, the encoding apparatus/decoding apparatus may generate a prediction sample for the current chroma block based on above Equation 1 in which the calculated parameters and reconstructed samples of the current luma block for the current chroma block are used.

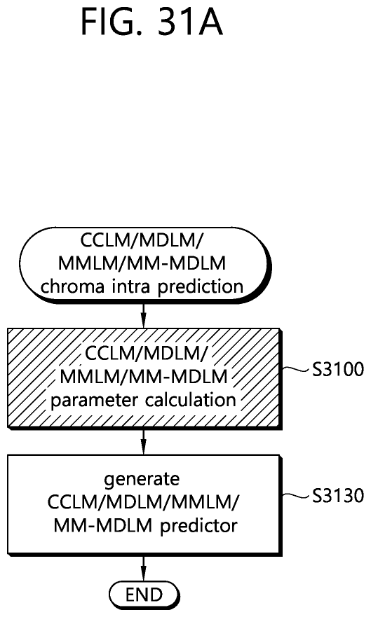

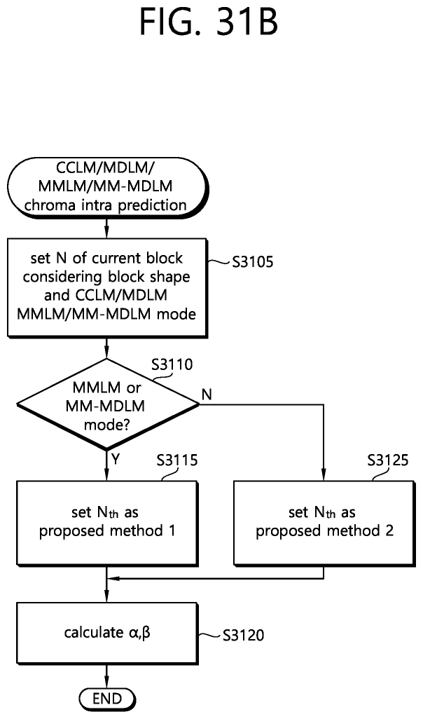

FIGS. 31A and 31B are diagrams for describing a process of performing CCLM/MDLM/MMLM/MM-MDLM prediction based on the CCLM/MDLM/MMLM/MM-MDLM parameters of the current chroma block derived according to method 5 of the embodiment described above.

Referring to FIG. 31A, the encoding apparatus/decoding apparatus may calculate a CCLM/MDLM/MMLM/MM-MDLM parameter for the current block (S3100). For example, the CCLM/MDLM/MMLM/MM-MDLM parameter may be calculated as the embodiment shown in FIG. 31B.

FIG. 31B may illustrate a specific embodiment of calculating the CCLM/MDLM/MMLM/MM-MDLM parameter. For example, referring to FIG. 31B, the encoding apparatus/decoding apparatus may set N of the current block in consideration of the shape of the block and the CCLM/MDLM/MMLM/MM-MDLM mode (S3105).

The encoding apparatus/decoding apparatus may determine whether the mode applied to the current block is the MMLM mode or the MM-MDLM mode (S3110).

When the mode applied to the current block is the MMLM mode or the MM-MDLM mode, the encoding apparatus/decoding apparatus may set Nth according to method 1 of the embodiment proposed in FIG. 27 (S3115). Thereafter, the encoding apparatus/decoding apparatus may derive parameters α and β for the CCLM/MDLM/MMLM/MM-MDLM prediction based on the selected samples (S3120).

Alternatively, when the mode applied to the current block is not the MMLM mode nor the MM-MDLM mode, the encoding apparatus/decoding apparatus may set Nₜₕ according to method 2 of the embodiment proposed in FIG. 28 (S3125). Thereafter, the encoding apparatus/decoding apparatus may derive parameters α and β for the CCLM/MDLM/MMLM/MM-MDLM prediction based on the selected samples (S3120).

Referring back to FIG. 31A, in the case where the parameters for CCLM/MDLM/MMLM/MM-MDLM prediction for the current chroma block are calculated, the encoding apparatus/decoding apparatus may perform CCLM/MDLM/MMLM/MM-MDLM prediction based on the parameters and generate a prediction sample for the current chroma block (S3130). For example, the encoding apparatus/decoding apparatus may generate a prediction sample for the current chroma block based on above Equation 1 in which the calculated parameters and reconstructed samples of the current luma block for the current chroma block are used.

Meanwhile, in this document, an embodiment different from the above-described embodiment may be proposed for reducing the computational complexity of deriving the CCLM parameter in deriving the CCLM parameter.

Specifically, in this embodiment, in order to alleviate the complexity of the existing CCLM parameter calculation, a method of adaptively selecting samples used for CCLM parameter calculation is proposed, and a method of selecting only luma samples to be adaptively selected and performing downsampling is proposed.

Referring back to FIG. 5, in this embodiment, when performing CCLM prediction between a 4×4 chroma block and a corresponding 8×8 luma block, downsampling may be performed so that the 8×8 luma block reference sample can correspond to the 4×4 chroma block. Here, the downsampling may be performed at a ratio of 2:1, for example, using Equation 9.

Rec′_{L}(x,y)=(2×Rec_{L}(2x, 2y)+2×Rec_{L}(2x, 2y+1)+Rec_{L}(2x−1,2y)+Rec_{L}(2x+1,2y)+Rec_{L}(2x−1,2y+1)+Rec_{L}(2x+1,2y+1)+4)>>3 [Equation 9]

In Equation 9, Rec′L(x, y) may denote the result value of downsampling, and Rec_{L} (2x, 2y) may denote the location of the luma sample corresponding to the sample location (x, y) of the chroma block. That is, 6-tap downsampling is performed between all luma block reference samples, which may cause an increase in computational complexity in the decoder.

In the above-described embodiments of this document, luma samples not used for CCLM operation may be generated when adaptively selecting samples for CCLM parameter calculation. Therefore, this embodiment may propose to skip downsampling of luma samples that are not used for CCLM parameter calculation when downsampling the luma block. Alternatively, this embodiment may propose not to perform downsampling of luma samples that are not used for CCLM parameter calculation when downsampling the luma block. Thereby, this embodiment can reduce operations which take place during downsampling.

In this embodiment, in the case where half of the samples are used when calculating the CCLM parameter as in method 1 proposed in FIG. 27, downsampling may be performed, for example, as in Equation 10 or 11.

Rec′_{L}(x,y)=(2×Rec_{L}(4x, 2y)+2×Rec_{L}(4x, 2y+1)+Rec_{L}(4x−1,2y)+Rec_{L}(4x+1,2y)+Rec_{L}(4x−1,2y+1)+Rec_{L}(4x+1,2y+1)+Rec_{L}(4x+1,2y+1)>>3 [Equation 10]

Rec′_{L}(x,y)=(2×Rec_{L}(2x, 4y)+2×Rec_{L}(2x, 4y+1)+Rec_{L}(2x−1,4y)+Rec_{L}(2x+1,4y)+Rec_{L}(2x−1,4y+1)+Rec_{L}(2x+1,4y+1)+4)>>3 [Equation 11]

For example, Equation 10 may be used for downsampling of the top neighboring reference sample of the luma block, and Equation 11 may be used for downsampling of the left neighboring reference sample of the luma block. Additionally, in Equations 10 and 11, Rec′L(x, y) may denote the result value of downsampling; Rec_{L}(2x, 2y) may denote the location of the luma sample corresponding to the sample location (x, y) of the chroma block; and >> may denote a bit shift operator.

Also, in this embodiment, when using a method for changing positions of downsampled samples, such as the above-described subsampling method proposed in FIG. 22, downsampling may be performed, for example, as in Equation 12 or 13.

Rec′_{L}(x,y)=(2×Rec_{L}(4x+1,2y)+2×Rec_{L}(4x+1,2y+1)+Rec_{L}(4x, 2y)+Rec_{L}(4x+2,2y)+Rec_{L}(4x, 2y+1)+Rec_{L}(4x+2,2y+1)+4)>>3 [Equation 12]

Rec′_{L}(x, y)=(2×Rec_{L}(2x, 4y+1)+2×Rec_{L}(2x, 4y+2)+Rec_{L}(2x−1,4y+1)+Rec_{L}(2x+1,4y+1)+Rec_{L}(2x−1,4y+2)+Rec_{L}(2x+1,4y+2)+4)>>3 [Equation 13]

For example, Equation 12 may be used for downsampling of the top neighboring reference sample of the luma block, and Equation 13 may be used for downsampling of the left neighboring reference sample of the luma block. Additionally, in Equations 12 and 13, Rec′L(x, y) may denote the result value of downsampling; Rec_{L} (2x, 2y) may denote the location of the luma sample corresponding to the sample location (x, y) of the chroma block; and >> may denote a bit shift operator.

In the above equations, since the number of times of downsampling is reduced by half, the (x, y) value can use only up to half the size of the current chroma block. That is, since half of the samples are used, the amount of downsampling operation is reduced by half, and the storage buffer of the downsampled luma component for CCLM calculation can also be reduced by half, thereby obtaining a memory reduction effect.

In addition, when CCLM parameter calculation is performed using four fixed samples as in the case of TH=2 in the method proposed in FIG. 9, the downsampling complexity is reduced to up to one sixtee Nₜₕ (in the case of a 32×32 chroma block), and the storage buffer of the downsampled luma component for this also stores only 4 samples. Therefore, only one sixtee Nₜₕ of buffer is required compared to storing the existing 64 samples, thereby greatly reducing the required memory.

In addition, when using said method 3 proposed in FIG. 29, or performing CCLM parameter calculation using half the samples as in the case of TH=4 in the method proposed in FIG. 10 and using up to 8 samples, the downsampling complexity is reduced to at least half and up to one sixtee Nₜₕ (in the case of a 32×32 chroma block), and the storage buffer of the downsampled luma component for this also stores only 8 samples. Therefore, only one eighth of buffer is required compared to storing the existing 64 samples, thereby greatly reducing the required memory.

The method proposed in this embodiment may be used in combination with the above-described methods proposed in FIGS. 10 to 31.

Meanwhile, according to this embodiment, without the need to transmit additional information, a promised value may be used in the encoding apparatus and the decoding apparatus, or information indicating whether or not the proposed method is used and the value may be transmitted in units of CUs, slices, pictures, and sequences. In this document, a slice/slice header may be replaced with a tile/tile header or a tile group/tile group header.

For example, in the case where information indicating whether or not the proposed method is used is transmitted in units of CUs, when the intra prediction mode of the current chroma block is the CCLM mode (i.e., when CCLM prediction is applied to the current chroma block), the cclm_reduced_sample_flag syntax element is parsed as follows, so that the above-described embodiment may be performed. The cclm_reduced_sample_flag syntax element may indicate a syntax element of a CCLM reduced sample flag.

When the value of the cclm_reduced_sample_flag syntax element is 0 (false), the Nₜₕ is set to 4 for all the blocks, and CCLM parameter calculation is performed through the neighboring sample selection method of the above-described embodiment proposed in FIG. 9

When the value of the cclm_reduced_sample_flag syntax element is 1 (true), CCLM parameter calculation is performed through method 3 proposed in FIG. 29 of this embodiment described above

Alternatively, when information indicating a method to be applied is transmitted in units of slices, pictures, or sequences, a method to be applied may be selected from among the above-described methods 1 to 5 proposed in FIGS. 27 to 31 based on the information transmitted through high level syntax (HLS) as described later, and the CCLM parameter may be calculated based on the selected method. That is, luma block downsampling may be performed based on the selected method, and the CCLM parameter may be calculated based on the luma sample derived through the downsampling.

For example, the information indicating the method to be applied signaled through a slice header may be represented as in the following Table.

TABLE 42

| | Descriptor |
|---|---|
| slice_header( ) { | |
| ... | |
| cclm_reduced_sample_threshold | f(2) |
| ... | |

cclm_reduced_sample_threshold may represent a syntax element of information indicating the method to be applied.

Alternatively, for example, the information indicating the method to be applied signaled through a Picture Parameter Set (PPS) may be represented as in the following table.

TABLE 43

| | Descriptor |
|---|---|
| pic_parameter_set_rbsp( ) { | |
| ... | |
| cclm_reduced_sample_threshold | f(2) |
| ... | |

Alternatively, for example, the information indicating the method to be applied signaled through a Sequence Parameter Set (SPS) may be represented as in the following table.

TABLE 44

| | Descriptor |
|---|---|
| seq_parameter_set_rbsp( ) { | |
| ... | |
| cclm_reduced_sample_threshold | f(2) |
| ... | |

The method selected based on the value of the cclm_reduced_sample_threshold transmitted through the slice header, the PPS or the SPS (i.e., a value derived by decoding cclm_reduced_sample_threshold) may be derived as shown in the following table.

TABLE 45

| cclm_reduced_sample_threshold | Proposed method |
|---|---|
| 0 | 1 |
| 1 | 2 |
| 2 | 3 |
| 3 | 4 |
| 4 | 5 |

Referring to Table 45, when the value of the cclm_reduced_sample_threshold syntax element is 0, the method applied to the current chroma block may be selected as said method 1 proposed in FIG. 27; when the value of the cclm_reduced_sample_threshold syntax element is 1, the method applied to the current chroma block may be selected as said method 2 proposed in FIG. 28; when the value of the cclm_reduced_sample_threshold syntax element is 2, the method applied to the current chroma block may be selected as said method 3 proposed in FIG. 29; when the value of the cclm_reduced_sample_threshold syntax element is 3, the method applied to the current chroma block may be selected as said method 4 proposed in FIG. 30; and when the value of the cclm_reduced_sample_threshold syntax element is 4, the method applied to the current chroma block may be selected as said method 5 proposed in FIG. 31.

The method proposed in this embodiment may be used for a CCLM mode which is an intra-prediction mode for a chroma component, and the chroma block predicted through the CCLM mode may be used to derive a residual image through a difference from an original image in the encoding apparatus or used to derive reconstructed image through an addition with a residual signal in the decoding apparatus.

In this embodiment, when a promised value is used the encoding apparatus and the decoding apparatus use without the need to transmit additional information, the encoding apparatus may perform the same operation as the decoding apparatus using the promised proposed method, and perform in the same manner the downsampling of the luma component and the calculation of the CCLM parameter, which are proposed when performing CCLM-based chroma block intra prediction.

Meanwhile, when information indicating one of the methods is transmitted in units of CUs, slices, pictures and sequences, the encoding apparatus may determine one of the methods 1 to 5 proposed in FIGS. 27 to 31, and then transmit the information to the decoding apparatus as follows.

In the case where information indicating whether or not the method of the above-described embodiment is used is transmitted in units of CUs, when the intra prediction mode of the current chroma block is the CCLM mode (that is, when CCLM prediction is applied to the current chroma block), the encoding apparatus may determine which of the following two cases has better encoding efficiency through the RDO, and may transmit information about the determined method to the decoding apparatus.

1) When the Nₜₕ is set to 4 for all blocks, and it has a good encoding efficiency to perform CCLM parameter calculation through the neighboring sample section method of the above-described embodiment proposed in FIG. 9, a cclm_reduced_sample_flag syntax element with a value of 0 (false) is transmitted

2) When it is set that said method 3 proposed in FIG. 29 is applied and it has a good encoding efficiency to perform CCLM parameter calculation through the neighboring sample selection method proposed in the above-described embodiment, a cclm_reduced_sample_flag syntax element with a value of 1 (true) is transmitted

Alternatively, in the case where the information indicating whether or not the method of the embodiment described above is applied is transmitted in units of slices, pictures or sequences, the encoding apparatus may add a high level syntax (HLS) as represented in Table 42, 43 or 44 described above, and transmit the information representing one method of said methods proposed in FIGS. 27 to 31. Alternatively, information indicating one of the methods proposed in FIGS. 27 to 31 may be included in the HLS as shown in Table 42, 43, or 44 described above. For example, the information indicating one of the methods may include a cclm_reduced_sample_threshold syntax element, and the value of the cclm_reduced_sample_threshold syntax element may be derived based on Table 45. The encoding apparatus may set a method to be applied from among said methods in consideration of the size of the input image or in accordance with an encoding target bitrate.

1) For example, when the input image is HD or higher, the encoding apparatus may apply said method 2 proposed in FIG. 28, and when the input image is HD or lower, it may apply said method 3 proposed in FIG. 29.

2) When high quality image encoding is required, the encoding apparatus may apply said method 1 proposed in FIG. 27, and when low quality image encoding is required, it may apply said method 2 proposed in FIG. 28.

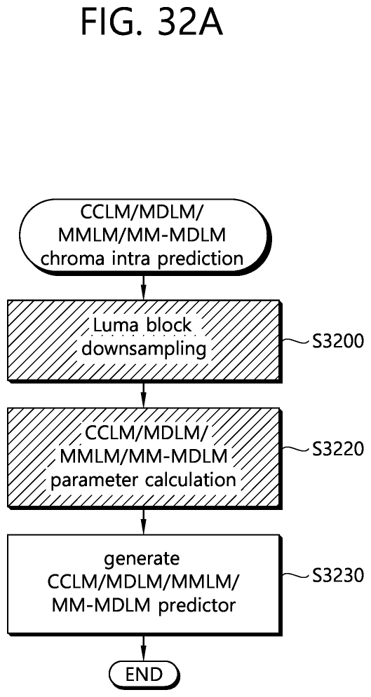

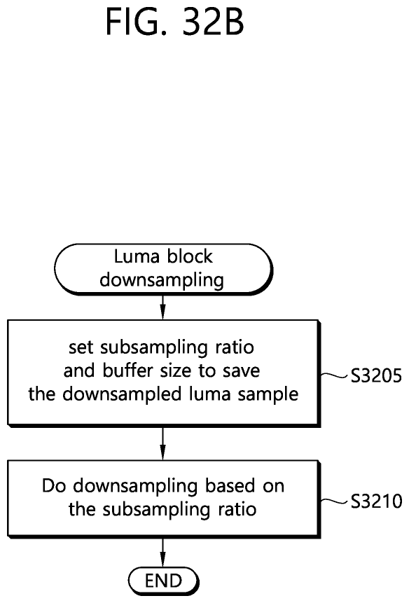

FIGS. 32A and 32B are diagrams for describing a process of performing CCLM/MDLM/MMLM/MM-MDLM prediction based on the CCLM/MDLM/MMLM/MM-MDLM parameters of the current chroma block derived according to the method of the embodiment described above.

Referring to FIG. 32A, the encoding apparatus/decoding apparatus may perform luma block downsampling on the current block (S3200). For example, the luma block downsampling may be performed as in the embodiment shown in FIG. 32B.

FIG. 32B may illustrate a specific embodiment of performing luma block downsampling. For example, referring to FIG. 32B, the encoding apparatus/decoding apparatus may set a buffer size for storing downsampled luma samples and a subsampling ratio (S3205). Here, the subsampling ratio may indicate a ratio of samples to be used for parameter calculation among neighboring chroma samples.

Thereafter, the encoding apparatus/decoding apparatus may perform downsampling based on the set subsampling ratio (S3210). For example, the downsampling may use Equation 10 or 12 for top neighboring samples, and use Equation 11 or 13 for left neighboring samples. That is, the encoding apparatus/decoding apparatus may derive the downsampled luma sample through the downsampling. Alternatively, the encoding apparatus/decoding apparatus may derive samples for parameter calculation more efficiently by performing downsampling at a subsampling ratio, compared to the existing method in which subsampling is performed after downsampling.

Referring back to FIG. 32A, when the downsampled luma sample is derived, the encoding apparatus/decoding apparatus may calculate a CCLM/MDLM/MMLM/MM-MDLM parameter for the current block based on the downsampled luma sample (S3220). For example, as a method of calculating the CCLM/MDLM/MMLM/MM-MDLM parameter, one of methods 1 to 5 proposed in FIGS. 27 to 31 may be used, and CCLM/MDLM/MMLM/MM-MDLM parameters may include parameters a and 13 for CCLM/MDLM/MMLM/MM-MDLM prediction.

In the case where the parameters for CCLM/MDLM/MMLM/MM-MDLM prediction for the current chroma block are calculated, the encoding apparatus/decoding apparatus may perform CCLM/MDLM/MMLM/MM-MDLM prediction based on the parameters, and generate a prediction sample for the current chroma block (S3230). For example, the encoding apparatus/decoding apparatus may generate a prediction sample for the current chroma block based on above Equation 1 in which the calculated parameters and reconstructed samples of the current luma block for the current chroma block are used.

Meanwhile, in this document, an embodiment different from the above-described embodiment may be proposed for reducing the computational complexity of deriving the CCLM parameter in deriving the CCLM parameter.

Specifically, in this embodiment, in order to alleviate the complexity of the existing CCLM parameter calculation, a method of adaptively selecting samples used for CCLM parameter calculation is proposed, and a method for obtaining downsampled luma reference samples by applying downsampling with a small operation amount or without applying a filter during downsampling is proposed.

Referring back to FIG. 5 and Equation 9, Equation 9 may be simplified as Equation 14, for example.

(1) Rec′_{L}(x,y)=(2×Rec_{L}(2x, 2y)+Rec_{L}(2x−1,2y)+Rec_{L}(2x+1,2y)+2)>>2

(2) Rec′_{L}(x,y)=(2×Rec_{L}(2x, 2y+1)+Rec_{L}(2x−1,2y+1)+Rec_{L}(2x+1,2y+1)+2)>>2

(3) Rec′_{L}(x,y)=Rec_{L}(2x,2y)

(4) Rec′_{L}(x,y)=Rec_{L}(2x+1,2y)

(5) Rec′_{L}(x,y)=Rec_{L}(2x,2y+1)

(6) Rec′_{L}(x,y)=Rec_{L}(2x+1,2y+1) [Equation 14]

In Equation 14, (1) to (6) may represent respective downsampling filters, and in (1) to (6), Rec′L may denote a result value of downsampling; Rec_{L} may denote the position of the luma sample corresponding to the sample position (x,y) of the chroma block; and >> may denote a bit shift operator.

Alternatively, for example, when calculating the CCLM parameter using (3) downsampling filter in Equation 14 and above-described method 1 proposed in FIG. 27 (when half of the samples are used) at the same time, downsampling may be performed, for example, as in Equation 15 or 16.

Rec′_{L}(x, y)=Rec_{L}(4x, 2y) [Equation 15]

Rec′_{L}(x,y)=Rec_{L}(2x,4y) [Equation 16]

For example, Equation 15 may be used for downsampling of the top neighboring reference sample of the luma block, and Equation 16 may be used for downsampling of the left neighboring reference sample of the luma block. Additionally, Rec′L may denote the result value of downsampling, and Rec_{L} may denote the location of the luma sample corresponding to the sample location (x, y) of the chroma block.

Alternatively, when using a method for changing positions of downsampled samples like the above-described subsampling method proposed in FIG. 22, downsampling may be performed, for example, as in Equation 17 or 18.

Rec′_{L}(x,y)=Rec_{L}(4x+1,2y) [Equation 17]

Rec′_{L}(x,y)=Rec_{L}(2x,4y+1) [Equation 18]

For example, Equation 17 may be used for downsampling of the top neighboring reference sample of the luma block, and Equation 18 may be used for downsampling of the left neighboring reference sample of the luma block. Additionally, Rec′L may denote the result value of downsampling, and Rec_{L} may denote the location of the luma sample corresponding to the sample location (x, y) of the chroma block.

In the above equations, since the number of times of downsampling is reduced by half, the (x, y) value can use only up to half the size of the current chroma block. That is, since half of the samples are used, the amount of downsampling operation is reduced by half, and the storage buffer of the downsampled luma component for CCLM calculation can also be reduced by half, thereby obtaining a memory reduction effect. Additionally, since a simpler downsampling filter is used, operation complexity can be further greatly reduced.

In addition, when using said method 3 proposed in FIG. 29, or performing CCLM parameter calculation using half the samples as in the case of TH=4 in the method proposed in FIG. 10 and using up to 8 samples, the downsampling complexity is reduced to at least half and up to one sixtee Nₜₕ (in the case of a 32×32 chroma block), and the storage buffer of the downsampled luma component for this also stores only 8 samples. Therefore, only one eighth of buffer is required compared to storing the existing 64 samples, thereby greatly reducing the required memory.

The method proposed in this embodiment may be used in combination with the above-described methods proposed in FIGS. 10 to 31.

Meanwhile, according to this embodiment, without the need to transmit additional information, a promised value may be used in the encoding apparatus and the decoding apparatus, or information indicating the proposed filter type or information about a value may be transmitted in units of CUs, slices, pictures, and sequences. In this document, a slice/slice header may be replaced with a tile/tile header or a tile group/tile group header.

For example, in the case where information indicating whether or not the proposed method is used is transmitted, when the intra prediction mode of the current chroma block is the CCLM mode (i.e., when CCLM prediction is applied to the current chroma block), the cclm_reduced_sample_filter syntax element is parsed as follows, so that the above-described embodiment may be performed.

Alternatively, when information indicating the filter type is transmitted in units of slices, pictures, or sequences, one filter may be selected based on the information transmitted through high level syntax (HLS) as described later, and the CCLM parameter may be calculated based on the selected filter. That is, luma block downsampling may be performed based on the selected filter, and the CCLM parameter may be calculated based on the luma sample derived through the downsampling.

For example, the information indicating the filter to be applied signaled through a slice header may be represented as in the following Table.

TABLE 46

| | Descriptor |
|---|---|
| slice_header( ) { | |
| ... | |
| cclm_reduced_sample_filter | f(2) |
| ... | |

The cclm_reduced_sample_filter syntax element may represent a syntax element of information indicating the filter to be applied.

Alternatively, for example, the information indicating the filter to be applied signaled through a Picture Parameter Set (PPS) may be represented as in the following table.

TABLE 47

| | Descriptor |
|---|---|
| pic_parameter_set_rbsp( ) { | |
| ... | |
| cclm_reduced_sample_filter | f(2) |
| ... | |

Alternatively, for example, the information indicating the filter to be applied signaled through a Sequence Parameter Set (SPS) may be represented as in the following table.

TABLE 48

| | Descriptor |
|---|---|
| seq_parameter_set_rbsp( ) { | |
| ... | |
| cclm_reduced_sample_filter | f(2) |
| ... | |

The filter selected based on the value of the cclm_reduced_sample_filter syntax element transmitted through the slice header, the PPS or the SPS (i.e., a value derived by decoding cclm_reduced_sample_filter) may be derived as shown in the following table.

TABLE 49

| cclm_reduced_sample_filter | Proposed filter |
|---|---|
| 0 | 14 |
| 1 | 15 |
| 2 | 16 |
| 3 | 17 |

Referring to Table 49, when the value of the cclm_reduced_sample_filter syntax element is 0, a filter applied to the current chroma block may be selected as filter 14, and filter 14 may represent a filter which uses Equation 9 above. When the value of the cclm_reduced_sample_filter syntax element is 1, a filter applied to the current chroma block may be selected as filter 15, and filter 15 may represent a filter which uses (1) in Equation 14 above. When the value of the cclm_reduced_sample_filter syntax element is 2, a filter applied to the current chroma block may be selected as filter 16, and filter 16 may represent a filter which uses (2) in Equation 14 above. When the value of the cclm_reduced_sample_filter syntax element is 3, a filter applied to the current chroma block may be selected as filter 17, and filter 17 may represent a filter which uses (3) in Equation 14 above.

The method proposed in this embodiment may be used for a CCLM mode which is an intra-prediction mode for a chroma component, and the chroma block predicted through the CCLM mode may be used to derive a residual image through a difference from an original image in the encoding apparatus or used to derive reconstructed image through an addition with a residual signal in the decoding apparatus.

In this embodiment, when a promised value is used the encoding apparatus and the decoding apparatus use without the need to transmit additional information, the encoding apparatus may perform the same operation as the decoding apparatus using the promised proposed method, and perform in the same manner the downsampling of the luma component and the calculation of the CCLM parameter, which are proposed when performing CCLM-based chroma block intra prediction.

Meanwhile, when information indicating one of the filters is transmitted in units of slices, pictures and sequences, the encoding apparatus may determine one of the filters, and then transmit the information to the decoding apparatus as follows.

Alternatively, when information about whether or not to use a filter or information about a filter to be applied is transmitted in units of slices, pictures, or sequences, the encoding apparatus may transmit information about the filter type (or filter to be applied) proposed in this embodiment by adding high level syntax (HLS) as shown in Table 46, 47, or 48 described above. Alternatively, as shown in Table 46, 47, or 48, information about the filter type (or filter to be applied) proposed in this embodiment may be included in the HLS. For example, the information about the filter type (or filter to be applied) may include a cclm_reduced_sample_filter syntax element, and the value of the cclm_reduced_sample_filter syntax element may be derived based on Table 49. The encoding apparatus may set the filter type (or filter to be applied) in consideration of the size of the input image or in accordance with an encoding target bitrate.

1) For example, when the input image is HD or higher, the encoding apparatus may apply filter 14 of Table 48, and when the input image is HD or lower, it may apply filter 17 of Table 48.

2) When high quality image encoding is required, the encoding apparatus may apply filter 14 of Table 48, and when low quality image encoding is required, it may apply filter 17 of Table 48.

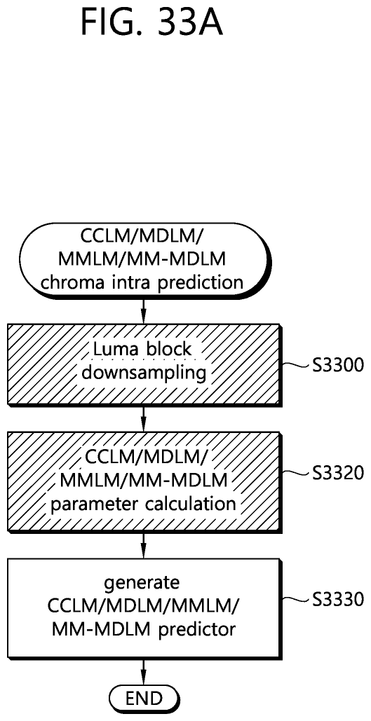

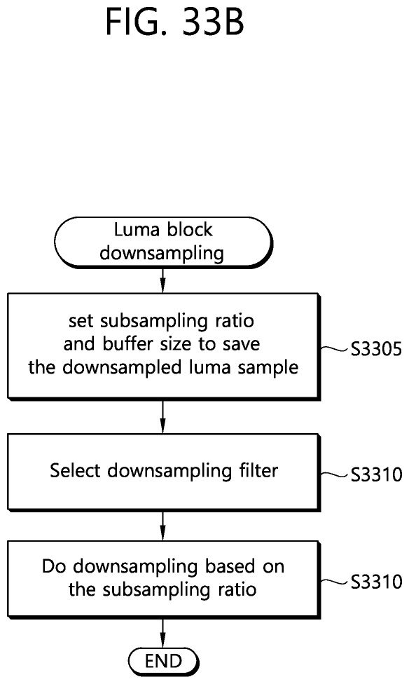

FIGS. 33A and 33B are diagrams for describing a process of performing CCLM/MDLM/MMLM/MM-MDLM prediction based on the CCLM/MDLM/MMLM/MM-MDLM parameters of the current chroma block derived according to the filter of the embodiment described above.

Referring to FIG. 33A, the encoding apparatus/decoding apparatus may perform luma block downsampling on the current block (S3300). For example, the luma block downsampling may be performed as in the embodiment shown in FIG. 33B.

FIG. 33B may illustrate a specific embodiment of performing luma block downsampling. For example, referring to FIG. 33B, the encoding apparatus/decoding apparatus may set a buffer size for storing downsampled luma samples and a subsamppoing ratio (S3305). Here, the subsampling ratio may indicate a ratio of samples to be used for parameter calculation among neighboring chroma samples.

Thereafter, the encoding apparatus/decoding apparatus may select a downsampling filter (S3310). Alternatively, the encoding apparatus/decoding apparatus may also select a downsampling filter based on the set subsampling ratio or buffer size.

The encoding apparatus/decoding apparatus may perform downsampling based on the set subsampling ratio (S3215). Alternatively, the encoding apparatus/decoding apparatus may perform downsampling using the selected downsampling filter. Alternatively, the encoding apparatus/decoding apparatus may perform downsampling using the set subsampling ratio and the selected downsampling filter. For example, the downsampling may use some of the filters which use Equations 9 and 14 to 18. That is, the encoding apparatus/decoding apparatus may derive samples for parameter calculation more efficiently by performing downsampling at a subsampling ratio, compared to the existing method in which subsampling is performed after downsampling.

Referring back to FIG. 33A, when the downsampled luma sample is derived, the encoding apparatus/decoding apparatus may calculate a CCLM/MDLM/MMLM/MM-MDLM parameter for the current block based on the downsampled luma sample (S3320). For example, as a method of calculating the CCLM/MDLM/MMLM/MM-MDLM parameter, one of methods 1 to 5 proposed in FIGS. 27 to 31 may be used, and CCLM/MDLM/MMLM/MM-MDLM parameters may include parameters a and 13 for CCLM/MDLM/MMLM/MM-MDLM prediction.

In the case where the parameters for CCLM/MDLM/MMLM/MM-MDLM prediction for the current chroma block are calculated, the encoding apparatus/decoding apparatus may perform CCLM/MDLM/MMLM/MM-MDLM prediction based on the parameters, and generate a prediction sample for the current chroma block (S3330). For example, the encoding apparatus/decoding apparatus may generate a prediction sample for the current chroma block based on above Equation 1 in which the calculated parameters and reconstructed samples of the current luma block for the current chroma block are used.

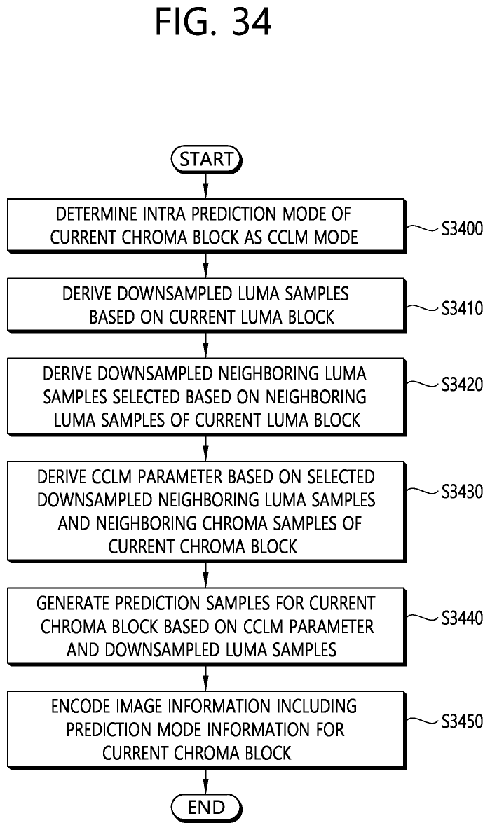

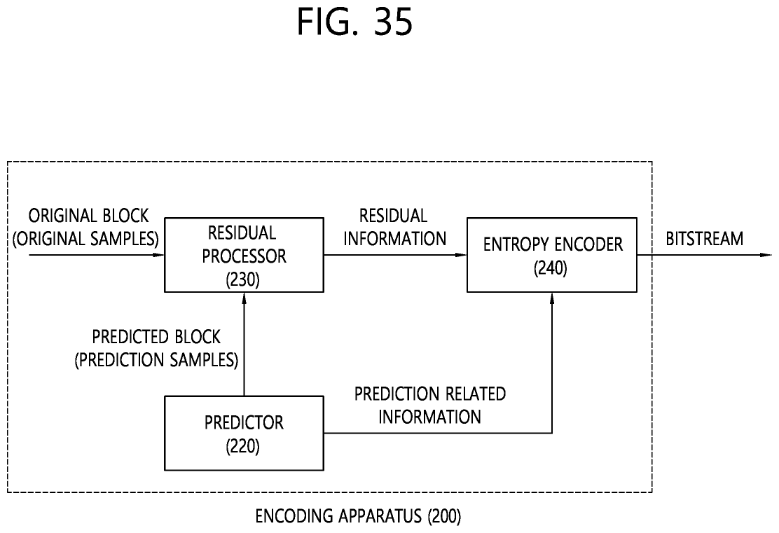

FIGS. 34 and 35 schematically show an example of a video/image encoding method and associated components according to the embodiment(s) of this document.

The method disclosed in FIG. 34 may be performed by the encoding apparatus disclosed in FIG. 2. Specifically, for example, S3400 to S3440 of FIG. 34 may be performed by the predictor 220 of the encoding apparatus in FIGS. 35, and S3450 of FIG. 34 may be performed by the entropy encoder 240 of the encoding apparatus in FIG. 35. In addition, although not shown in FIG. 34, residual information may be derived from original samples (or original block) by the residual processor 230 of the encoding apparatus in FIG. 35, and the residual information may be encoded by the entropy encoder 240. Alternatively, the entropy encoder 240 may generate a bitstream based on residual information and prediction related information. The method disclosed in FIG. 34 may include the embodiments described above in this document.

Referring to FIG. 34, the encoding apparatus may determine the intra prediction mode of the current chroma block as a cross-component linear model (CCLM) mode (S3400). For example, the encoding apparatus may determine the intra prediction mode of the current chroma block based on a rate-distortion cost (RDO). Here, the RD cost may be derived based on the sum of absolute differences (SAD). The encoding apparatus may determine the CCLM mode as the intra prediction mode of the current chroma block based on the RD cost.

In addition, the encoding apparatus may encode prediction mode information indicating the intra prediction mode of the current chroma block, and the prediction mode information may be signaled through a bitstream. The prediction mode information for the current chroma block may include an intra_chroma_pred_mode syntax element. For example, the prediction mode information may indicate the CCLM mode. Alternatively, the prediction mode information may include a cclm_mode_flag syntax element. Alternatively, the prediction mode information may further include a cclm_mode_idx syntax element. Alternatively, the prediction mode information may indicate an MDLM mode, an MMLM mode, or an MM-MDLM mode. The image information may include the prediction mode information.

For example, the size of the current chroma block may be 4×4. Alternatively, the size of the current chroma block may also be 8×8, 16×16, or 32×32. Alternatively, the current chroma block may be non-square.

For example, the encoding apparatus may derive the number of neighboring chroma samples of the current chroma block based on the width and height of the current chroma block. Alternatively, the encoding apparatus may derive the number of neighboring chroma samples of the current chroma block based on a specific value and the width and height of the current chroma block. Here, the number of neighboring chroma samples may indicate the number of samples used for CCLM parameter calculation. Additionally, the number of neighboring chroma samples may represent the number of left neighboring chroma samples of the current chroma block, the number of top neighboring chroma samples of the current chroma block, or the number of left and top neighboring chroma samples of the current chroma block.

For example, in the case where the width and the height of the current chroma block are greater than the specific value, the number of the neighboring chroma samples may be derived based on the specific value. Alternatively, in the case where the width and height of the current chroma block are greater than the specific value, the number of neighboring chroma samples may be derived as a value obtained by multiplying the specific value by two. That is, based on the specific value less than or equal to the width and less than or equal to the height, the number of the neighboring chroma samples may be derived as a value obtained by multiplying the specific value by two. Alternatively, when the width and height of the current chroma block are less than or equal to the specific value, it may be derived as a value obtained by multiplying the smaller value of the width and height by two. For example, the specific value may be derived as two. Alternatively, the specific value may be derived as 4, 8 or 16. Alternatively, the specific value may be derived as a preset value. In embodiments of this document, the specific value may be represented as Nth. The information indicating the specific value may be signaled in units of coding units (CUs). Alternatively, the information indicating the specific value may be signaled in units of slice headers, picture parameter sets (PPSs), or sequence parameter sets (SPSs). That is, the information indicating the specific value may be signaled as a slice header, PPS, or SPS.

The encoding apparatus may derive downsampled luma samples based on the current luma block (S3410), and derive downsampled neighboring luma samples selected based on the neighboring luma samples of the current luma block (S3420).

For example, the encoding apparatus may downsample the neighboring luma samples for deriving the selected downsampled neighboring luma samples from among the neighboring luma samples of the current luma block. Alternatively, the encoding apparatus may not downsample the neighboring luma samples that are not used for derivation of the selected downsampled neighboring luma samples among the neighboring luma samples of the current luma block. Alternatively, the encoding apparatus may skip downsampling other than the downsampling for deriving the selected downsampled neighboring luma samples. Alternatively, the encoding apparatus may perform downsampling only on neighboring luma samples selected from among neighboring luma samples of the current luma block. Alternatively, the encoding apparatus may perform downsampling using only samples for deriving selected downsampled neighboring luma samples from among neighboring luma samples of the current luma block.

For example, the selected downsampled neighboring luma samples may be selected based on the neighboring chroma samples. Alternatively, the selected downsampled neighboring luma samples may be selected based on the number of the neighboring chroma samples. Alternatively, the selected downsampled neighboring luma samples may correspond to the neighboring chroma samples.

For example, the size of the current luma block may be 8×8. Alternatively, the size of the current luma block may be 16×16, 32×32, or 64×64. Alternatively, the current luma block may be non-square.

For example, the selected downsampled neighboring luma samples may correspond to the neighboring chroma samples. Alternatively, the downsampled neighboring luma samples may be related to the neighboring chroma samples.

For example, the selected downsampled neighboring luma samples may include four selected downsampled neighboring luma samples related to the neighboring chroma samples. Alternatively, the selected downsampled neighboring luma samples may include four selected downsampled neighboring luma samples corresponding to the neighboring chroma samples.

For example, the neighboring chroma samples may include left neighboring chroma samples of the current chroma block or top neighboring chroma samples of the current chroma block. For example, the four selected downsampled neighboring luma samples may include four selected downsampled left neighboring luma samples related to the left neighboring chroma samples. Alternatively, the four selected downsampled left neighboring luma samples may correspond to the left neighboring chroma samples. Alternatively, they may be sample pairs with each other. Alternatively, for example, when a prediction mode using left neighboring reference samples among CCLM mode or MDLM mode is used, the selected downsampled neighboring luma samples may include four selected downsampled left neighboring luma samples corresponding to the left neighboring chroma samples of the current chroma block. For example, the four selected downsampled neighboring luma samples may include four selected downsampled top neighboring luma samples related to the top neighboring chroma samples. Alternatively, the four selected downsampled top neighboring luma samples may correspond to the top neighboring chroma samples. Alternatively, they may be sample pairs with each other. Alternatively, for example, when a prediction mode using top neighboring reference samples among CCLM mode or MDLM mode is used, the selected downsampled neighboring luma samples may include four selected downsampled top neighboring luma samples corresponding to the top neighboring chroma samples of the current chroma block.

For example, the neighboring chroma samples may include left neighboring chroma samples of the current chroma block and top neighboring chroma samples of the current chroma block. For example, the four selected downsampled neighboring luma samples may include two selected downsampled left neighboring luma samples related to the left neighboring chroma samples and two selected downsampled top neighboring luma samples related to the top neighboring chroma samples. Alternatively, the two selected downsampled left neighboring luma samples may correspond to the left neighboring chroma samples, and the two selected downsampled top neighboring luma samples may correspond to the top neighboring chroma samples. Alternatively, they may be sample pairs with each other. Alternatively, for example, when a prediction mode using left and top neighboring reference samples among CCLM mode or MDLM mode is used, the selected downsampled neighboring luma samples may include two selected downsampled left neighboring luma samples corresponding to left neighboring chroma samples of the current chroma block, and two selected downsampled top neighboring luma samples corresponding to top neighboring chroma samples of the current chroma block.

For example, the selected downsampled neighboring luma samples may be derived based on downsampling at a ratio of 4:1 based on the neighboring luma samples of the current luma block. For example, downsampling at a ratio of 4:1 may be performed based on Equation 10, 11, 12, 13, 15, 16, 17, or 18. In other words, when the size of the current luma block is 8×8, the two selected downsampled left neighboring luma samples and the two selected downsampled top neighboring luma samples may be derived through downsampling based on Equation 10, 11, 12, 13, 15, 16, 17 or 18.

Alternatively, for example, the selected downsampled neighboring luma samples may be derived based on downsampling at a ratio of 2:1 based on the neighboring luma samples of the current luma block. For example, downsampling at a ratio of 2:1 may be performed based on Equation 9 or 14.

For example, the selected downsampled left neighboring luma samples may be derived based on a first downsampling method, and the selected downsampled top neighboring luma samples are may be derived based on a second downsampling method different from the first downsampling method. For example, the first downsampling method for the left neighboring luma samples may be performed based on Equation 9, 11, 13, 14, 16, or 18, and the second downsampling method for the top neighboring luma samples may be performed based on Equation 9, 10, 12, 14, 15, or 17.

Alternatively, for example, the selected downsampled left neighboring luma samples and the selected downsampled top neighboring luma samples may be derived based on the same downsampling method. For example, in this case, it may be performed based on Equation 9 or 14.

For example, the selected downsampled neighboring luma samples may be derived based on downsampling at a ratio of 1:2:1 from the first neighboring sample, the second neighboring sample, and the third neighboring sample. Here, the first neighboring sample may be located at (−1, y) or (x, −1) based on the top left sample position (0, 0) of the current luma block. In other words, the first neighboring sample may represent neighboring luma sample(s) most adjacent to the boundary of the current luma block. The second neighboring sample may be located at (−2, y) or (x, −2) based on the top left sample position (0, 0) of the current luma block. In other words, the second neighboring sample may represent neighboring luma sample(s) located at a distance of one sample from the first neighboring sample in a direction opposite to the boundary of the current luma block. The third neighboring sample may be located at (−3, y) or (x, −3). In other words, the third neighboring sample may represent neighboring luma sample(s) located at a distance of two samples from the first neighboring sample in a direction opposite to the boundary of the current luma block. Here, said x may denote a variable which is an integer within a range from 0 to a value equal to the width of the current luma block minus 1, and said y may denote a variable which is an integer within a range from 0 to a value equal to the height of the current luma block minus 1.

For example, the selected downsampled neighboring luma samples may be derived from neighboring luma samples of the current luma block using a downsampling filter. The downsampling filter may include a 6-tap filter, a 3-tap filter, or a filter for deriving a sample at a specific position based on neighboring luma samples of the current luma block, and the sample at the specific position may be derived based on the positions of the neighboring chroma samples among neighboring luma samples of the current luma block. For example, the 6-tap filter may represent a filter which uses Equation 9. That is, the 6-tap filter may derive a downsampled neighboring luma sample based on 6 neighboring luma samples of the current luma block. For example, the 3-tap filter may represent a filter which uses (1) or (2) of Equation 14. That is, the 3-tap filter may derive a downsampled neighboring luma sample based on 3 neighboring luma samples of the current luma block. For example, a filter for deriving a sample at a specific position may represent a filter which uses (3), (4), (5), (6) of Equation 14, Equation 15, 16, 17 or 18. That is, the filter for deriving a sample at a specific position may derive a downsampled neighboring luma sample selected based on one neighboring luma sample of the current luma block.

The filter used for the downsampling may be derived by information indicating the downsampling filter. The information indicating the downsampling filter may be information indicating one of the filters. The information indicating the downsampling filter may include a cclm_reduced_sample_filter syntax element.

The image information may include information indicating the downsampling filter. Alternatively, the image information may include a slice header, a picture parameter set (PPS), or sequence parameter set (SPS). Alternatively, the information indicating the downsampling filter may be signaled in units of slice headers, PPSs, or SPSs. That is, the information indicating the specific value may be signaled as a slice header, PPS, or SPS.

The encoding apparatus may derive a CCLM parameter based on the selected downsampled neighboring luma samples and neighboring chroma samples of the current chroma block (S3430). For example, the encoding apparatus may derive CCLM parameters based on the top neighboring chroma samples, the left neighboring chroma samples, and the selected downsampled neighboring luma samples. For example, the CCLM parameters may be derived based on Equation 3 described above.

The encoding apparatus may generate prediction samples for the current chroma block based on the CCLM parameter and the downsampled luma samples (S3440). For example, the encoding apparatus may derive prediction samples for the current chroma block based on the CCLM parameters and the downsampled luma samples. The encoding apparatus may generate prediction samples for the current chroma block by applying the CCLM derived with the CCLM parameters to the downsampled luma samples. That is, the encoding apparatus may generate prediction samples for the current chroma block by performing CCLM prediction based on the CCLM parameters. For example, the prediction samples may be derived based on Equation 1 described above.

The encoding apparatus may encode image information including prediction mode information about the current chroma block (S3450). For example, the encoding apparatus may encode image information including prediction mode information about the current chroma block, and signal the encoded image information through a bitstream.

Meanwhile, although not shown, the encoding apparatus may derive residual samples for the current chroma block based on original samples and prediction samples for the current chroma block, generate information about a residual for the current chroma block based on the residual samples, and encode the information about a residual. The image information may include the information about a residual. Further, the encoding apparatus may generate reconstructed samples for the current chroma block based on the prediction samples and the residual samples for the current chroma block.

The encoding apparatus may generate a bitstream by encoding image information including all or some of the above-described informations (or syntax elements). Alternatively, it may be output in the form of a bitstream. Further, the bitstream may be transmitted to the decoding apparatus through a network or a storage medium. Alternatively, the bitstream may be stored in a computer-readable storage medium. Here, the network may include a broadcast network, a communication network and/or the like, and the digital storage medium may include various storage media, such as USB, SD, CD, DVD, Blu-ray, HDD, SSD, and the like.

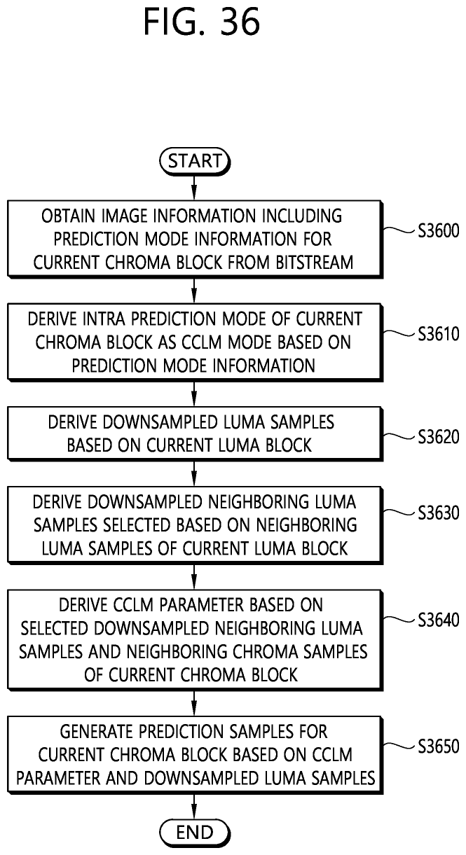

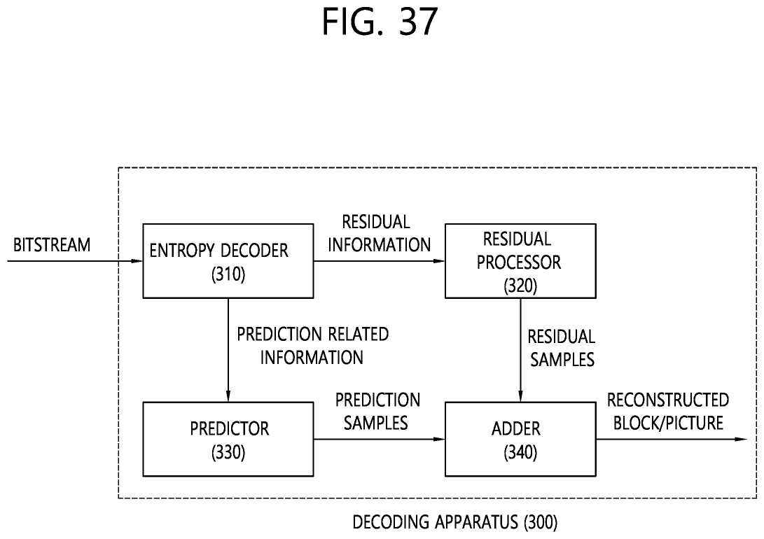

FIGS. 36 and 37 schematically show an example of a video/image encoding method and associated components according to the embodiment(s) of this document.

The method disclosed in FIG. 36 may be performed by the decoding apparatus disclosed in FIG. 3. Specifically, for example, S3600 of FIG. 36 may be performed by the entropy decoder 310 of the decoding apparatus in FIGS. 37, and S3610 to S3650 of FIG. 36 may be performed by the predictor 330 of the decoding apparatus in FIG. 37. In addition, although not shown in FIG. 36, in FIG. 37, residual information may be obtained from the bitstream by the entropy decoder 310 of the decoding apparatus, residual samples may be derived based on the residual information by the residual processor 320, and reconstructed samples (or reconstructed blocks) may be generated based on the prediction samples and the residual samples by the adder 340. The method disclosed in FIG. 36 may include the embodiments described above in this document.

Referring to FIG. 36, the decoding apparatus may obtain image information including prediction mode information for the current chroma block from the bitstream (S3600). For example, the decoding apparatus may receive image information including prediction mode information for the current chroma block through a bitstream. The prediction mode information may indicate an intra prediction mode of the current chroma block. Alternatively, the prediction mode information may include an intra_chroma_pred_mode syntax element.

For example, the size of the current chroma block may be 4×4. Alternatively, the size of the current chroma block may also be 8×8, 16×16, or 32×32. Alternatively, the current chroma block may be non-square.

The decoding apparatus may derive an intra prediction mode of the current chroma block as a cross-component linear model (CCLM) mode based on the prediction mode information (S3610). For example, the decoding apparatus may derive an intra prediction mode of the current chroma intra prediction mode based on the prediction mode information. For example, the prediction mode information may indicate the CCLM mode. Alternatively, the prediction mode information may include a cclm_mode_flag syntax element. Alternatively, the prediction mode information may further include a cclm_mode_idx syntax element. Alternatively, the prediction mode information may indicate an MDLM mode, an MMLM mode, or an MM-MDLM mode.

For example, the decoding apparatus may derive the number of neighboring chroma samples of the current chroma block based on the width and height of the current chroma block. Alternatively, the decoding apparatus may derive the number of neighboring chroma samples of the current chroma block based on a specific value and the width and height of the current chroma block. Here, the number of neighboring chroma samples may indicate the number of samples used for CCLM parameter calculation. Additionally, the number of neighboring chroma samples may represent the number of left neighboring chroma samples of the current chroma block, the number of top neighboring chroma samples of the current chroma block, or the number of left and top neighboring chroma samples of the current chroma block.

For example, in the case where the width and the height of the current chroma block are greater than the specific value, the number of the neighboring chroma samples may be derived based on the specific value. Alternatively, in the case where the width and height of the current chroma block are greater than the specific value, the number of neighboring chroma samples may be derived as a value obtained by multiplying the specific value by two. That is, based on the specific value less than or equal to the width and less than or equal to the height, the number of the neighboring chroma samples may be derived as a value obtained by multiplying the specific value by two. Alternatively, when the width and height of the current chroma block are less than or equal to the specific value, it may be derived as a value obtained by multiplying the smaller value of the width and height by two. For example, the specific value may be derived as two. Alternatively, the specific value may be derived as 4, 8 or 16. Alternatively, the specific value may be derived as a preset value. In embodiments of this document, the specific value may be represented as Nth. The information indicating the specific value may be signaled in units of coding units (CUs). Alternatively, the information indicating the specific value may be signaled in units of slice headers, picture parameter sets (PPSs), or sequence parameter sets (SPSs). That is, the information indicating the specific value may be signaled as a slice header, PPS, or SPS.

The decoding apparatus may derive downsampled luma samples based on the current luma block (S3620), and derive downsampled neighboring luma samples selected based on the neighboring luma samples of the current luma block (S3630).

For example, the decoding apparatus may downsample the neighboring luma samples for deriving the selected downsampled neighboring luma samples from among the neighboring luma samples of the current luma block. Alternatively, the decoding apparatus may not downsample the neighboring luma samples that are not used for derivation of the selected downsampled neighboring luma samples among the neighboring luma samples of the current luma block. Alternatively, the decoding apparatus may skip downsampling other than the downsampling for deriving the selected downsampled neighboring luma samples. Alternatively, the decoding apparatus may perform downsampling only on neighboring luma samples selected from among neighboring luma samples of the current luma block. Alternatively, the decoding apparatus may perform downsampling using only samples for deriving selected downsampled neighboring luma samples from among neighboring luma samples of the current luma block.

For example, the selected downsampled neighboring luma samples may be selected based on the neighboring chroma samples. Alternatively, the selected downsampled neighboring luma samples may be selected based on the number of the neighboring chroma samples. Alternatively, the selected downsampled neighboring luma samples may correspond to the neighboring chroma samples.

For example, the size of the current luma block may be 8×8. Alternatively, the size of the current luma block may be 16×16, 32×32, or 64×64. Alternatively, the current luma block may be non-square.

For example, the selected downsampled neighboring luma samples may correspond to the neighboring chroma samples. Alternatively, the downsampled neighboring luma samples may be related to the neighboring chroma samples.

For example, the selected downsampled neighboring luma samples may include four selected downsampled neighboring luma samples related to the neighboring chroma samples. Alternatively, the selected downsampled neighboring luma samples may include four selected downsampled neighboring luma samples corresponding to the neighboring chroma samples.

For example, the neighboring chroma samples may include left neighboring chroma samples of the current chroma block or top neighboring chroma samples of the current chroma block. For example, the four selected downsampled neighboring luma samples may include four selected downsampled left neighboring luma samples related to the left neighboring chroma samples. Alternatively, the four selected downsampled left neighboring luma samples may correspond to the left neighboring chroma samples. Alternatively, they may be sample pairs with each other. Alternatively, for example, when a prediction mode using left neighboring reference samples among CCLM mode or MDLM mode is used, the selected downsampled neighboring luma samples may include four selected downsampled left neighboring luma samples corresponding to the left neighboring chroma samples of the current chroma block. For example, the four selected downsampled neighboring luma samples may include four selected downsampled top neighboring luma samples related to the top neighboring chroma samples. Alternatively, the four selected downsampled top neighboring luma samples may correspond to the top neighboring chroma samples. Alternatively, they may be sample pairs with each other. Alternatively, for example, when a prediction mode using top neighboring reference samples among CCLM mode or MDLM mode is used, the selected downsampled neighboring luma samples may include four selected downsampled top neighboring luma samples corresponding to the top neighboring chroma samples of the current chroma block.

For example, the neighboring chroma samples may include left neighboring chroma samples of the current chroma block and top neighboring chroma samples of the current chroma block. For example, the four selected downsampled neighboring luma samples may include two selected downsampled left neighboring luma samples related to the left neighboring chroma samples and two selected downsampled top neighboring luma samples related to the top neighboring chroma samples. Alternatively, the two selected downsampled left neighboring luma samples may correspond to the left neighboring chroma samples, and the two selected downsampled top neighboring luma samples may correspond to the top neighboring chroma samples. Alternatively, they may be sample pairs with each other. Alternatively, for example, when a prediction mode using left and top neighboring reference samples among CCLM mode or MDLM mode is used, the selected downsampled neighboring luma samples may include two selected downsampled left neighboring luma samples corresponding to left neighboring chroma samples of the current chroma block, and two selected downsampled top neighboring luma samples corresponding to top neighboring chroma samples of the current chroma block.

For example, the selected downsampled neighboring luma samples may be derived based on downsampling at a ratio of 4:1 based on the neighboring luma samples of the current luma block. For example, downsampling at a ratio of 4:1 may be performed based on Equation 10, 11, 12, 13, 15, 16, 17, or 18. In other words, when the size of the current luma block is 8×8, the two selected downsampled left neighboring luma samples and the two selected downsampled top neighboring luma samples may be derived through downsampling based on Equation 10, 11, 12, 13, 15, 16, 17 or 18.

Alternatively, for example, the selected downsampled neighboring luma samples may be derived based on downsampling at a ratio of 2:1 based on the neighboring luma samples of the current luma block. For example, downsampling at a ratio of 2:1 may be performed based on Equation 9 or 14.

For example, the selected downsampled left neighboring luma samples may be derived based on a first downsampling method, and the selected downsampled top neighboring luma samples are may be derived based on a second downsampling method different from the first downsampling method. For example, the first downsampling method for the left neighboring luma samples may be performed based on Equation 9, 11, 13, 14, 16, or 18, and the second downsampling method for the top neighboring luma samples may be performed based on Equation 9, 10, 12, 14, 15, or 17.

Alternatively, for example, the selected downsampled left neighboring luma samples and the selected downsampled top neighboring luma samples may be derived based on the same downsampling method. For example, in this case, it may be performed based on Equation 9 or 14.

For example, the selected downsampled neighboring luma samples may be derived based on downsampling at a ratio of 1:2:1 from the first neighboring sample, the second neighboring sample, and the third neighboring sample. Here, the first neighboring sample may be located at (−1, y) or (x, −1) based on the top left sample position (0, 0) of the current luma block. In other words, the first neighboring sample may represent neighboring luma sample(s) most adjacent to the boundary of the current luma block. The second neighboring sample may be located at (−2, y) or (x, −2) based on the top left sample position (0, 0) of the current luma block. In other words, the second neighboring sample may represent neighboring luma sample(s) located at a distance of one sample from the first neighboring sample in a direction opposite to the boundary of the current luma block. The third neighboring sample may be located at (−3, y) or (x, −3). In other words, the third neighboring sample may represent neighboring luma sample(s) located at a distance of two samples from the first neighboring sample in a direction opposite to the boundary of the current luma block. Here, said x may denote a variable which is an integer within a range from 0 to a value equal to the width of the current luma block minus 1, and said y may denote a variable which is an integer within a range from 0 to a value equal to the height of the current luma block minus 1.

For example, the selected downsampled neighboring luma samples may be derived from neighboring luma samples of the current luma block using a downsampling filter. The downsampling filter may include a 6-tap filter, a 3-tap filter, or a filter for deriving a sample at a specific position based on neighboring luma samples of the current luma block, and the sample at the specific position may be derived based on the positions of the neighboring chroma samples among neighboring luma samples of the current luma block. For example, the 6-tap filter may represent a filter which uses Equation 9. That is, the 6-tap filter may derive a downsampled neighboring luma sample based on 6 neighboring luma samples of the current luma block. For example, the 3-tap filter may represent a filter which uses (1) or (2) of Equation 14. That is, the 3-tap filter may derive a downsampled neighboring luma sample based on 3 neighboring luma samples of the current luma block. For example, a filter for deriving a sample at a specific position may represent a filter which uses (3), (4), (5), (6) of Equation 14, Equation 15, 16, 17 or 18. That is, the filter for deriving a sample at a specific position may derive a downsampled neighboring luma sample selected based on one neighboring luma sample of the current luma block.

The filter used for the downsampling may be derived by information indicating the downsampling filter. The information indicating the downsampling filter may be information indicating one of the filters. The information indicating the downsampling filter may include a cclm_reduced_sample_filter syntax element.

The image information may include information indicating the downsampling filter. Alternatively, the image information may include a slice header, a picture parameter set (PPS), or sequence parameter set (SPS). Alternatively, the information indicating the downsampling filter may be signaled in units of slice headers, PPSs, or SPSs. That is, the information indicating the specific value may be signaled as a slice header, PPS, or SPS.

The decoding apparatus may derive a CCLM parameter based on the selected downsampled neighboring luma samples and neighboring chroma samples of the current chroma block (S3640). For example, the decoding apparatus may derive CCLM parameters based on the top neighboring chroma samples, the left neighboring chroma samples, and the selected downsampled neighboring luma samples. For example, the CCLM parameters may be derived based on Equation 3 described above.

The decoding apparatus may generate prediction samples for the current chroma block based on the CCLM parameter and the downsampled luma samples (S3650). For example, the decoding apparatus may derive prediction samples for the current chroma block based on the CCLM parameters and the downsampled luma samples. The decoding apparatus may generate prediction samples for the current chroma block by applying the CCLM derived with the CCLM parameters to the downsampled luma samples. That is, the decoding apparatus may generate prediction samples for the current chroma block by performing CCLM prediction based on the CCLM parameters. For example, the prediction samples may be derived based on Equation 1 described above.

Also, although not shown in FIG. 36, for example, the decoding apparatus may generate reconstructed samples for the current chroma block based on the prediction samples. For example, the decoding apparatus may generate reconstructed samples based on the prediction samples. For example, the decoding apparatus may receive information about the residual for the current chroma block from the bitstream. The information about the residual may include a transform coefficient relating to a (chroma) residual sample. The decoding apparatus may derive the residual sample (or residual sample array) for the current chroma block based on the residual information. In this case, the decoding apparatus may generate the reconstructed samples based on the prediction samples and the residual samples. The decoding apparatus may derive a reconstructed block or a reconstructed picture based on the reconstructed sample. Thereafter, as described above, the decoding apparatus may apply an in-loop filtering process such as deblocking filtering and/or an SAO process to the reconstructed picture in order to improve subjective/objective image quality, as needed.

The decoding apparatus may obtain image information including all or some of the above-described informations (or syntax elements) by decoding the bitstream. In addition, the bitstream may be stored in a computer-readable digital storage medium, and may cause the above-described decoding method to be performed.

In the above-described embodiments, methods are described based on a flowchart using a series of steps or blocks, but the present document is not limited to the sequence of the steps. Some steps may be generated simultaneously or in a different sequence from the steps described above. Further, those skilled in the art will understand that the steps shown in the flowchart diagram are not exclusive, other steps may be included, or one or more steps in the flowchart may be deleted without affecting the scope of this document.

The method according to the present document described above may be implemented in a software form, and the encoding apparatus and/or the decoding apparatus according to the present document may be included, for example, in a device that performs image processing, such as TV, computer, smartphone, set-top box, or display device.

When the embodiments of the present document are implemented in software, the above-described method may be implemented by modules (processes, functions, and so on) that perform the functions described above. Such modules may be stored in memory and executed by a processor. The memory may be inside or outside the processor, and the memory may be connected to the processor using various well known means. The processor may include an application-specific integrated circuit (ASIC), other chipsets, a logic circuit, and/or a data processing device. The memory may include a read-only memory (ROM), a random access memory (RAM), a flash memory, a memory card, a storage medium, and/or other storage devices.

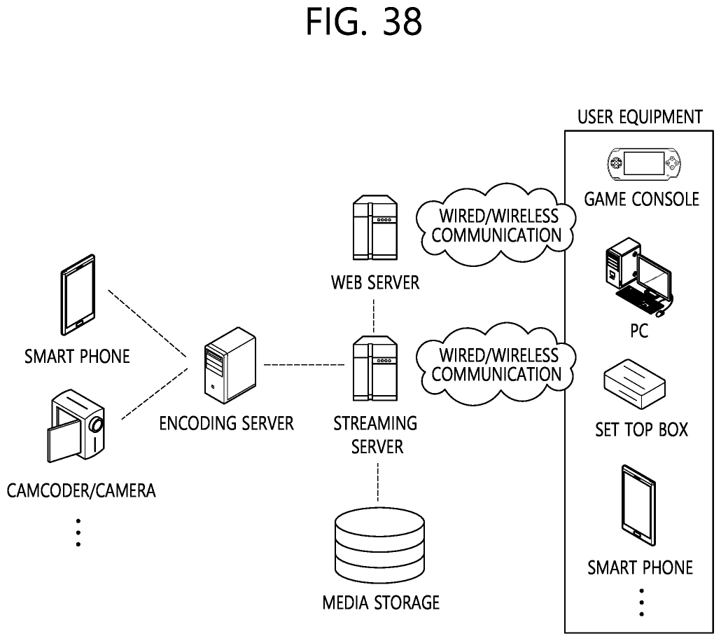

FIG. 38 is a diagram illustrating a structure of a content streaming system.

That is, the exemplary embodiments described in the present document may be performed by being implemented on a processor, a microprocessor, a controller, or a chip. For example, the functional units illustrated in each drawing may be performed by being implemented on a computer, a processor, a microprocessor, a controller, or a chip.

Further, the decoding apparatus and the encoding apparatus to which the present disclosure is applied may be included in a multimedia broadcast transceiver, a mobile communication terminal, a home cinema video device, a digital cinema video device, a surveillance camera, a video chat device, a real-time communication device such as video communication, a mobile streaming device, a storage medium, a camcorder, a Video on Demand (VoD) service provider, an Over the top (OTT) video device, an Internet streaming service provider, a three-dimensional (3D) video device, a video call video device, a medical video device, or the like, and used for processing video signals or data signals. For example, the Over the top (OTT) video device may include a game console, a Blue-ray player, an Internet access TV, a home theater system, a smartphone, a tablet PC, a digital video recorder (DVR), and the like.

Further, the processing method to which the present document is applied may be produced in the form of a program executed by a computer, and stored in a computer-readable recording medium. The multimedia data having the data structure according to the present document may also be stored in the computer-readable recording medium. The computer-readable recording medium includes all kinds of storage devices and distribution storage devices in which the computer-readable data are stored. The computer-readable recording medium may include, for example, a Blue-ray disc (BD), a universal serial bus (USB), a ROM, a PROM, an EPROM, an EEPROM, a RAM, a CD-ROM, a magnetic tape, a floppy disc, and an optical data storage device. Further, the computer-readable recording medium includes a media implemented in the form of a carrier (e.g., transmission through the Internet). Further, the bitstream generated by the encoding method may be stored in the computer-readable recording medium or transmitted through a wired/wireless communication network. Further, the exemplary embodiment of the present document may be implemented by a computer program product by program codes, and the program codes may be performed by the computer according to the exemplary embodiment of the present document. The program codes may be stored on the computer-readable carrier.

Further, the content streaming system to which the present document is applied may largely include an encoding server, a streaming server, a web server, a media storage, a user device, and a multimedia input device.

The encoding server serves to compress the content input from the multimedia input devices such as a smartphone, a camera, and a camcorder into the digital data to generate a bitstream and transmit the bitstream to the streaming server. As another example, if the multimedia input devices such as a smartphone, a camera, and a camcorder directly generate the bitstream, the encoding server may be omitted. The bitstream may be generated by the encoding method to which the present document is applied or the bitstream generation method, and the streaming server may temporarily store the bitstream in the process of transmitting or receiving the bitstream.

The streaming server serves to transmit the multimedia data to the user device based on the user request through the web server, and the web server serves as a medium which informs the user of what services are available. When the user requests the desired service to the web server, the web server delivers the user's request to the streaming server, and the streaming server transmits the multimedia data to the user. At this time, the content streaming system may include a separate control server, and in this case, the control server serves to control commands/responses between the devices within the content streaming system.

The streaming server may receive the contents from the media storage and/or the encoding server. For example, when receiving the contents from the encoding server, the streaming server may receive the contents in real time. In this case, to provide the smooth streaming service, the streaming server may store the bitstream for a predetermined time.

As an example of the user device, there may be a portable phone, a smartphone, a laptop computer, a digital broadcast terminal, a personal digital assistants (PDA), a portable multimedia player (PMP), a navigation device, a slate PC, a tablet PC, an ultrabook, a wearable device (e.g., a smartwatch, a smart glass, a head mounted display (HMD)), a digital TV, a desktop computer, a digital signage, or the like. The respective servers within the content streaming system may be operated by a distribution server, and in this case, the data received by each server may be distributed and processed.

1. An image decoding method performed by a decoding apparatus, the method comprising:
obtaining image information including prediction mode information for a current chroma block from a bitstream;
deriving an intra prediction mode of the current chroma block as a cross-component linear model (CCLM) mode based on the prediction mode information;
deriving downsampled luma samples based on luma samples of a current luma block;
deriving selected neighboring chroma samples of the current chroma block;
deriving selected downsampled neighboring luma samples based on neighboring luma samples of the current luma block;
deriving a CCLM parameter based on the selected downsampled neighboring luma samples and the selected neighboring chroma samples of the current chroma block; and
generating prediction samples for the current chroma block based on the CCLM parameter and the downsampled luma samples,
wherein the selected downsampled neighboring luma samples include four selected downsampled neighboring luma samples related to the selected neighboring chroma samples.

2. The image decoding method of claim 1, wherein the neighboring chroma samples include left neighboring chroma samples of the current chroma block or top neighboring chroma samples of the current chroma block, and
wherein the four selected downsampled neighboring luma samples include four selected downsampled left neighboring luma samples related to the left neighboring chroma samples or four selected downsampled top neighboring luma samples related to the top neighboring chroma samples.

3. The image decoding method of claim 1, wherein the neighboring chroma samples include left neighboring chroma samples of the current chroma block and top neighboring chroma samples of the current chroma block, and
wherein the four selected downsampled neighboring luma samples include two selected downsampled left neighboring luma samples related to the left neighboring chroma samples and two selected downsampled top neighboring luma samples related to the top neighboring chroma samples.

4. The image decoding method of claim 1, wherein samples among the neighboring luma samples of the current luma block, which are not used to derive the selected downsampled neighboring luma samples, are not downsampled.

5. The image decoding method of claim 3, wherein the selected downsampled left neighboring luma samples are derived based on a first downsampling method, and
wherein the selected downsampled top neighboring luma samples are derived based on a second downsampling method different from the first downsampling method.

6. The image decoding method of claim 1, wherein the selected downsampled neighboring luma samples are derived through downsampling based on a 1:2:1 ratio of a first neighboring sample, a second neighboring sample, and a third neighboring sample,
wherein based on a top left sample position (0, 0) of the current luma block, the first neighboring sample is located at (−1, y) or (x, −1), and the second neighboring sample is located at (−2, y) or (x, −2), and the third neighboring sample is located at (−3, y) or (x, −3), and
wherein said x denotes a variable which is an integer within a range from 0 to a value equal to the width of the current luma block minus 1, and said y denotes a variable which is an integer within a range from 0 to a value equal to the height of the current luma block minus 1.

7. The image decoding method of claim 1, wherein the selected downsampled neighboring luma samples are downsampled at a 4:1 ratio based on neighboring luma samples of the current luma block.

8. The image decoding method of claim 1, wherein the selected downsampled neighboring luma samples are derived based on neighboring luma samples of the current luma block using a downsampling filter.

9. The image decoding method of claim 8, wherein the downsampling filter includes a 6-tap filter, a 3-tap filter, or a filter for deriving a sample at a specific position based on neighboring luma samples of the current luma block, and
wherein the sample at the specific position is derived based on the positions of the selected neighboring chroma samples from among neighboring luma samples of the current luma block.

10. The image decoding method of claim 9, wherein the image information includes information indicating the downsampling filter,
wherein the downsampling filter is derived based on the information indicating the downsampling filter, and
wherein the information indicating the downsampling filter is signaled in a slice header, a picture parameter set (PPS), or a sequence parameter set (SPS).

11. (canceled)

12. The image decoding method of claim 1, wherein a number of the selected neighboring chroma samples is derived based on a specific value and the width and height of the current chroma block.

13. The image decoding method of claim 12, wherein based on the specific value less than or equal to the width and less than or equal to the height, the number of the selected neighboring chroma samples is derived as a value obtained by multiplying the specific value by two.

14. An image encoding method performed by an encoding apparatus, the method comprising:
determining an intra prediction mode of a current chroma block as a cross-component linear model (CCLM) mode;
deriving downsampled luma samples based on luma samples of a current luma block;
deriving selected neighboring chroma samples of the current chroma block;
deriving selected downsampled neighboring luma samples based on neighboring luma samples of the current luma block;
deriving a CCLM parameter based on the selected downsampled neighboring luma samples and the selected neighboring chroma samples of the current chroma block;
generating prediction samples for the current chroma block based on the CCLM parameter and the downsampled luma samples; and
encoding image information including prediction mode information for the current chroma block,
wherein the selected downsampled neighboring luma samples include four selected downsampled neighboring luma samples related to the selected neighboring chroma samples.

15. (canceled)

16. The method of claim 1, wherein the deriving the selected downsampled neighboring luma samples comprises:
applying downsampling based on specific neighboring luma samples related to positions of the selected neighboring chroma samples.

17. The method of claim 16, wherein a number of the specific neighboring luma samples used for the downsampling for deriving the selected downsampled neighboring luma samples are 24.

18. The method of claim 16, wherein among the neighboring luma samples of the current luma block, only the specific neighboring luma samples are used for the downsampling for deriving the selected downsampled neighboring luma samples.

19. The method of claim 14, wherein the deriving the selected downsampled neighboring luma samples comprises:
applying downsampling based on specific neighboring luma samples related to positions of the selected neighboring chroma samples.

20. The method of claim 19, wherein a number of the specific neighboring luma samples used for the downsampling for deriving the selected downsampled neighboring luma samples are 24.

21. The method of claim 19, wherein among the neighboring luma samples of the current luma block, only the specific neighboring luma samples are used for the downsampling for deriving the selected downsampled neighboring luma samples.

22. A non-transitory computer-readable digital storage medium storing a bitstream of encoded image information generated by a method, the method comprising:
determining an intra prediction mode of a current chroma block as a cross-component linear model (CCLM) mode;
deriving downsampled luma samples based on luma samples of a current luma block;
deriving selected neighboring chroma samples of the current chroma block;
deriving selected downsampled neighboring luma samples based on neighboring luma samples of the current luma block;
deriving a CCLM parameter based on the selected downsampled neighboring luma samples and the selected neighboring chroma samples of the current chroma block;
generating prediction samples for the current chroma block based on the CCLM parameter and the downsampled luma samples; and
encoding image information to generate the bitstream, the image information includes prediction mode information for the current chroma block,
wherein the selected downsampled neighboring luma samples include four selected downsampled neighboring luma samples related to the selected neighboring chroma samples.
